(19) United States
(12) Patent Application Publication
(10) Pub. No.: US 2015/0090665 A1
(43) Pub. Date: Apr. 2, 2015

(54) ACTIVATED SOLUTIONS FOR WATER TREATMENT

(71) Applicant: R-Hangel, LLC, Bountiful, UT (US)

(72) Inventors: Douglas Randolph Vineyard, Bountiful, UT (US); Jayapregasham Tharamapalan, Oviedo, FL (US); Irina Vladimirovna Vineyard, Bountiful, UT (US)

(21) Appl. No.: 14/498,351

(22) Filed: Sep. 26, 2014

Related U.S. Application Data
(60) Provisional application No. 61/883,841, filed on Sep. 27, 2013.

(51) Int. Cl. C25B 1/22; C25B 9/08; C02F 5/00

(52) U.S. Cl. CPC C25B 1/22; C02F 5/00; C25B 9/08; C02F 2303/22; C02F 2305/00
USPC 210/696; 205/556; 205/50; 252/175

(57) ABSTRACT

The present invention relates to activated solutions comprising one or more of hypochlorous acid, bicarbonate ions, and phosphate ions for use in water treatment, in particular water purification and descaling, and processes for making the same.

### FIELD OF INVENTION

The present invention relates to flow-through electrolytic cells, to methods for synthesizing activated solutions in flow-through electrolytic cells and to activated solutions made thereby.

### BACKGROUND

The principal challenge of water purveyors is providing safe, potable water for domestic, commercial and industrial use, as well as providing water at sufficient pressure. A major problem in achieving this objective is biofouling resulting from bacterial growth and the deposition of biofilms, and scaling resulting from the deposition of mineral compounds. In order to control the growth of biofilms, water distributions systems must maintain disinfectant residual throughout the water chain, from source to delivery point. Such disinfectant residuals, however, frequently react with natural organic matters and inorganic species, such as bromide, resulting in disinfectant by-products, such as total trihalomethanes (TTHMs), haloacetic acids (HAA5) formation, as well as unacceptable taste and odor of chlorine. While such disinfectant by-products can be controlled by reducing the disinfectant residual, the result is a water supply that is more susceptible to biological contaminants and higher risk to the health of water consumers.

Mineral scaling is also a significant problem in water distributions systems, Scaling can be triggered by various physical, chemical or biological factors in the water supply or distribution system, such as temperature rise, pressure change or change in pH. Scale consists primarily of calcium or magnesium carbonates or calcium sulfate. As scale builds up in hot water tanks or heat exchangers, the scale buildup insulates the water from the heat source and more energy is required to heat the water. Scaling further reduces the system pressure in distribution mains, requiring higher operating pressures in the system, which result in pipe breakages and high cost of replacing water mains and pumping systems.

The various aspects and embodiments of the present invention relate to improved chemical solutions for preventing or reducing biofilms and scaling within water systems, and novel methods for producing such chemical solutions.

### SUMMARY OF INVENTION

The various embodiments of the present invention represent an improvement upon the systems of the prior art.

In one aspect, the present invention relates to methods for co-synthesizing in a flow-through electrochemical cell an activated solution for use in water treatment, comprising:

(a) providing a flow-through electrochemical cell comprising a cylindrical anode and a coaxial cylindrical cathode, a capillary-porous diaphragm coaxial with and between the anode and cathode and defining an anodic chamber and cathodic chamber;

(b) introducing an anodic electrolyte solution into the anodic chamber such that the anodic electrolyte solution flows through the anodic chamber and the products of the electrochemical reaction flow out of the anodic chamber, wherein the anodic electrolyte solution comprises one or more electrolyte of the formula MK, wherein
M is selected from the group consisting of alkali metal and alkaline earth metal ions, and
K is selected from the group consisting of bicarbonate, carbonate and phosphate ions;

(c) introducing a cathodic electrolyte solution into the cathode chamber such that the cathodic electrolyte solution flows through the cathodic chamber and the products of the electrochemical reaction flow out of the cathodic chamber, wherein the cathodic electrolyte solution comprises one or more electrolyte of the formula MX, wherein
M is selected from the group consisting of alkali metals and alkaline earth metal ions, and
X is a halogen ion; and

(d) subjecting the first electrolyte solution and second electrolyte solution to a current sufficient to create an electrolytic reaction and produce an activated solution comprising a hypohalous acid and one or more ion selected from the group consisting of phosphate ion and bicarbonate ion.

In some embodiments of the above methods, MX comprises one or more of the group consisting of sodium chloride, potassium chloride, calcium chloride, magnesium chloride, sodium bromide, potassium bromide, sodium iodide, and potassium iodide. In other embodiments, MX comprises sodium chloride. In yet other embodiments, MK comprises one or more of the group consisting of sodium bicarbonate, potassium bicarbonate, calcium bicarbonate, magnesium bicarbonate, sodium carbonate, potassium carbonate. In some embodiments, MK comprises sodium bicarbonate. In some other embodiments, MK comprises one or more of the group consisting of disodium phosphate, dipotassium phosphate, calcium phosphate, monomagnesium phosphate, and dimagnesium phosphate. In other embodiments, MK comprises disodium phosphate.

In other embodiments, MK is a mixture of electrolytes, comprising one or more of the group consisting of sodium bicarbonate, potassium bicarbonate, aqueous calcium bicarbonate and aqueous magnesium bicarbonate, sodium carbonate, potassium carbonate; calcium bicarbonate, and magnesium bicarbonate; and one or more of the group consisting of disodium phosphate, dipotassium phosphate, calcium phosphate, monomagnesium phosphate, and dimagnesium phosphate.

In alternative embodiments, MK is a mixture of electrolytes comprising sodium bicarbonate and disodium phosphate. In other embodiments, MX is a mixture of electrolytes comprising sodium chloride and sodium bicarbonate.

In some embodiments of the method described above, the anodic electrolyte solution flows through the anode chamber and the cathodic electrolyte solution flows through cathode chamber in counter-current mode. In other embodiments, the anodic electrolyte solution flows through the anode chamber and the cathodic electrolyte solution flows through cathode chamber in co-current mode.

In some embodiments, the rate of flow of the cathodic electrolyte solution in the cathode chamber is greater than the rate of flow of the anodic electrolyte solution in the anode chamber. In other embodiments, the rate of flow of the cathodic electrolyte solution in the cathode chamber is at least two times greater than the rate of flow of the anodic electrolyte solution in the anode chamber.

In some embodiments, MX is a mixture of electrolytes comprising sodium chloride and disodium phosphate. In some embodiments, the anodic electrolyte solution flows through the anode chamber and the cathodic electrolyte solution flows through cathode chamber in counter-current mode. In other embodiments, the anodic electrolyte solution flows through the anode chamber and the cathodic electrolyte solution flows through cathode chamber in co-current mode. In other embodiments, the rate of flow of the cathodic electrolyte solution in the cathode chamber is greater than the rate of flow of the anodic electrolyte solution in the anode chamber. In other embodiments, the rate of flow of the cathodic electrolyte solution in the cathode chamber is at least two times greater than the rate of flow of the anodic electrolyte solution in the anode chamber.

In some embodiments of the present invention, MX comprises sodium chloride, and MK comprises sodium bicarbonate and disodium phosphate. In some embodiments, the anodic electrolyte solution and cathodic electrolyte solution flow through the anode chamber and cathode chamber in co-current mode. In other embodiments, the rate of flow of the cathodic electrolyte solution in the cathode chamber is greater than the rate of flow of the anodic electrolyte solution in the anode chamber. In yet other embodiments, the rate of flow of the cathodic electrolyte solution in the cathode chamber is at least two times greater than the rate of flow of the anodic electrolyte solution in the anode chamber.

In some embodiments of the present invention, the anode has a surface comprising an electrocatalytic coating comprising about 36% to about 68% iridium, about 2% to about 10% rubidium, about 14% to about 19% ruthenium, and about 24% to about 44% platinum. In some embodiments, the anode has a surface comprising an electrocatalytic coating comprising about 75% iridium, about 15% ruthenium, and about 5% platinum.

In some embodiments of the above method, the cathode chamber outlet is connected to the anode chamber inlet, thereby enabling recirculation of the cathode chamber reaction products to the anode chamber reactants. In other embodiments, the anodic electrolyte solution and cathodic electrolyte solution flow through the anode chamber and cathode chamber in co-current mode. In yet other embodiments, the rate of flow of the cathodic electrolyte solution in the cathode chamber is equal to or greater than the rate of flow of the anodic electrolyte solution in the anode chamber. In still other embodiments, the rate of flow of the cathodic electrolyte solution in the cathode chamber is greater than the rate of flow of the anodic electrolyte solution in the anode chamber. In other embodiments, the rate of flow of the cathodic electrolyte solution in the cathode chamber is at least two times greater than the rate of flow of the anodic electrolyte solution in the anode chamber. In other embodiments, the rate of flow of the cathodic electrolyte solution in the cathode chamber is at least three times greater than the rate of flow of the anodic electrolyte solution in the anode chamber. In other embodiments, the anodic electrolyte solution and cathodic electrolyte solution flow through the anode chamber and cathode chamber in counter-current mode. In other embodiments, the rate of flow of the cathodic electrolyte solution in the cathode chamber is equal to or greater than the rate of flow of the anodic electrolyte solution in the anode chamber. In other embodiments, the rate of flow of the cathodic electrolyte solution in the cathode chamber is greater than the rate of flow of the anodic electrolyte solution in the anode chamber. In other embodiments, the rate of flow of the cathodic electrolyte solution in the cathode chamber is at least two times greater than the rate of flow of the anodic electrolyte solution in the anode chamber. In other embodiments, the rate of flow of the cathodic electrolyte solution in the cathode chamber is at least three times greater than the rate of flow of the anodic electrolyte solution in the anode chamber.

In another aspect, the present invention relates to products produced according to the methods described above. In some embodiments, the product is a solution comprising two or more of the group consisting of activated hypochlorous acid; activated phosphate ion, activated bicarbonate ion (hydrogencarbonate ion HCO₃⁻). In some embodiments, the solution comprises activated hypochlorous acid, activated bicarbonate ion and activated phosphate ion. In some embodiments, the solution comprises activated hypochlorous acid and activated phosphate ion. In other embodiments, the product comprises a solution of activated hypochlorous acid and a solution of activated bicarbonate ion.

In another aspect, the present invention relates to methods of using the products described above. In some embodiments, the present invention relates to a method for preventing or removing mineral and biological deposits in a water system, comprising the step of circulating within the water system a solution comprising two or more of the group consisting of activated hypohalous acid, activated bicarbonate ion and activated phosphate ion. Such solutions may comprise hypochlorous acid, and activated bicarbonate ion. In some embodiments, the solution comprises hypochlorous acid, and activated phosphate ion. In other embodiments, the solution comprises activated hypochlorous acid, activated bicarbonate ion and activated phosphate ion.

In another aspect, the present invention relates to chemical solutions comprising two or more of the group comprising activated hypohalous acid, activated bicarbonate ion, and activated phosphate ion. In some embodiments, the chemical solution comprises activated hypohalous acid and one or more of activated bicarbonate ion and activated phosphate ion. In other embodiments, the solution comprises activated hypochlorous acid, and activated bicarbonate ion. In other embodiments, the solution comprises activated hypochlorous acid, and activated phosphate ion. In other embodiments, the solution comprises activated hypochlorous acid, activated bicarbonate ion, and activated phosphate ion.

In another aspect, the present invention relates to products comprises a mixture of a solution of activated bicarbonate ion and a solution of activated hypochlorous acid. In some embodiments, the mixture comprises greater than about 2% and less than about 25% by volume activated bicarbonate solution. In other embodiments, mixture comprises between about 5% and 15% by volume activated bicarbonate solution. In still other embodiments, the mixture comprises about 10% by volume activated bicarbonate solution. In other embodiments, the mixture comprises less than about 20%, less than about 25%, or less than about 50% by volume activated bicarbonate solution.

In some embodiments, the mixture retains an average total chlorine value greater than about 100, greater than about 200, greater than about 300, or greater than about 350 over a period of 10 days.

### BRIEF DESCRIPTION OF DRAWINGS

Various embodiments of the present invention are shown and described in reference to the numbered drawings:

FIG. 1A illustrates a typical flow-through electrolytic module (FEM).

FIG. 1B shows a schematic of the FEM module configuration of FIG. 1A.

FIG. 2A is a schematic diagram showing a co-current feed to anodic and cathodic chambers.

FIG. 2B is a schematic diagram showing a counter current feed to anodic and cathodic chambers.

FIG. 3 is a diagram showing a series of eight FEMs units configured to operate in parallel.

FIG. 4A shows an arrangement of a FEM unit configured to produce activated hypchlorous acid in counter-current single pass mode.

FIG. 4B shows a schematic of the FEM unit configuration of FIG. 4A.

FIG. 5A shows an arrangement of a FEM unit configured to produce activated hypchlorous acid in co-current single pass mode.

FIG. 5B shows a schematic of the FEM unit configuration of FIG. 5A.

FIG. 6A is a schematic showing activated hypchlorous acid in counter-current brine feed and recycle stream feed mode.

FIG. 6B shows an arrangement of a FEM unit configured to produce activated hypchlorous acid in counter-current single pass mode.

FIG. 7A is a schematic showing activated hypchlorous acid in co-current brine feed and recycle stream feed mode

FIG. 7B shows an arrangement of a FEM unit configured to produce activated hypchlorous acid in co-current brine feed and recycle stream feed mode

FIG. 8A shows an arrangement of a FEM unit configured to produce activated bicarbonate ion solution in counter-current single pass mode.

FIG. 8B shows a schematic of the FEM unit configuration of FIG. 8A.

FIG. 9A shows an arrangement of a FEM unit configured to produce activated bicarbonate ion solution in co-current single pass mode.

FIG. 9B shows a schematic of the FEM unit configuration of FIG. 9A.

FIG. 10A is a schematic showing activated bicarbonate ion solution in counter-current brine feed and recycle stream feed mode.

FIG. 10B shows an arrangement of a FEM unit configured to produce activated bicarbonate ion solution in counter-current single pass mode.

FIG. 11A is a schematic showing activated bicarbonate ion solution in co-current brine feed and recycle stream feed mode

FIG. 11B shows an arrangement of a FEM unit configured to produce activated bicarbonate ion solution in co-current brine feed and recycle stream feed mode

FIG. 12A shows an arrangement of a FEM unit configured to produce activated phosphate ion solution in counter-current single pass mode.

FIG. 12B shows a schematic of the FEM unit configuration of FIG. 12A.

FIG. 13A shows an arrangement of a FEM unit configured to produce activated phosphate ion solution in co-current single pass mode.

FIG. 13B is a schematic of the FEM unit configuration of FIG. 13A.

FIG. 14A is a schematic showing an arrangement of a FEM unit configured to produce activated phosphate ion solution in counter-current brine feed and recycle stream feed mode

FIG. 14B shows an arrangement of a FEM unit configured to produce activated phosphate ion solution in counter-current brine feed and recycle stream feed mode.

FIG. 15A is a schematic showing an arrangement of a FEM unit configured to produce activated bicarbonate ion solution in co-current brine feed and recycle stream feed mode.

FIG. 15B shows an arrangement of a FEM unit configured to produce activated bicarbonate ion solution in co-current brine feed and recycle stream feed mode.

FIG. 16A illustrates a counter-current feed single pass process for producing hypochlorous acid and bicarbonate ion based solutions.

FIG. 16B is a schematic of the FEM unit configuration of FIG. 16A.

FIG. 17A illustrates a co-current feed single pass process for producing hypochlorous acid and bicarbonate based solutions.

FIG. 17B is a schematic of the FEM unit configuration of FIG. 17A.

FIG. 18A illustrates a counter-current feed single pass process for producing hypochlorous acid and phosphate ion based solutions.

FIG. 18B is a schematic of the FEM unit configuration of FIG. 18A.

FIG. 19A illustrates a co-current feed single pass process for producing hypochlorous acid and phosphate ion based solutions.

FIG. 19B is a schematic of the FEM unit configuration of FIG. 19A.

FIG. 20A illustrates a counter-current feed single pass process for producing hypochlorous acid, bicarbonate ion, and phosphate ion based solutions.

FIG. 20B is a schematic of the FEM unit configuration of FIG. 20A.

FIG. 21A illustrates a co-current feed single pass process for producing hypochlorous acid, bicarbonate ion, and phosphate ion based solutions.

FIG. 21B is a schematic of the FEM unit configuration of FIG. 21A.

FIG. 22 is a schematic showing a conventional filtration process in a coagulation flocculation.

FIG. 23 is a schematic showing the possible uses of the solutions of the present invention in a direct filtration process in a coagulation flocculation plant.

FIG. 24 is a schematic showing the possible uses of the solutions of the present invention in a direct filtration process in a lime softening plant.

FIG. 25 is a schematic showing the possible uses of the solutions of the present invention in a microfiltration/ultrafiltration low-pressure system for water treatment.

FIG. 26 is a schematic showing the possible uses of the solutions of the present invention in a microfiltration/ultrafiltration system as a pretreatment to advanced membrane processes in a water treatment/wastewater reclamation process.

FIG. 27 is a schematic showing the alternative uses of the solutions of the present invention in a microfiltration/ultrafiltration system as a pretreatment to advanced membrane processes in a water treatment/wastewater reclamation process.

FIG. 28 is a schematic showing the possible uses of the solutions of the present invention as a chemically enhanced backwash chemical.

FIG. 29 is a schematic showing the possible uses of the solutions of the present invention in a high-pressure membrane system (nanofiltration/reverse osmosis) process in desalination water treatment processes.

FIG. 30 is a schematic showing the possible uses of the solutions of the present invention in a high-pressure membrane system (nanofiltration/reverse osmosis) process in a water treatment/advanced wastewater reclamation processes.

FIG. 31 is a schematic showing the possible uses of the solutions of the present invention for sulfide control in ground water sources of water.

FIG. 32 is a schematic showing the possible uses of the solutions of the present invention for treatment of conventional wastewater effluent.

FIG. 33 illustrates an electromodules setup and ammeter arrangement for a set of eight electromodules used to produce solutions.

FIG. 34A illustrates a generic counter-current single pass production configuration for producing activated solutions.

FIG. 34B is a schematic of the FEM unit configuration of FIG. 34A.

FIG. 35A illustrates a generic co-current single pass production configuration for producing activated solutions.

FIG. 35B is a schematic of the FEM unit configuration of FIG. 35A.

FIG. 36A is a schematic showing a generic counter-current brine feed and recycle stream feed (with the feed brine in the cathodic chamber).

FIG. 36B illustrates the counter-current brine feed and recycle stream feed (with the feed brine in the cathodic chamber) of the schematic of FIG. 36A.

FIG. 37A is a schematic showing a counter-current brine feed and recycle stream feed (with the feed brine in the anodic chamber).

FIG. 37B illustrates the counter-current brine feed and recycle stream feed (with the feed brine in the anodic chamber) of the schematic of FIG. 37A.

FIG. 38A is a schematic showing a co-current brine feed and recycle stream feed (with the feed brine in the cathodic chamber).

FIG. 38B illustrates the co-current brine feed and recycle stream feed (with the feed brine in the cathodic chamber) of the schematic of FIG. 38A.

FIG. 39A is a schematic showing a co-current brine feed and recycle stream feed (with the feed brine in the anodic chamber).

FIG. 39B illustrates the co-current brine feed and recycle stream feed (with the feed brine in the anodic chamber) of the schematic of FIG. 39A.

### DETAILED DESCRIPTION

The invention and accompanying drawings are discussed below, using reference numerals to identify parts and features, to enable one skilled in the art to practice the present invention. The drawings and descriptions are exemplary of various aspects of the invention and are not intended to limit or narrow the scope of the appended claims.

### DEFINITIONS

The term “activated” means a solution that has been prepared according to the methods described herein. In particular, an activated solution is a solution that has been prepared using a flow-through electrolytic module and has pH, conductivity and ORP values, as described herein and in the examples below.

The terms “bicarbonate” or “bicarbonate ion” (also known as hydrogen carbonate) means an anion with the empirical formula HCO₃⁻. The term “bicarbonate” is also used to refer to a salt of a bicarbonate ion. Bicarbonate ions are generally introduced into the aqueous solution in the form of a bicarbonate salt, which is dissolved in the solution to form an ionic solution comprising the negatively charged bicarbonate ion. Bicarbonate salts may include alkali metal salts or alkaline earth metal salts. For example, suitable bicarbonate salts may specifically include sodium bicarbonate (NaHCO₃), potassium bicarbonate (KHCO₃), calcium bicarbonate (Ca(HCO₃)₂) and magnesium bicarbonate (Mg(HCO₃)₂). The most common salt of a bicarbonate ion is sodium bicarbonate, which is commonly known as baking soda. Bicarbonate or bicarbonate ions may also be introduced into an electrolytic solution via carbonate salts, such as sodium carbonate (Na₂CO₃), potassium carbonate (K₂CO₃), which are ionized in solution to form the conjugate bicarbonate ions.

The terms “phosphate” or “phosphate ion” means an anion with the empirical formula of PO₄³⁻. The term “phosphate” is also used to refer to a salt of a phosphate ion. Phosphate ions are generally introduced into the aqueous solution in the form of a phosphate salt, which is dissolved in the solution to form an ionic solution comprising the negatively charged phosphate ion. Phosphate salts may include alkali metal salts or alkaline earth metal salts. For example, suitable phosphate salts may specifically include disodium phosphate (Na₂HPO₄), dipotassium phosphate (K₂HPO₄), calcium phosphate (Ca₃(HPO₄)₂) and monomagnesium phosphate (Mg(H₂CO₃)₂) and dimagnesium phosphate (Mg(HPO₄)). The most common salt of a phosphate ion is disodium phosphate.

The terms “halide” or “halide ion” means an anion derived from a halogen molecule, such as chlorine, bromine or iodine. The term “halide” is also used to refer to a salt of a halide ion. In aqueous solutions, halide ions are generally introduced into the aqueous solution in the form of a halide salt, which is dissolved in the solution to form an ionic solution comprising the negatively charged halide ion. Halide salts may include alkali metal salts or alkaline earth metal salts. For example, suitable halide salts may specifically include potassium chloride (KCl), calcium chloride (CaCl₂), magnesium chloride (MgCl₂), sodium bromide (NaBr), potassium bromide (KBr), sodium iodide (NaI), and potassium iodide (KI).

The term “hypochlorous acid” means an acid with the empirical formula of HOCl.

“TDS” means total dissolved solids.

“TTHM” means total trihalomethanes, which are chemical compounds in which three of the four hydrogen atoms of methane (CH₄) are replaced by halogen atoms, typically chlorine (Cl), flourine (F), or bromine (Br).

“HAA5” means the sum of mass concentrations of five haloacetic acid species consisting of Monochloroacetic Acid (MCAA), Dichloroacetic Acid (DCAA), Trichloroacetic Acid (TCAA), Monobromoacetic Acid (MBAA) and Dibromoacetic Acid (DBAA).

“Hypohalous acid” means any oxyacid of a halogen of the general formula HOX, where X is selected from the group consisting of FI, Cl, Br, and I.

### Flow-Through Electrolytic Modules

Flow-through electrolytic modules for synthesis of water and aqueous solutions and production of different chemical products have been disclosed in the art.

The current state of the art designs comprise electrolytic cells having coaxially arranged tubular electrodes and a diaphragm arranged between the electrodes, thereby dividing the internal space between the diaphragm and the tubular electrodes into separate electrolytic cells consisting of an anode chamber and a cathode chamber through which electrolytic solutions flow. Exemplary FEMs are disclosed in, for example, U.S. Pat. Nos. 8,366,939; 7,897,023; 6,843,895; 5,427,667; 5,540,819; 5,628,888, 5,635,040; 5,783,052; 5,871,623; 5,985,110; 6,004,439; U.S. Application Nos 2011/0226615; EP 1007471B1, and others. FEMs are distinct from fluidized bed electrolytic cells in that they permit higher through-put processing of solutions. The coatings and material that form the anodic and cathodic chambers are varied to achieve the desired synthesis of the activated solutions.

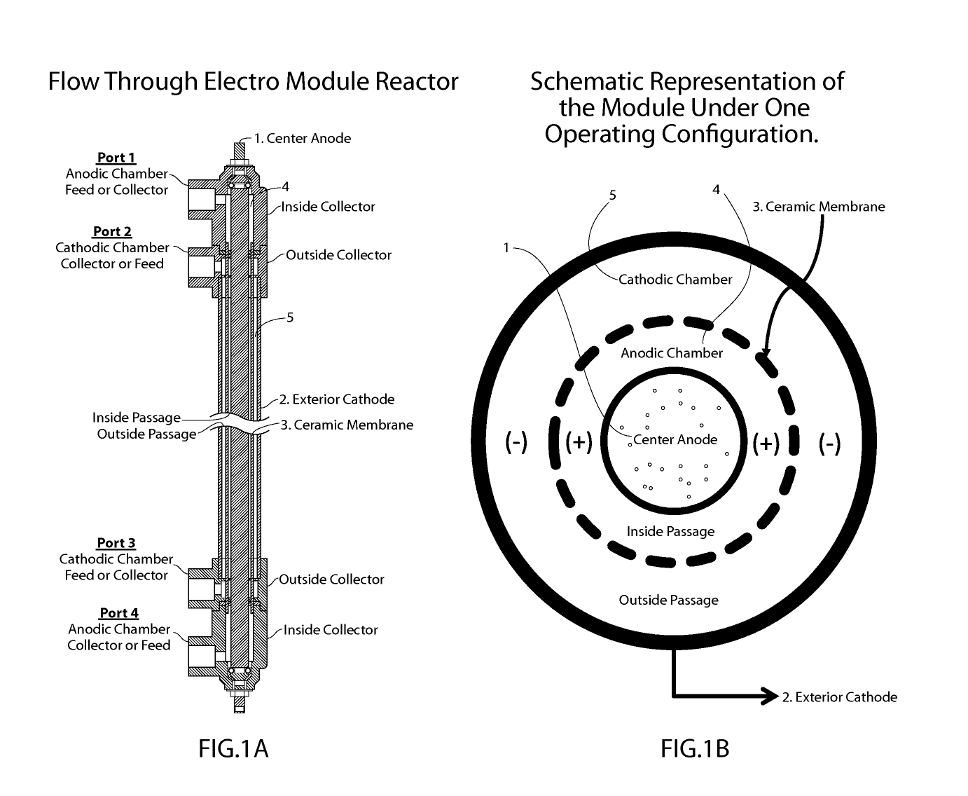

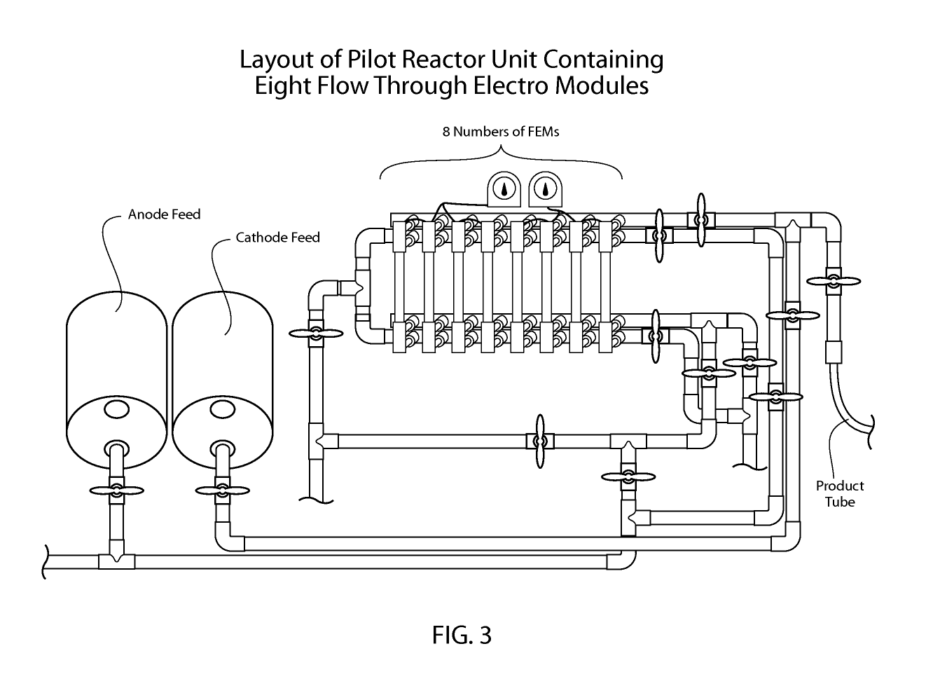

Generally, the FEM reactor consists of two chambers—anode and cathode chambers. A schematic of the cross-sectional view of the FEM showing the anode and cathode chambers, which are the inside, and outside passages of the FEM is presented in FIGS. 1A and 1B. Flow-through electrolytic modules (FEMs) used in the processes of the present invention generally comprise a coaxially arranged tubular outer and inner electrodes made in the form of tube lengths and a permeable ceramic diaphragm arranged coaxially with and between the outer and inner cylindrical electrodes. Generally, as shown in FIG. 1A and FIG. 1B, the FEMS used for processing of solutions comprise an inner tubular center anode 1, an outer cylindrical exterior cathode 2, a permeable tubular ceramic diaphragm 3 arranged between the anode and the cathode, thereby dividing the inter-electrode space into the anode chamber 4 and cathode chamber 5, and units for mounting, securing, and sealing the electrodes and the diaphragm located at the end sections of the cell, and devices (such as pumps, piping, filters, flow control circuitry, etc.) for supplying and removing the solutions into and out of the electrode chambers (the anode chamber and cathode chamber), and diaphragm are mounted in units. The components of the FEMs units are connected with devices for supplying and removing the solutions so as to form the working section of the cell, along the full length of which the constant hydrodynamic parameters of the electrode chambers and the electric field parameters are maintained. Multiple FEMs units may be mounted in tandem so as to increase the processing capacity of a system, as shown in FIG. 3.

The FEM reactor as depicted in FIGS. 1A and 1B is symmetrical across its horizontal axis. The feed to the anode chamber can be from either the top (Port 1) or bottom feed port (Port 4). The anode collector port will correspondingly be opposite to the feed port as Port 4 or Port 1 respectively. Likewise the feed to the cathode chamber can be from either the second port from the top (Port 2) or the third port from the top (Port 3), and cathode chamber collector port will be reversed accordingly, as Port 3 or Port 2 respectively. Therefore all depictions showing the anode chamber feed as Port 1 is similar to Port 4 and those depicting cathode chamber feed as Port 2 is similar to Port 3 and the collector ports reversed accordingly.

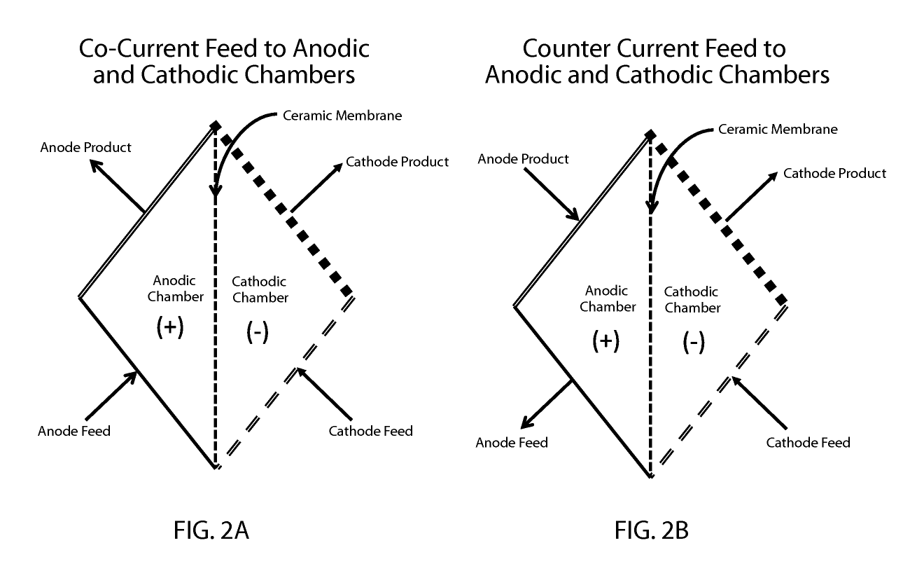

The design of the FEMs allow for changes in the direction of feed and product from the anode and cathode chambers. FIG. 2A and FIG. 2B are schematic diagrams that illustrate two possible configurations. FIG. 2A illustrates co-current mode, wherein the anode feed and cathode feed are at the same end of the FEM unit (in the embodiment shown in FIG. 2A, at the bottom), such that the solutions in the anode chamber and cathode chamber flow in the same direction (upwardly). FIG. 2B illustrates counter-current mode, wherein the anode feed and cathode feed are at different ends of the FEM unit, such that the solution in the anode chamber and cathode chamber flow in opposite directions. It is possible, of course, to configure the FED such that the feed ports are at the top and product ports are at the bottom.

In addition, it is possible to configure a FEMs device to facilitate recirculation of the product of one of the anode or cathode chambers to the other chamber. For example, with reference to FIG. 1A, when the anode chamber feed is at Port 1 and the anode collector flow is at Port 4, the product from Port 4 can be recirculated to the cathode chamber feed (Port 3) before the product water is collected from the cathode collector (Port 2).

The cell operation is as follows. In reference to FIGS. 1A and 1B, a solution to be processed is supplied to the anode 4 and cathode 5 chambers of the cell through the devices for supplying an electrolyte solution (not shown in FIG. 1A or 1B). Depending on the chemistry of the process, the movement of the electrolyte in the chambers is effectuated as a parallel flow, in an upward or downward direction (i.e., in co-current mode), or with the electrolyte fluids flowing in opposite directions in the anodic chamber and cathodic chamber (i.e., in counter-current mode).

According to another embodiment of the invention, filling one of the electrode chambers takes place by way of electrofiltration through the diaphragm from the second chamber or by way of filtration due the pressure drop at the diaphragm. Having passed the electrode chambers, the electrolyte is removed from the cell through the devices for removing (not shown in FIGS. 1A and 1B). The solution is being processed either by its single passing through the chambers 4 and 5 or, in accordance with the embodiment comprising the anode 2 having apertures, by a circulation of the solution in the anode chamber.

In one aspect, the present invention provides methods for processing electrolyte solutions to synthesize activated solutions comprising one or more of activated hypochlorous acid, activated bicarbonate (hydrogencarbonate ions as HCO₃⁻) and activated phosphate ions.

### Synthesis of Activated Solutions Comprising Hypohalous Acid

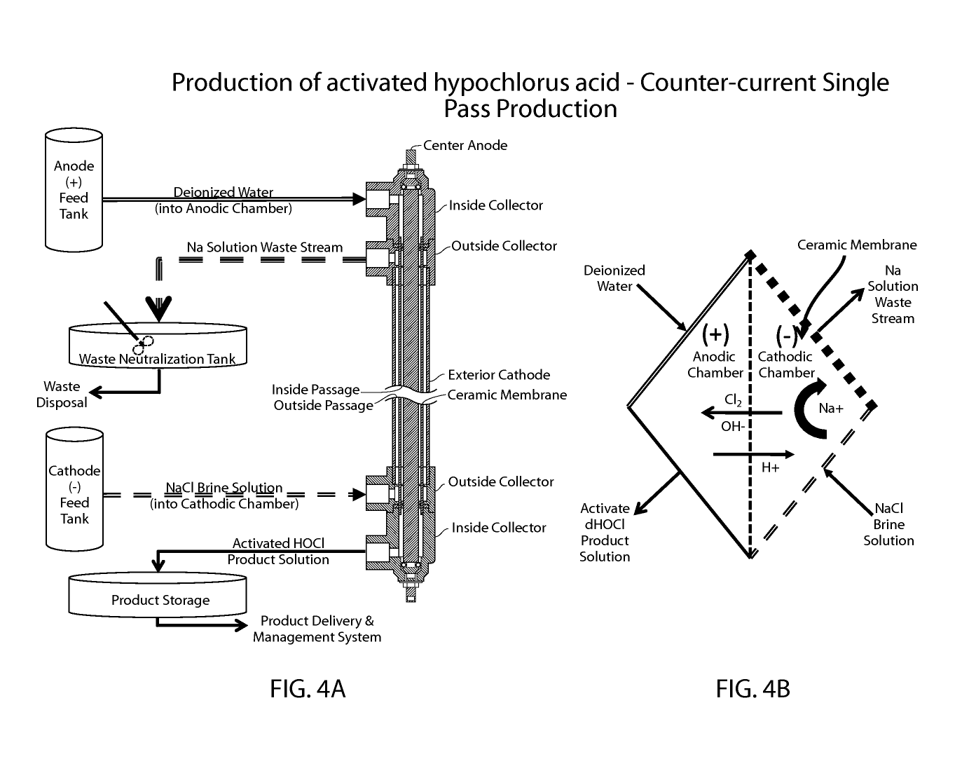

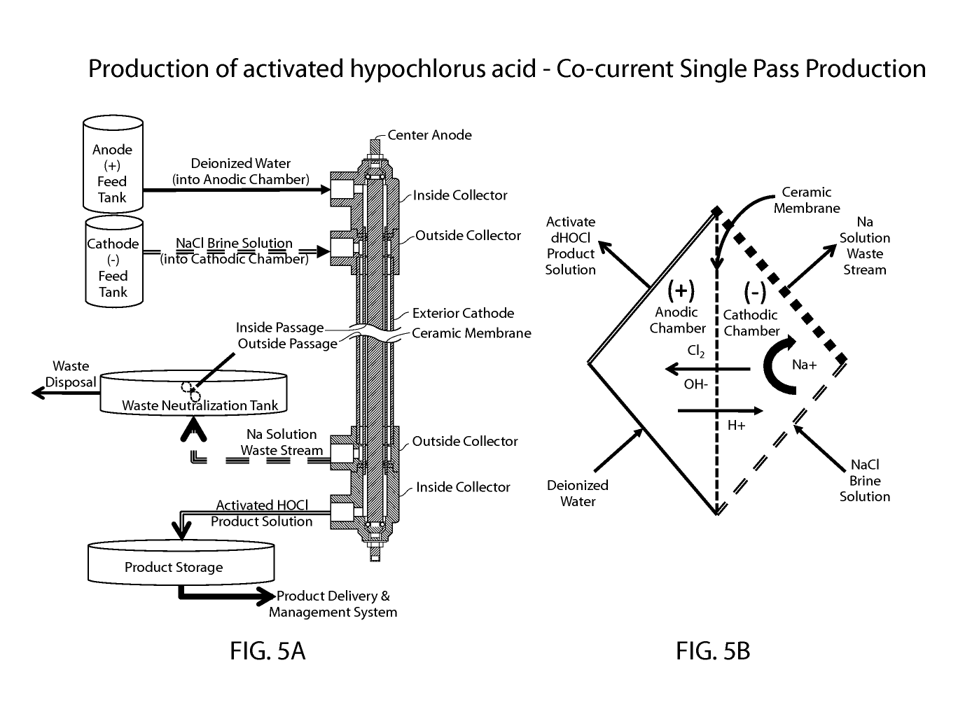

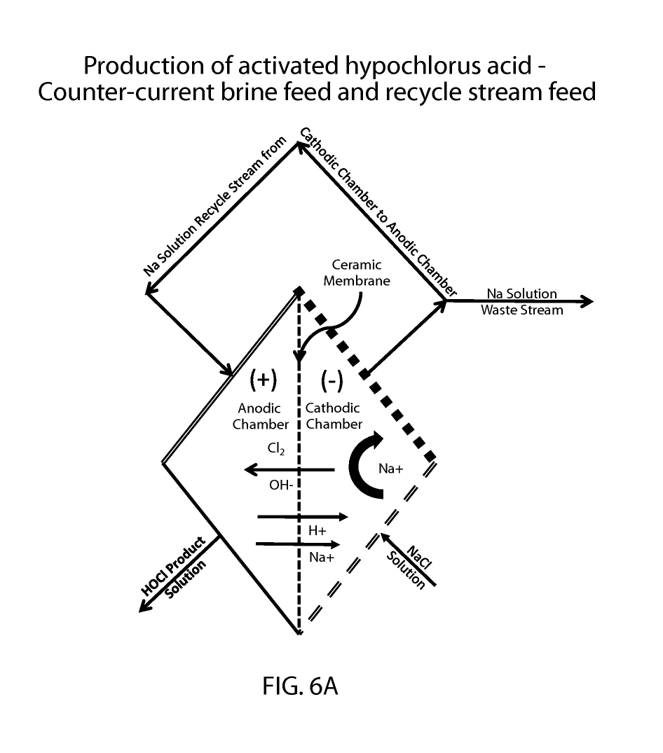

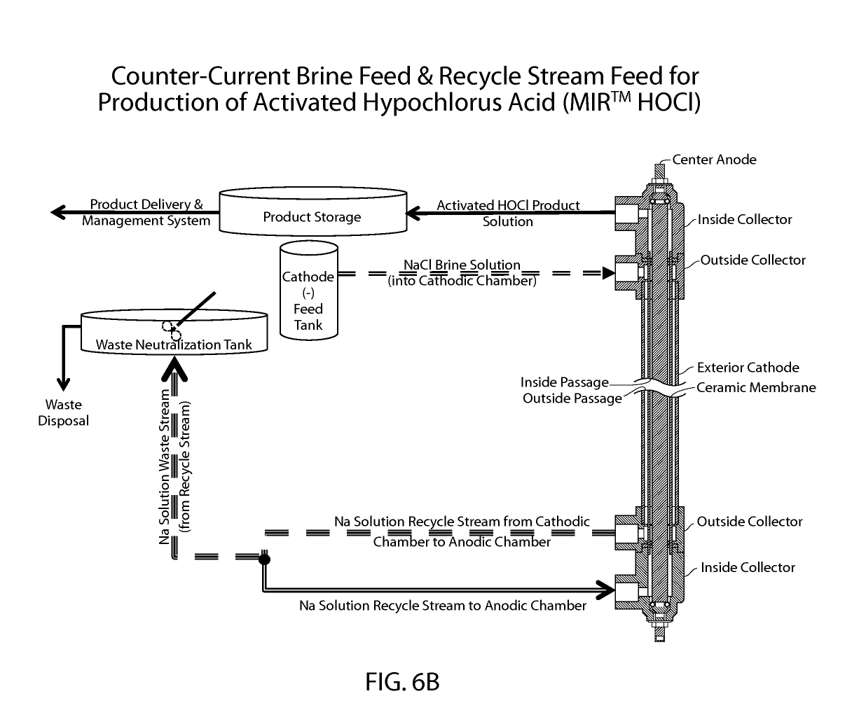

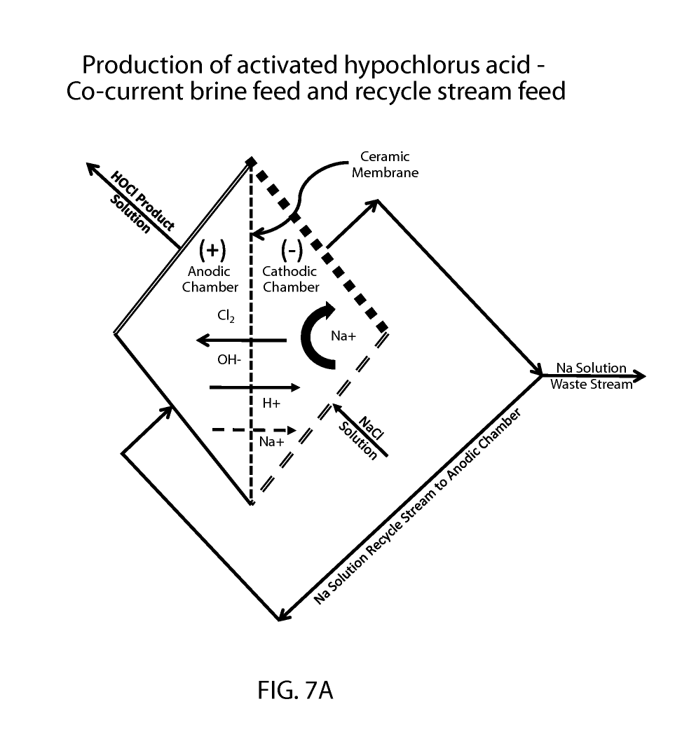

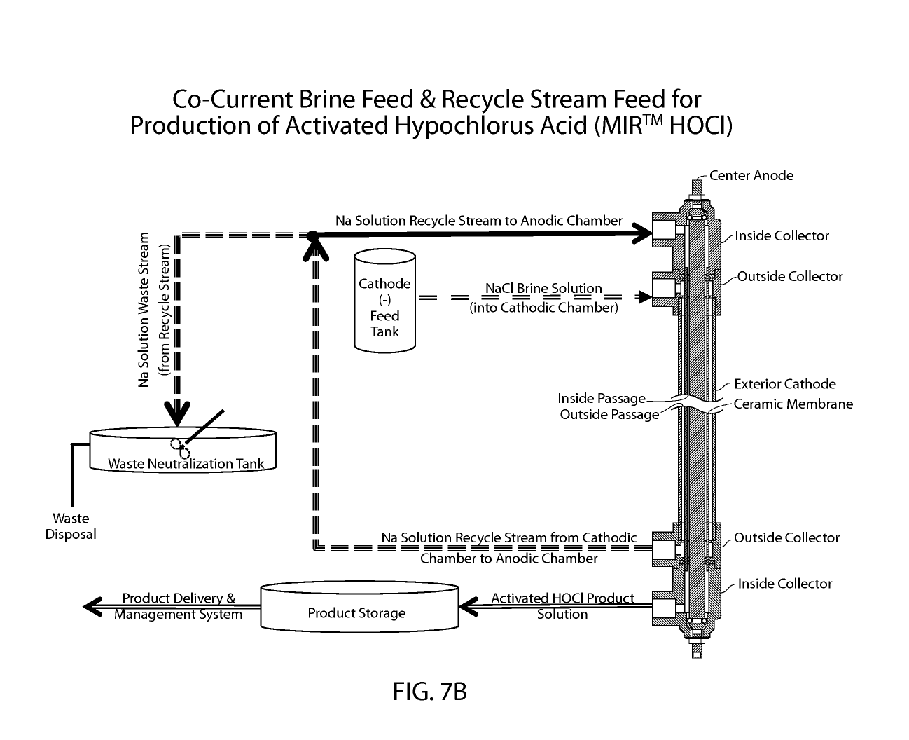

The synthesis of solutions containing hypochlorous acid (HOCl) can be carried out in any one of the following four different configurations: counter-current single pass production (FIGS. 4A and 4B), co-current single pass production (FIGS. 5A and 5B); counter-current brine feed and recycle stream feed (FIGS. 6A and 6B), and co-current brine feed and recycle stream feed (FIGS. 7A and 7B). In some embodiments, the sodium chloride feed brine used in the synthesis as shown in configurations in FIGS. 4-7, can have conductivities ranging from 2000 μS/cm to 40,000 μS/cm, when using pure salts of sodium chloride. In some embodiments, the activated HOCl solution produced can have product free chlorine strength concentrations ranging from 200 mg/L (0.02%) to 1700 mg/L (0.17%). In some embodiments, the synthesizes are carried out by retaining sodium (Na⁺) ions in the cathode feed chamber, while the chloride (Cl⁻) ions migrate in the form of chlorine gas (Cl₂) across the ceramic membrane. In the cases of synthesizes with recycle stream (FIGS. 6A and 6B, and FIGS. 7A and 7B), the sodium ions that are fed into the anodic chamber from the recycle stream migrate to the cathodic chamber. During the syntheses, the hydroxide (OH⁻) and hydronium (H⁺) ions migrate across the ceramic membrane between the anodic and cathodic chambers. In some embodiments, the adjustment of product pH is therefore carried out by regulating the hydronium (H⁺) ions loss in the waste stream as hydrogen gas (H₂) and the hydroxide (OH⁻) ions in the product stream. Either regulating the flow rates and/or applying backpressure on the feed and waste streams adjust the product pH stream.

In some embodiments, the electrochemical synthesis of hypochlorus acid (HOCl) having the following properties, as measured upon production of the HOCl product: FAC: 200 ppm-1700 ppm; ORP: 320 mV-900 mV; pH: 6.5-7.5; Ampere differential between anode and cathode chambers: 5-40 Amperes. The product Free Available Chlorine (FAC), Oxidation-Reduction Potential (ORP), pH and resonance parameters will typically adjust over time, with the ORP and resonance measurements degrading as the product ages. The pH of the product will drop as the parts of the activated hypochlorus acid (HOCl) slowly lose their activation and then decompose, especially by photo-oxidation, to hydrochloric acid (HCl) and oxygen (O₂). The HOCl product is applied in varying degrees of dilution to tap on its resonance energy to carry out de-scaling of hardness scales that have already formed and act as scale inhibitor and as a biocide. As the HOCl product ages and the product quality deteriorates, adjusting its dose rates, i.e. by reducing its dilution rate in the medium that the product is applied, the product can still be used. Therefore product outside the ranges listed above can still be used, and the final decision to not use the product is based on resonance. When the resonance falls below efficacious levels, the product is no longer considered for use as a scale inhibitor or biocide.

During the electrochemical synthesis, one of the identifiable markers of activation of the brine to produce activated HOCl is the cation and anion transfer between the anodic and cathodic chambers resulting in electrical current (or potential difference) between the anode and cathode chamber, that is measured in terms of current flowing between the two chambers. This electrical current flowing between the two chambers is measured in terms of amperes, and in the case of the activated hypochlorus acid the ampere readings range between 5 and 40 Amps. When the sodium chloride (NaCl) brine concentration is higher, the ampere pull across the two chambers is higher and this is due to the increased presence of ions at higher NaCl concentrations.

The feed brine solution is presented as using sodium chloride (NaCl). However other embodiments can include salts of potassium chloride (KCl); calcium chloride (CaCl₂); magnesium chloride (MgCl₂); sodium bromide (NaBr); potassium bromide (KBr); sodium iodide (NaI); and potassium iodide (KI). In instances where monovalent cation based salts (i.e. Na and K) are used, recycling of the cations stream to the anodic chamber is practical as the cations can migrate across the ceramic membrane to the cathodic chamber as depicted in FIGS. 6A and 6B and FIGS. 7A and 7B. In the instances where the calcium (Ca²⁺) and magnesium (Mg²⁺) based feed brine solutions are used, the calcium and magnesium ions will migrate from the anodic chamber to the cathodic chamber in the FEMs with adjusted ceramic membrane pore sizes of 20-50 nm.

Bromine (Br) and iodine based anion salts are activated for use in non-potable water supply applications, in order to reduce the potential for brominated and iodinated TTHMs, after the compounds have dissipated their activated resonance energy in the system that they are applied in.

The feed brine solution is made up with reverse osmosis permeate or deionised water or distilled water to reduce the introduction of additional anions or cations into the activated product stream, and to increase the purity of the activated product. However, other embodiments can include preparation of the feed brine mix in city or utility supplied tap water.

The deionized water feed depicted in the single pass co-current feed and counter-current feed conditions as depicted in FIGS. 4A and 4B and FIGS. 5A and 5B, is one embodiment to create a concentration gradient (in terms of TDS or conductivity measurements) between the anode and cathode chambers. Other waters sources that can be used include reverse osmosis permeate or distilled water or even city or utility supplied tap water.

In instances where there is recycling of the waste stream to the anodic chamber, the rate of wastage from this stream can be utilized to maintain a concentration gradient between the anodic and cathodic chambers in order to create a potential difference between the two chambers that will result in a electrical circuit that will draw current (measured in terms of Amperes across the anodic and cathodic chamber).

### Synthesis of Activated Solutions Comprising Bicarbonate Ions

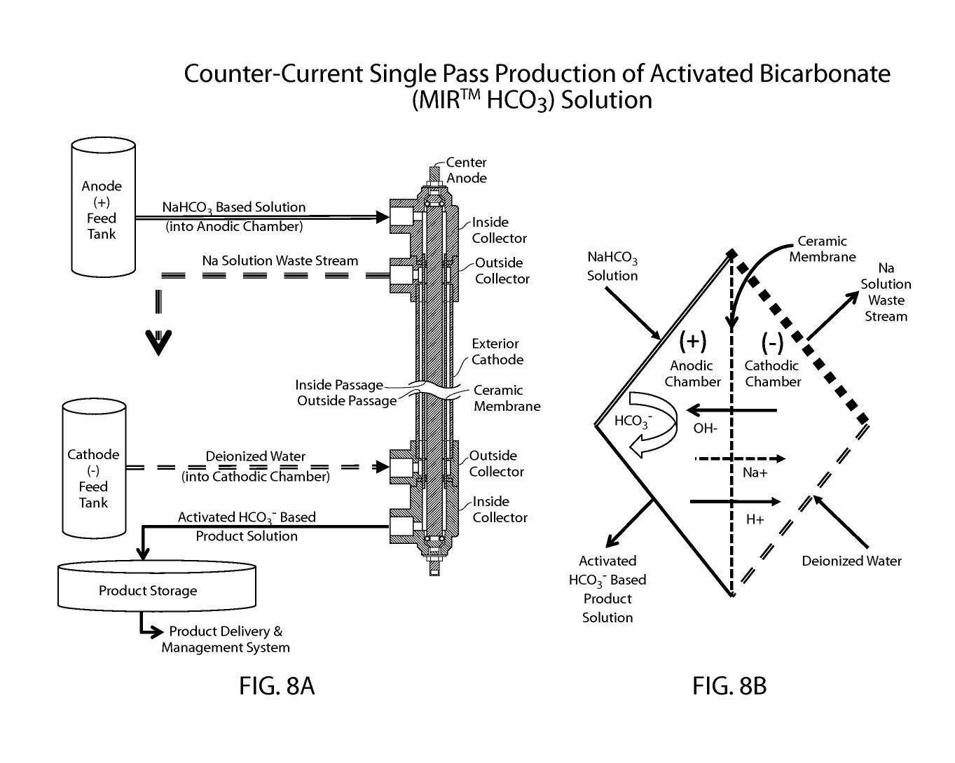

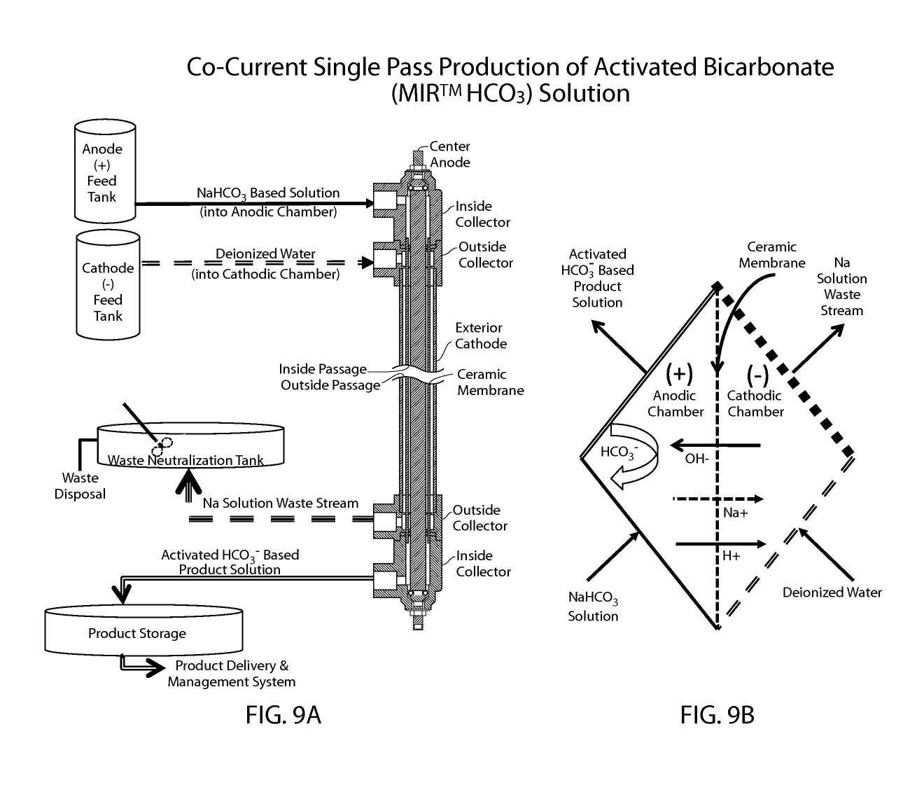

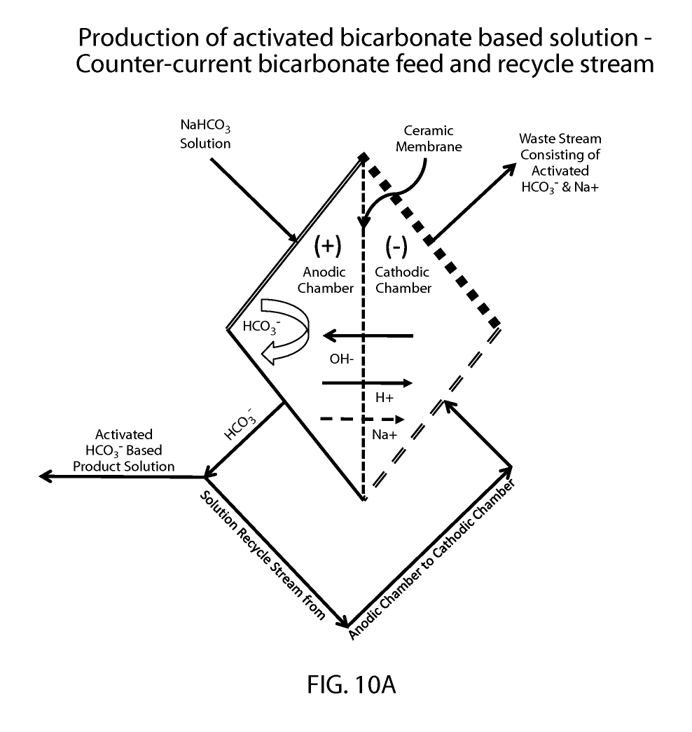

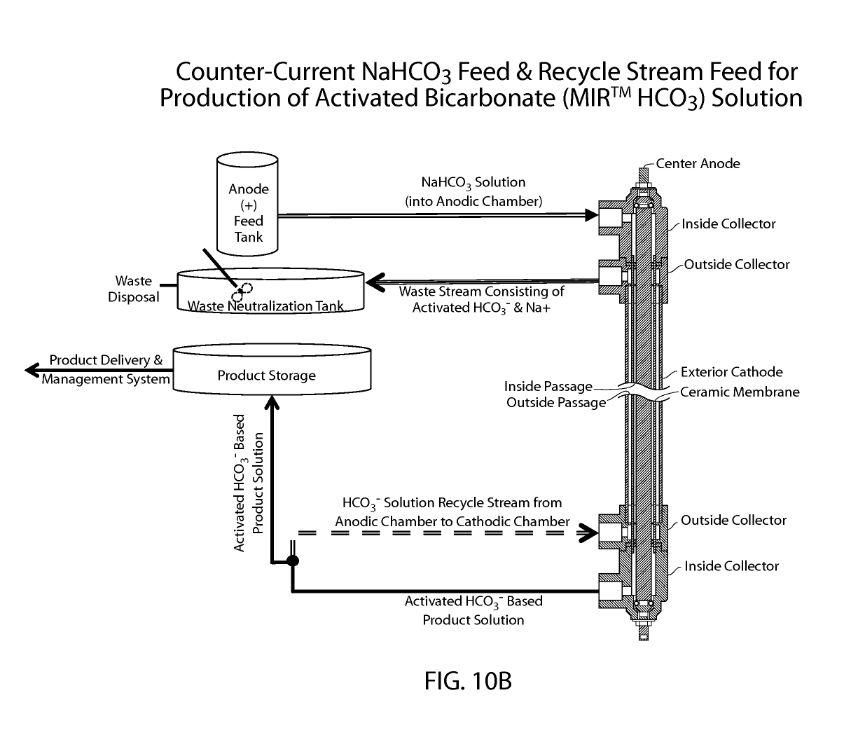

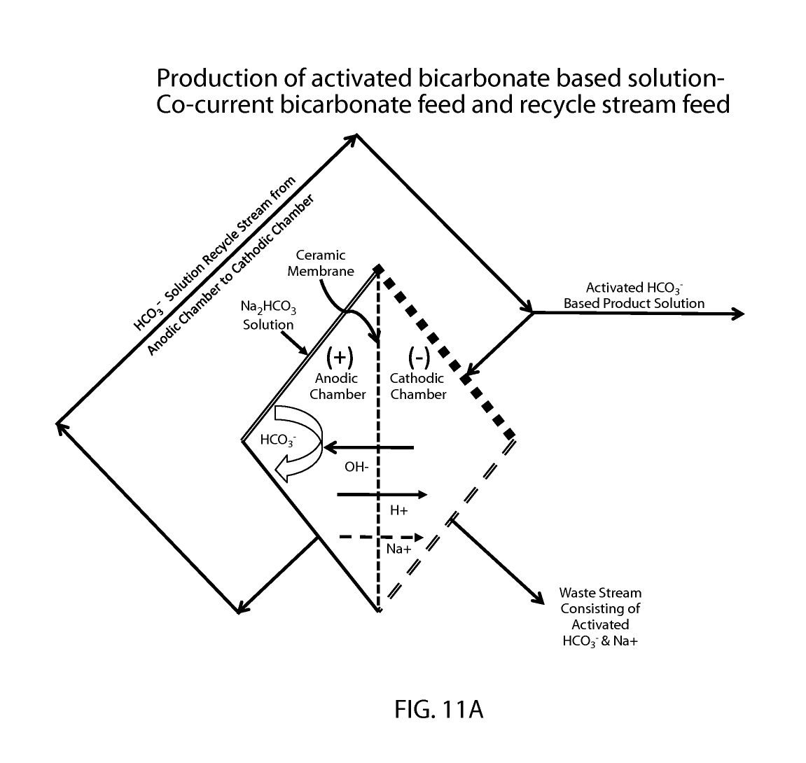

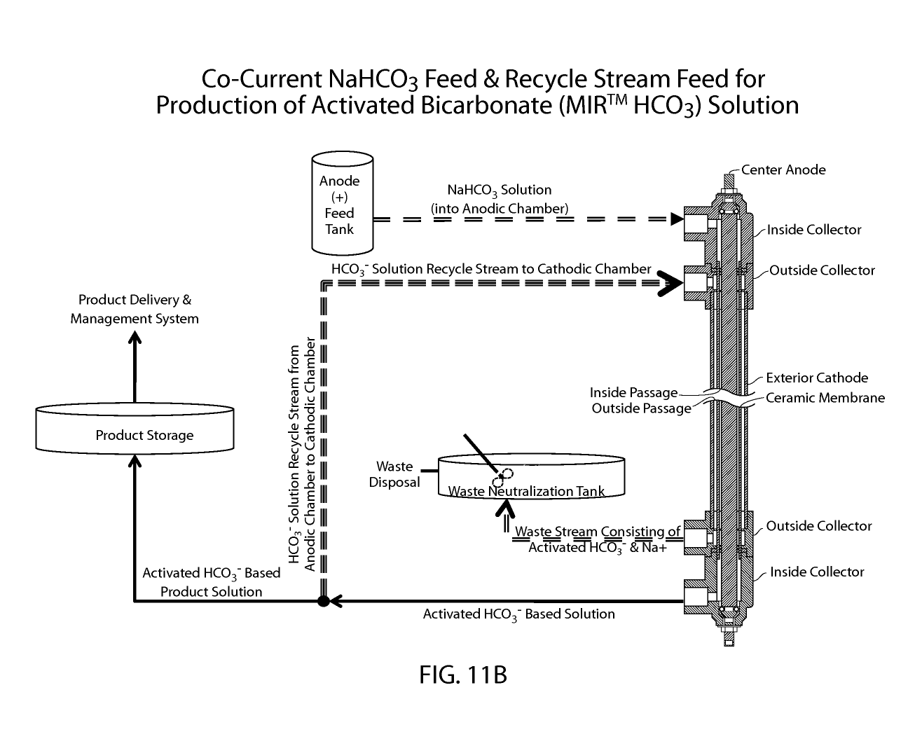

The synthesis of bicarbonate ions (HCO₃⁻) ions can be carried out in four different configurations as listed below: counter-current single pass production (FIGS. 8A and 8B); co-current single pass production (FIGS. 9A and 9B); counter-current brine feed and recycle stream feed (FIGS. 10A and 10B); co-current brine feed and recycle stream feed (FIGS. 11A and 11B).

In some embodiments, the bicarbonate ions can be produced from a solution comprising sodium bicarbonate (NaHCO₃). The sodium bicarbonate feed brine used in the synthesis as shown in configurations in FIGS. 8-11, can have conductivities ranging from 4000 μS/cm to 28,000 μS/cm. The typical activated bicarbonate based solution (comprising percarbonic acid) has a pH in the range of 6.7-8. Synthesis using salts of higher conductivities is possible if the FEMs are scaled up proportionally for feed and flow rates to be adjusted to allow synthesis in the typical product pH range of 6.7-8. These syntheses are carried out by feeding the sodium bicarbonate brine solution to the anodic chamber. The sodium (Na⁺) ions electromigrate to the cathode feed chamber via the ceramic membrane, while the bicarbonate (HCO₃⁻) ions is retained the anodic chamber. In the cases of syntheses with recycle stream (FIGS. 10A and 10B and FIGS. 11A and 11B), the bicarbonate ions that are fed into the cathodic chamber (to create concentration gradient) from the recycle stream are partly wasted, while some of the bicarbonate is converted to carbonic acid (H₂CO₃) or carbon dioxide gas (CO₂) in the high pH environment of the cathodic chamber by the migration of the hydronium (H⁺) ions. In the current embodiment of the FEM with pore sizes of the ceramic membranes being larger, the bicarbonate ions in the recycle stream also migrate from the cathode chamber to the anode chamber. During these syntheses, the hydroxide (OH⁻) and hydronium (H⁺) ions migrate across the ceramic membrane between the anodic and cathodic chambers. The adjustment of product pH is therefore carried out by regulating the hydronium (H⁺) ions loss in the cathode chamber waste stream as hydrogen gas (H₂) and the hydroxide (OH⁻) ions in the product stream. In the cases of syntheses with recycle stream (FIGS. 10A and 10B and FIGS. 11A and 11B), the wastage of bicarbonate is also part of the pH adjustment factor together with hydronium (H⁺) and hydroxide (OH⁻) ions. Either regulating the flow rates and/or applying backpressure on the feed and waste streams adjust the product pH stream.

In some embodiments, the electrochemical synthesis of bicarbonate ion product (HCO₃⁻) has the following properties, based on measurements made upon production of bicarbonate ion product (HCO₃⁻): ORP: 500 mV-900 mV; pH: 6.7-8.0; ampere differential between anode and cathode chambers: 1-15 Amperes. The product Oxidation-Reduction Potential (ORP), pH and resonance parameters will adjust over time, with the ORP measurements degrading as the product ages. As the product ages and the product quality deteriorates, the product properties can be maintained by adjusting its dose rates (i.e. by reducing its dilution rate). Therefore product outside the ranges listed above can still be used, and the final decision to not use the product is based on ORP or resonance values. When the ORP or resonance values fall below efficacious levels, the product is no longer considered for use as a scale inhibitor or biocide.

During the electrochemical synthesis, one of the identifiable markers of activation of the brine to produce activated bicarbonate based solution (comprising percarbonic acid) is the cation and anion transfer between the anodic and cathodic chambers resulting in electrical current (or potential difference) between the anode and cathode chamber, that is measured in term of current flowing between the two chambers. This electrical current flowing between the two chambers is measured in terms of amperes, and in the case of the activated bicarbonate based solutions the ampere readings range between 1 and 15 Amps, for the configuration of the FEMs. Upsizing proportionally the FEMs, can potentially allow brine feed of higher conductivity concentrations, resulting in a higher Amps pull between the two chambers during synthesis of the activated bicarbonate based solution (comprising percarbonic acid). When the sodium bicarbonate (NaHCO₃) brine concentration is higher, the ampere pull across the two chambers is higher and this is due to the increased presence of ions at higher NaHCO₃ concentrations.

The feed brine solution is presented as using sodium bicarbonate (NaHCO₃). However other embodiments can include salts of potassium bicarbonate (KHCO₃); aqueous calcium bicarbonate (Ca(HCO₃)₂); and aqueous magnesium bicarbonate (Mg(HCO₃)₂). In the instances where the calcium (Ca²⁺) and magnesium (Mg²⁺) based feed brine solutions are used, the calcium and magnesium ions will migrate from the anodic chamber to the cathodic chamber in the FEMs with adjusted ceramic membrane pore sizes of 20-50 nm.

The feed brine solutions can also be prepared using salts of sodium carbonate (Na₂CO₃); potassium carbonate (K₂CO₃); calcium bicarbonate (CaCO₃); and magnesium bicarbonate (MgCO₃), and synthesizing with or without pH adjustments using acid. The feed brine solution is made up with reverse osmosis permeate or deionised water or distilled water to reduce the introduction of additional anions or cations into the activated product stream, and to increase the purity of the activated product. However, other embodiments can include preparation of the feed brine mix in City or Utility supplied tap water.

In one embodiment, the deionized water feed depicted in the single pass co-current feed and counter-current feed conditions, as shown in FIGS. 8A and 8B and FIGS. 9A and 9B, can be used to create a concentration gradient (in terms of TDS or conductivity measurements) between the anode and cathode chambers. Other water sources that can be used include reverse osmosis permeate or distilled water or even city or utility supplied tap water.

In instances where there is recycling of the waste stream to the cathodic chamber, the rate of wastage from this stream can be utilized to maintain a concentration gradient between the anodic and cathodic chambers. The concentration gradient creates a potential difference between the two chambers that will result in a electrical circuit that will draw current (measured in terms of Amperes across the anodic and cathodic chamber).

### Synthesis of Activated Solutions Comprising Phosphate Ions

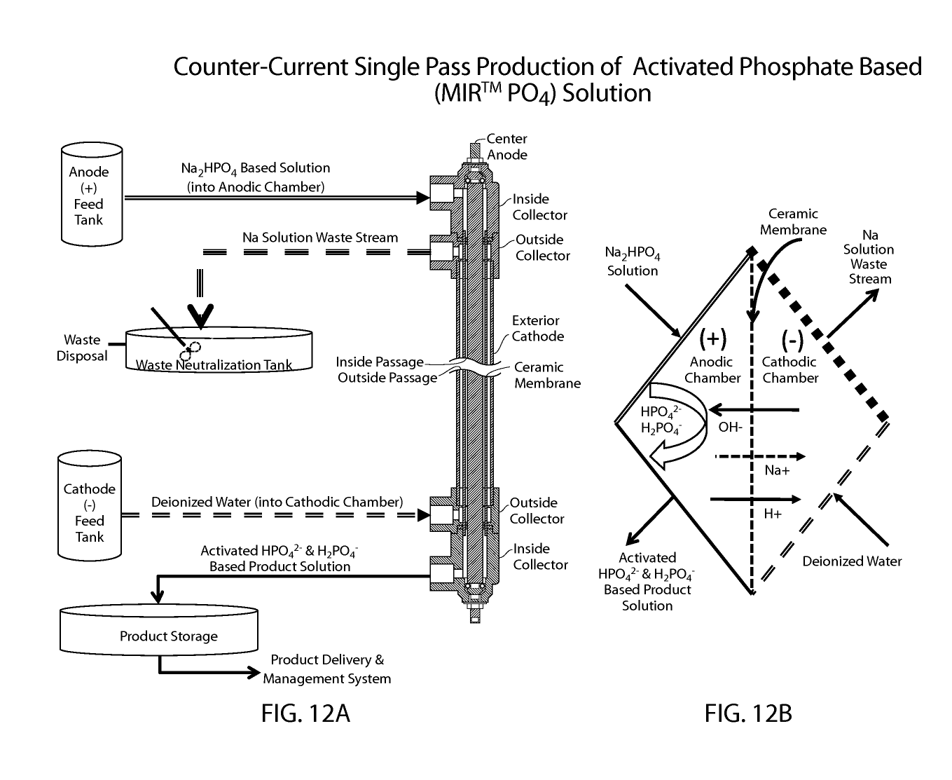

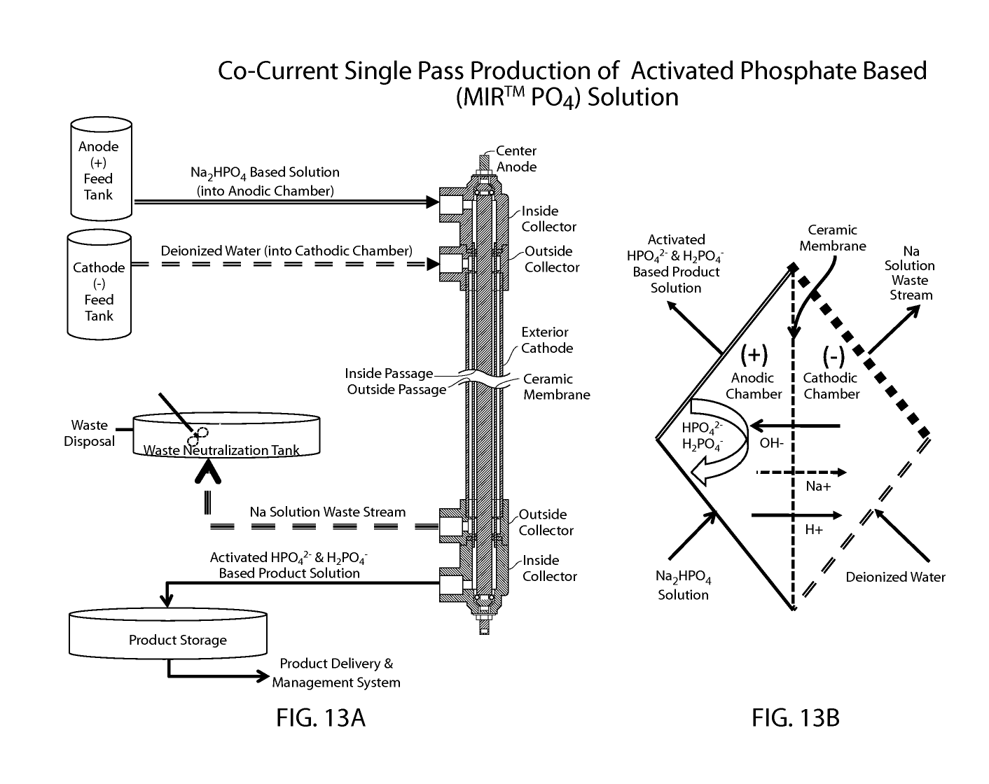

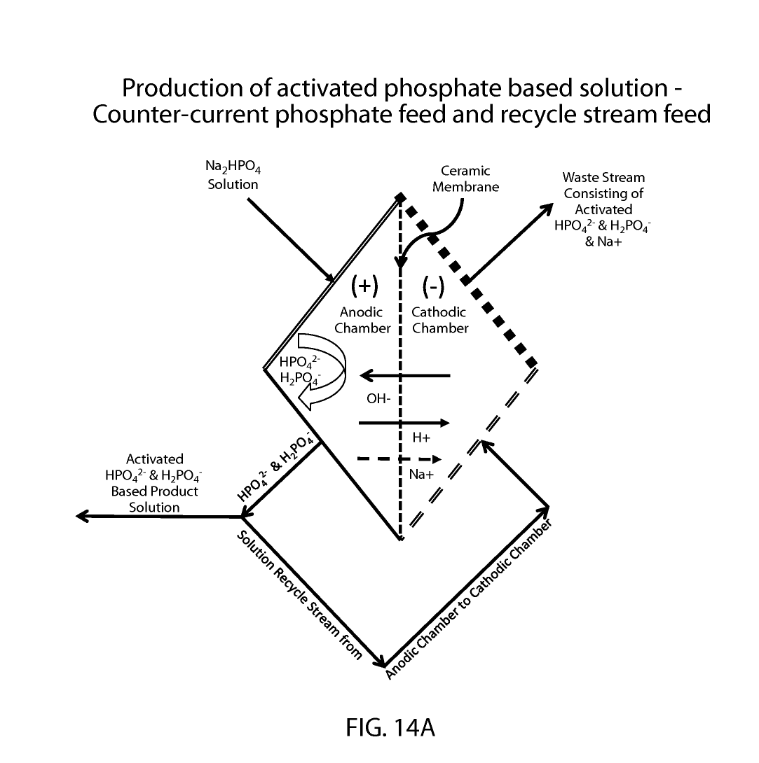

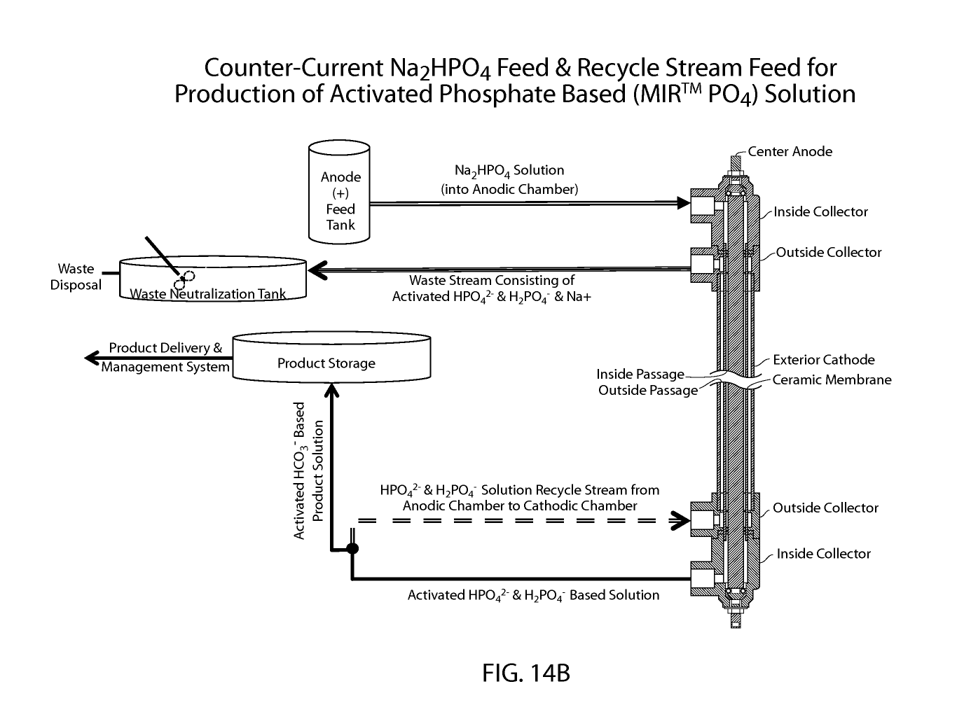

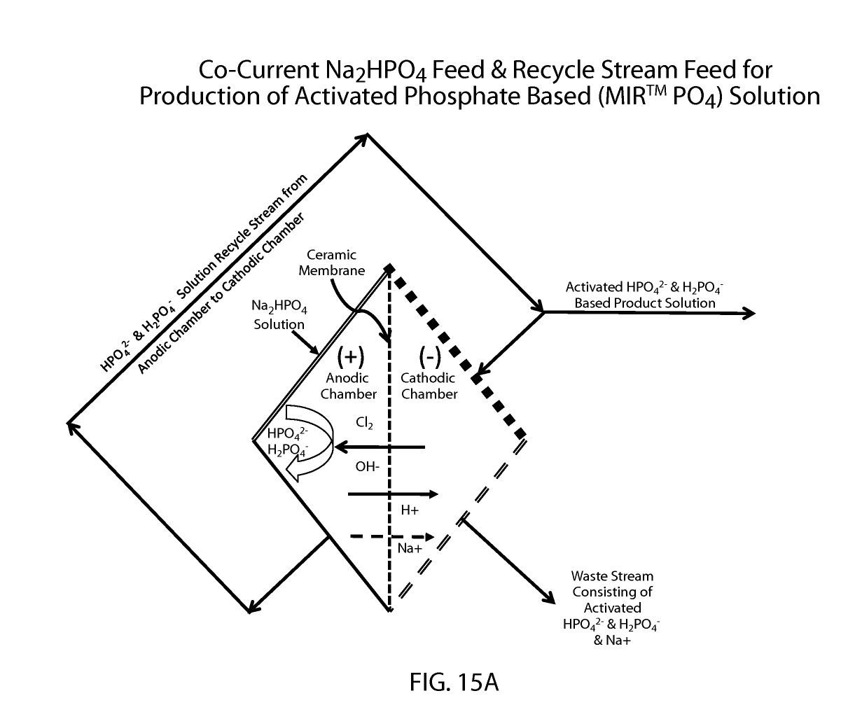

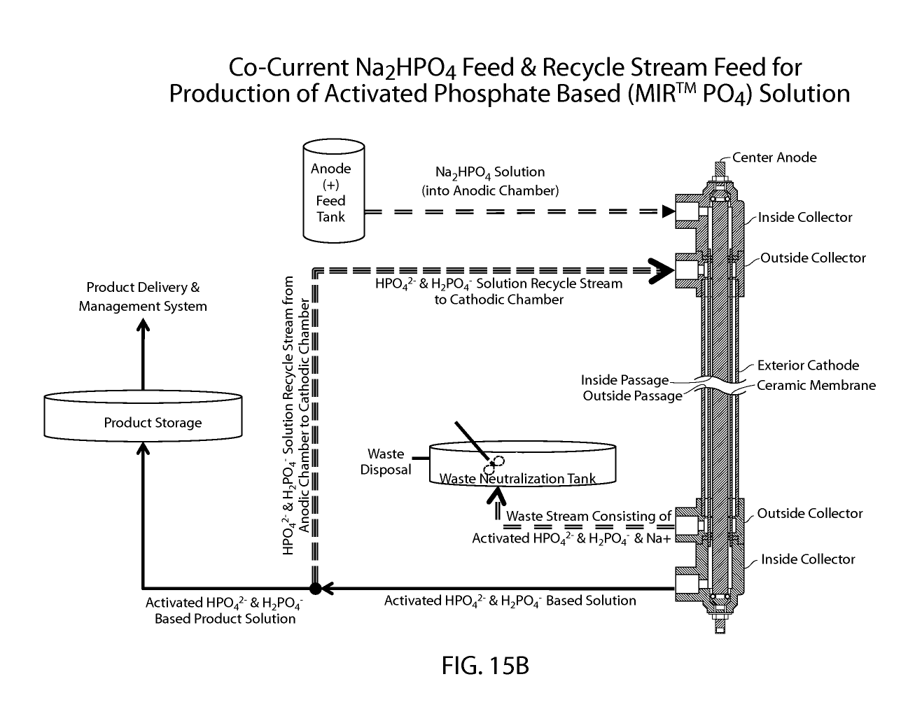

The synthesis of phosphate ions (HPO₄²⁻) can be carried out in four different configurations as listed below: counter-current single pass production (FIGS. 12A and 12B); co-current single pass production (FIGS. 13A and 13B); counter-current brine feed and recycle stream feed (FIGS. 14A and 14B); co-current brine feed and recycle stream feed (FIGS. 15A and 15B).

In some embodiments, the phosphate ions can be produced from a solution comprising disodium phosphate (Na₂HPO₄). In some embodiments, the disodium phosphate feed brine used in the synthesis as shown in configurations in FIGS. 12-15, has conductivities ranging from 2000 μS/cm to 35,000 μS/cm. In other embodiments, the activated phosphate based solution has a pH in the range of 7.2-8.5. Synthesis using salts of higher conductivities is possible if the FEMs can be scaled up proportionally for feed and flow rates to be adjusted to allow synthesis in the typical product pH range of 7.2-8.5. These syntheses are carried out by feeding the disodium phosphate (Na₂HPO₄) brine solution to the anodic chamber. The sodium (Na⁺) ions electromigrate to the cathode feed chamber via the ceramic membrane, while the phosphate (H₂PO₄⁻ and HPO₄²⁻) ions are retained in the anodic chamber. In the cases of syntheses with recycle stream (FIGS. 14A and 14B and FIGS. 15A and 15B), the phosphate ions (H₂PO₄⁻ and HPO₄²⁻) that are fed into the cathodic chamber (to create a concentration gradient) from the recycle stream are partly wasted, while some of the phosphate ions (H₂PO₄⁻ and HPO₄²⁻) are converted to phosphoric acid (H₃PO₄) in the high pH environment of the cathodic chamber by the migration of the hydronium (H⁺) ions. In the current embodiment of the FEM with pore sizes of the ceramic membranes being larger than the phosphate ions (H₂PO₄⁻ and HPO₄²⁻), the phosphate ions in the recycle stream do not migrate from the cathode chamber to the anode chamber. During these syntheses, the hydroxide (OH⁻) and hydronium (H⁺) ions migrate across the ceramic membrane between the anodic and cathodic chambers. The adjustment of product pH, can therefore be carried out by regulating the hydronium (H⁺) ions loss in the cathode chamber waste stream as hydrogen gas (H₂) and the hydroxide (OH⁻) ions loss in the product stream. The product stream pH can be regulated by either regulating the flow rates and/or applying backpressure on the feed and waste streams.

In some embodiments, the electrochemical synthesis of phosphate ions (H₂PO₄⁻ and HPO₄²⁻) has the following properties, based on measurements made upon production of phosphate ions (H₂PO₄⁻ and HPO₄²⁻): ORP: 400 mV-850 mV; pH: 7.2-8.5; ampere differential between anode and cathode chambers: 1-30 Amperes. The product Oxidation-Reduction Potential (ORP), pH and resonance parameters will adjust over time. As the product ages and the product quality deteriorates, the product can still be used by adjusting its dose rates (i.e. by reducing its dilution rate). Therefore product outside the ranges listed above can still be used, and the final decision to not use the product is based on resonance measurements. When the ORP or resonance falls below efficacious levels, the product is no longer considered for use as a scale inhibitor or biocide.

During the electrochemical synthesis, one of the identifiable markers of activation of the brine to produce activated phosphate based solution (comprising monohydrogen phosphate and dihydrogen phosphate) is the cation and anion transfer between the anodic and cathodic chambers resulting in electrical current (or potential difference) between the anode and cathode chamber, that is measured in term of current flowing between the two chambers. This electrical current flowing between the two chambers is measured in terms of amperes, and in the case of the activated based solutions the ampere readings range between 1 and 30 Amps, for the configuration of the EMs. Upsizing proportionally the FEMs, can potentially allow brine feed of higher conductivity concentrations, resulting in a higher Amps pull between the two chambers during synthesis of the activated phosphate based solution. When the disodium phosphate (Na₂HPO₄) brine concentration is higher, the ampere pull across the two chambers is higher and this is due to the increased presence of ions at higher Na₂HPO₄ concentrations.

In some embodiments, the feed brine solution comprises disodium phosphate (Na₂HPO₄). However other embodiments can include salts of dipotassium phosphate (K₂HPO₄); calcium phosphate (Ca₃(PO₄)₂); monomagnesium phosphate (Mg(H₂PO₄)₂); and dimagnesium phosphate (Mg(HPO₄)). The feed brine solutions can also be prepared using water soluble salts of phosphate and synthesizing the brine after pH adjustment.

The feed brine solution is made up with reverse osmosis permeate or deionised water or distilled water to reduce the introduction of additional anions or cations into the activated product stream, and to increase the purity of the activated product. However, other embodiments can include preparation of the feed brine mix in City or Utility supplied tap water.

In one embodiment, the deionized water feed depicted in the single pass co-current feed and counter-current feed conditions, as shown in FIGS. 12A and 12B and FIGS. 13A and 13B, can be used to create a concentration gradient (in terms of TDS or conductivity measurements) between the anode and cathode chambers. Other water sources that can be used include reverse osmosis permeate or distilled water or even city or utility supplied tap water.

In instances where there is recycling of the waste stream to the cathodic chamber, the rate of wastage from this stream can be utilized to maintain a concentration gradient between the anodic and cathodic chambers. The concentration gradient creates a potential difference between the two chambers that will result in a electrical circuit that will draw current (measured in terms of Amperes across the anodic and cathodic chamber).

### Co-Synthesis of Activated Solutions Comprising Hypohalous Acid and Carbonate Ions

In another aspect of the invention, there is provided a method for co-synthesizing a solution comprising activated hypochlorous acid (HOCl), hypobromous acid (HOBr) or Hypoiodous acid (HOI) and activated carbonate ion.

In some embodiments, the feed brine solution to the cathode chamber comprises sodium chloride (NaCl). In other embodiments, the feed brine solution to the cathode chamber may comprise one or more halide salts selected from the group consisting of potassium chloride (KCl); calcium chloride (CaCl₂); magnesium chloride (MgCl₂); sodium bromide (NaBr); potassium bromide (KBr); sodium iodide (NaI); and potassium iodide (KI).

In some embodiments, the feed brine solution to the anode chamber comprises sodium bicarbonate (NaHCO₃). In other embodiments the feed brine solution to the anode chamber may comprise one or more carbonate salts selected from the group consisting of potassium bicarbonate (KHCO₃); aqueous calcium bicarbonate (Ca(HCO₃)₂); and aqueous magnesium bicarbonate (Mg(HCO₃)₂).

The feed brine solution is made up with reverse osmosis permeate or deionised water or distilled water to reduce the introduction of additional anions or cations into the activated product stream, and to increase the purity of the activated product. However, other embodiments can include preparation of the feed brine mix in city or utility supplied tap water.

### Co-Synthesis of Activated Solutions Comprising Hypohalous Acid and Bicarbonate Ion

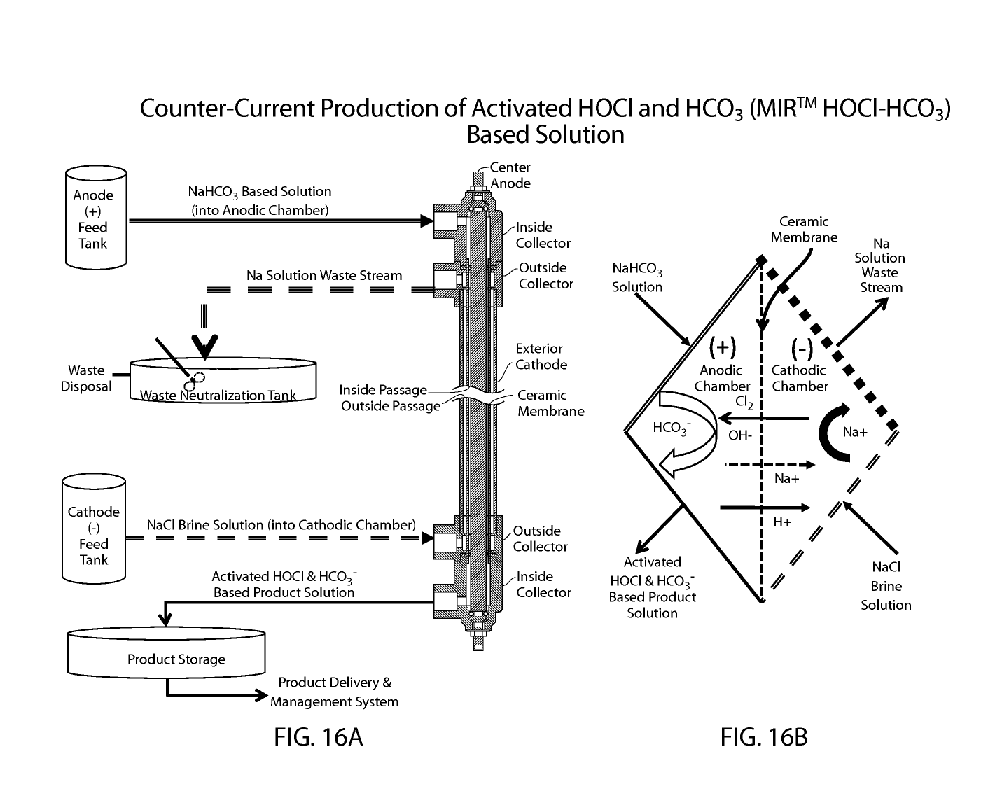

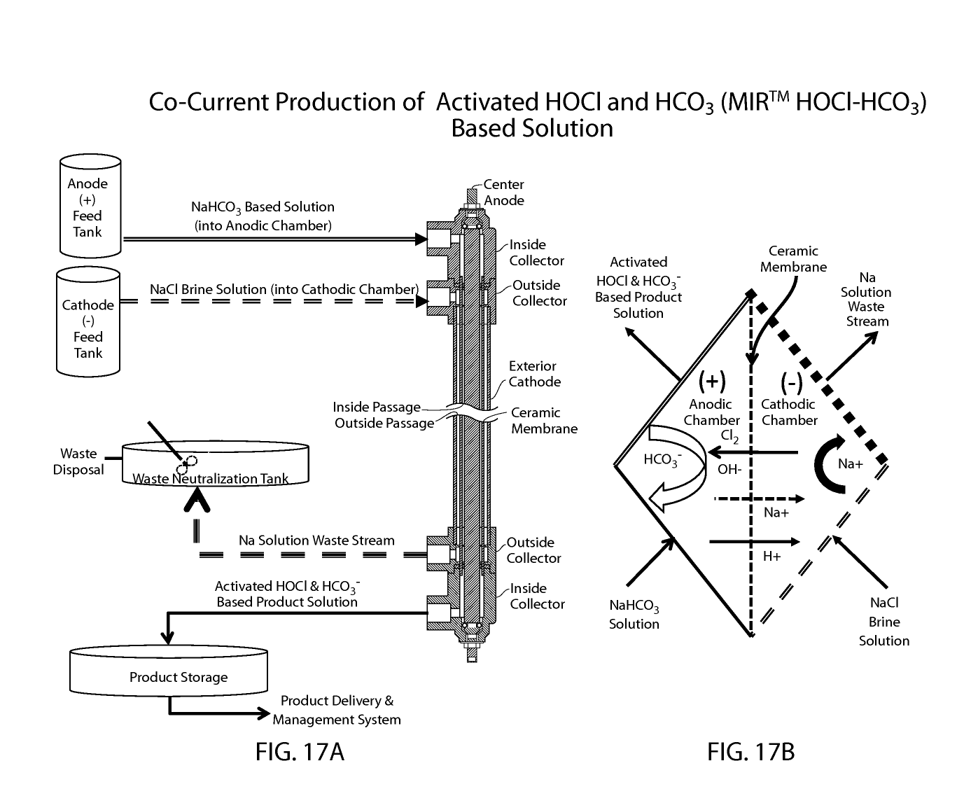

In one particular embodiment, the invention provides a method for synthesis of a solution comprising activated hypochlorous acid and activated bicarbonate ion (HCO₃⁻) solution, derived from the electrolytic reaction of sodium chloride (NaCl) and sodium bicarbonate (NaHCO₃) solution carried out in a flow-through electrolytic module (FEM). The reaction may be performed in either of two distinct configurations: counter-current single pass mode (as illustrated in FIGS. 16A and 16B), or co-current single pass mode (as illustrated in FIGS. 17A and 17B).

The sodium chloride concentrate during synthesis can have conductivities ranging from 2000 μS/cm to 40,000 μS/cm, when using pure salts of sodium chloride (NaCl). The sodium bicarbonate (NaHCO₃) feed brine used in the synthesis can have conductivities ranging from 4000 μS/cm to 28,000 μS/cm, when using sodium bicarbonate salt. The activated hypochlorus acid and bicarbonate based solution that is collected as product from the anodic chamber has a pH in the range of 7.0-8.0. These syntheses are carried out by feeding the sodium bicarbonate (NaHCO₃) brine solution to the anodic chamber and the sodium chloride (NaCl) brine to the cathodic chamber. The sodium (Na⁺) ions from the bicarbonate brine electromigrate to the negatively charged cathode feed chamber via the ceramic membrane, while the bicarbonate (HCO₃⁻) ions are retained in the positively charged anodic chamber. During these synthesizes, the hydroxide (OH⁻) and hydronium (H⁺) ions migrate across the ceramic membrane between the anodic and cathodic chambers. The adjustment of product pH, is therefore carried out by regulating the hydronium (H⁺) ions loss in the cathode chamber waste stream as hydrogen gas (H₂) and the hydroxide (OH⁻) ions loss in the product stream. Either regulating the flow rates and/or applying backpressure on the feed and waste streams adjusts the product pH stream.

The solutions comprising HOCl and bicarbonate ions will generally have the following parameters and product ranges, based on measurements made upon production of product: ORP: 400 mV-850 mV; pH: 7.2-8.5; Ampere differential between anode and cathode chambers: 2-40 Amperes. The product oxidation-reduction potential (ORP), pH and resonance parameters will adjust over time. As the product ages and the product quality deteriorates, product having effective properties can be maintained by adjusting its dose rates (i.e., by reducing its dilution rate). Therefore product outside the ranges listed above can still be used, and the final decision to not use the product is based on resonance measurements. When the resonance falls below acceptable levels, the product is no longer considered for use as a scale inhibitor or biocide.

During the electrochemical synthesis, one of the identifiable markers of activation of the brines to co-generate activated hypochlorus acid and bicarbonate based solution is the cation and anion transfer between the anodic and cathodic chambers resulting in electrical current (or potential difference) between the anode and cathode chamber, that is measured in term of current flowing between the two chambers. This electrical current flowing between the two chambers is measured in terms of amperes, and in the case of the activated solutions the ampere readings range between 2 and 40 Amps, for the configuration of the FEMs.

In accordance with the above methods, the present invention provides methods for using an in-solution resonance meter to monitor production of co-synthesized activated hypochlorus acid and bicarbonate based solution. The resonance meter is used in quantifying the stability of the product; degradation rate of activated product solution and therefore becoming the key factor in deciding when the product use for its de-scaling, scale inhibition and biocidal effects should be discontinued;

In one aspect, the present invention further provides a novel method using a single pass sodium chloride (NaCl) brine feed to cathodic chamber in conjunction with sodium bicarbonate (NaHCO₃) brine to the anode chamber, by way of counter-current feed of the two feeds to co-synthesis the activated hypochlorus acid and bicarbonate based solution, as represented in FIGS. 16A and 16B.

In another aspect, the present invention further provides a novel method using a single pass sodium chloride (NaCl) brine feed to cathodic chamber in conjunction with sodium bicarbonate (NaHCO₃) brine to the anode chamber, by way of co-current feed of the two feeds to co-synthesis the activated hypochlorus acid and bicarbonate based solution, as represented in FIGS. 17A and 17B.

### Co-Synthesis of Activated Solutions Comprising Hypohalous Acid and Phosphate Ions

In one aspect of the invention, there is provided a method for co-synthesizing a solution comprising activated hypohalous acid, such as hypochlorous acid (HOCl), hypobromous acid (HOBr) or Hypoiodous acid (HOI) and activated phosphate ion.

In some embodiments, the feed brine solution to the cathode chamber comprises sodium chloride (NaCl). In other embodiments, the feed brine solution may comprise one or more halide salts selected from the group consisting of potassium chloride (KCl); calcium chloride (CaCl₂); magnesium chloride (MgCl₂); sodium bromide (NaBr); potassium bromide (KBr); sodium iodide (NaI); and potassium iodide (KI).

In some embodiments, the feed brine solution to the anode chamber is disodium phosphate (Na₂HPO₄). In other embodiments the feed brine solution to the anode chamber may comprise one or more phosphate salt selected from the group consisting of dipotassium phosphate (K₂HPO₄); calcium phosphate (Ca₃(PO₄)₂); monomagnesium phosphate (Mg(H₂PO₄)₂); and dimagnesium phosphate (Mg(HPO₄)). The feed brine solutions can also be prepared using water soluble salts of phosphate and synthesizing the brine after pH adjustment.

The feed brine solution is made up with reverse osmosis permeate or deionised water or distilled water to reduce the introduction of additional anions or cations into the activated product stream, and to increase the purity of the activated product. However, other embodiments can include preparation of the feed brine mix in City or Utility supplied tap water.

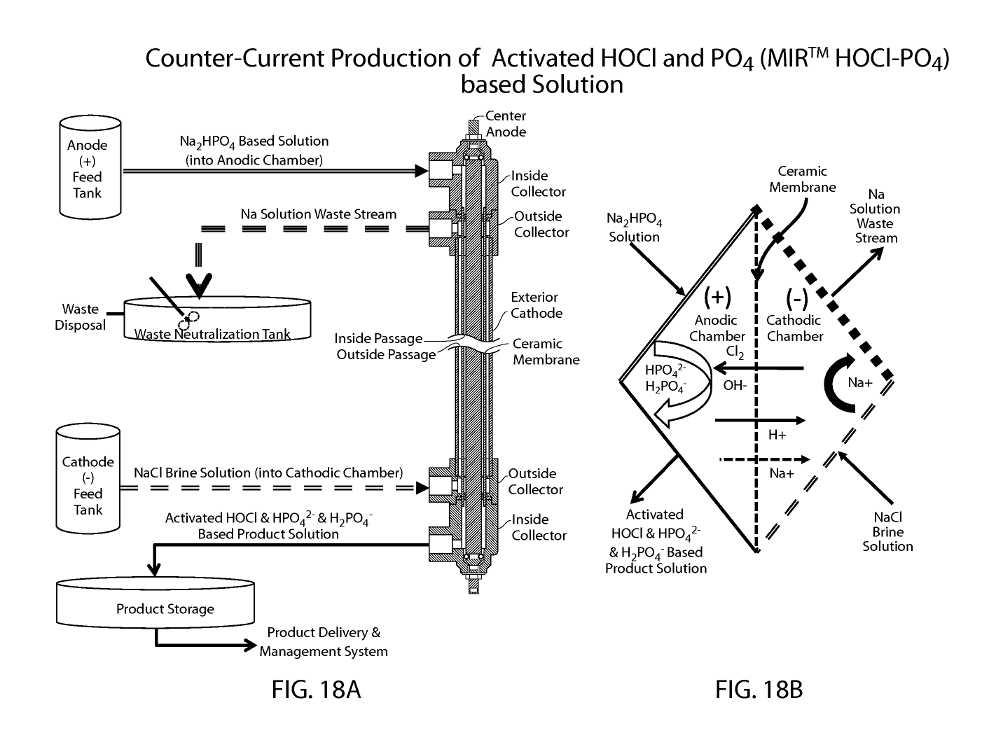

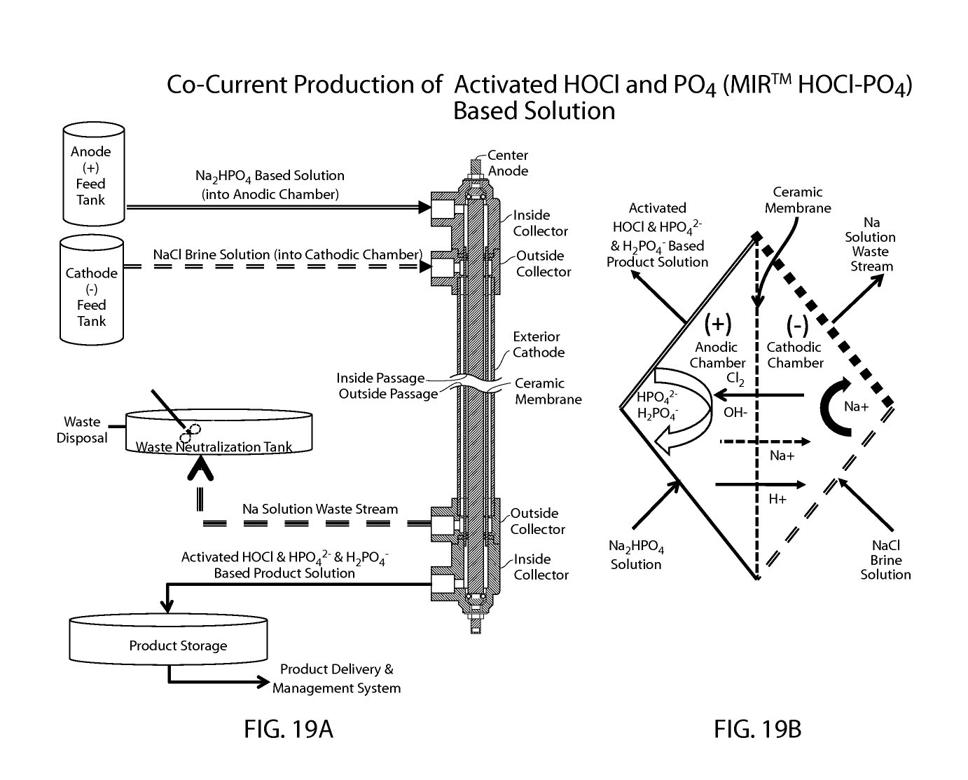

In one particular embodiment, the invention provides a method for synthesis of a solution comprising activated hypochlorous acid (HOCl) and activated phosphate ion, derived from the electrolytic reaction of sodium chloride (NaCl) and disodium phosphate (Na₂HPO₄), which can be carried out in either of two distinct configurations: counter-current single pass production (as illustrated in FIGS. 18A and 18B), or co-current single pass production (FIGS. 19A and 19B).

The sodium chloride concentrate range during the co-synthesis of sodium chloride and sodium bicarbonate can have conductivities ranging from 2000 μS/cm to 40,000 μS/cm, when using pure salts of sodium chloride (NaCl). The disodium phosphate (Na₂HPO₄) feed brine used in the synthesis can have conductivities ranging from 2000 μS/cm to 35,000 μS/cm, when using disodium phosphate (Na₂HPO₄) salt. The activated hypochlorus and phosphate based solution that is collected as product from the anodic chamber has a pH in the range of 7.2-8.5. These synthesizes are carried out by feeding the disodium phosphate (Na₂HPO₄) brine solution to the anodic chamber and the sodium chloride (NaCl) brine to the cathodic chamber. The sodium (Na⁺) ions from the phosphate brine electromigrate to the cathode feed chamber via the ceramic membrane, while the phosphate (H₂PO₄⁻ and HPO₄²⁻) ions are retained in the anodic chamber. During these synthesizes, the hydroxide (OH⁻) and hydronium (H⁺) ions migrate across the ceramic membrane between the anodic and cathodic chambers. The adjustment of product pH, is therefore carried out by regulating the hydronium (H⁺) ions loss in the cathode chamber waste stream as hydrogen gas (H₂) and the hydroxide (OH⁻) ions loss in the product stream. Either regulating the flow rates and/or applying backpressure on the feed and waste streams adjust the product pH stream.

The electrochemical synthesis of activated solutions comprising hypohalous acid and phosphate ions produces solutions having the following parameters and product ranges, based on measurements made upon production of product: ORP: 400 mV-850 mV; pH: 7.2-8.5; Ampere differential between anode and cathode chambers: 10-40 Amperes. The product Oxidation-Reduction Potential (ORP), pH and resonance parameters will adjust over time. The ORP measurements will degrade as the product ages. As the product ages and the product quality deteriorates, effective product can be maintained by adjusting its dose rates (i.e., by reducing its dilution rate). Therefore product outside the ranges listed above can still be used, and the final decision to not use the product is based on resonance measurements. When the resonance falls below efficacious values, the product is no longer considered for use as a scale inhibitor or biocide.

During the electrochemical synthesis, one of the identifiable markers of activation of the brines to co-generate activated hypochlorus acid and phosphate based solution is the cation and anion transfer between the anodic and cathodic chambers resulting in electrical current (or potential difference) between the anode and cathode chamber, that is measured in term of current flowing between the two chambers. This electrical current flowing between the two chambers is measured in terms of amperes, and in the case of the activated based solutions the ampere readings range between 10 and 40 Amps, for the configuration of the EMs.

In accordance with the above methods, the present invention provides methods for using an in-solution resonance meter to monitor production of co-synthesized activated hypochlorus acid and phosphate based solution. The resonance meter is used in quantifying the stability of the product; degradation rate of activated product solution and therefore becoming the key factor in deciding when the product use for its de-scaling, scale inhibition and biocidal effects should be discontinued;

In another embodiment, the present invention further provides methods for using a single pass sodium chloride (NaCl) brine feed to cathodic chamber in conjunction with disodium phosphate (Na₂HPO₄) brine to the anode chamber, by way of counter-current feed of the two feeds to co-synthesize the activated hypochlorus acid and phosphate based solution, as represented in FIGS. 18A and 18B.

In another embodiment, the present invention further provides methods for using a single pass sodium chloride (NaCl) brine feed to cathodic chamber in conjunction with disodium phosphate (Na₂HPO₄) brine to the anode chamber, by way of co-current feed of the two feeds to co-synthesize the activated hypochlorus acid and phosphate based solution, as represented in FIGS. 19A and 19B.

### Co-Synthesizing Activated Solutions Comprising Hypohalous Acid, Bicarbonate Ions and Phosphate Ions

In one aspect of the invention, there is provided a method for co-synthesizing a solution comprising activated hypohalous acid, such as hypochlorous acid (HOCl), hypobromous acid (HOBr) or Hypoiodous acid (HOI), together with activated phosphate ion and activated carbonate ion.

In some embodiments, the feed brine solution to the cathode chamber comprises sodium chloride (NaCl). In other embodiments, the feed brine solution may comprise one or more halide salts selected from the group consisting of potassium chloride (KCl); calcium chloride (CaCl₂); magnesium chloride (MgCl₂); sodium bromide (NaBr); potassium bromide (KBr); sodium iodide (NaI); and potassium iodide (KI).

In some embodiments, the feed brine solution to the anode chamber is presented as using sodium bicarbonate (NaHCO₃). In other embodiments the feed brine solution to the anode chamber may comprise one or more carbonate salts selected from the group consisting of potassium bicarbonate (KHCO₃); aqueous calcium bicarbonate (Ca(HCO₃)₂); and aqueous magnesium bicarbonate (Mg(HCO₃)₂).

In some embodiments, the feed brine solution to the anode chamber is presented as using disodium phosphate (Na₂HPO₄). In other embodiments the feed brine solution to the anode chamber may comprise one or more a phosphate salt selected from the group consisting of dipotassium phosphate (K₂HPO₄); calcium phosphate (Ca₃(PO₄)₂); monomagnesium phosphate (Mg(H₂PO₄)₂); and dimagnesium phosphate (Mg(HPO₄)). The feed brine solutions can also be prepared using water soluble salts of phosphate and synthesizing the brine after pH adjustment.

The feed brine solution is made up with reverse osmosis permeate or deionised water or distilled water to reduce the introduction of additional anions or cations into the activated product stream, and to increase the purity of the activated product. However, other embodiments can include preparation of the feed brine mix in City or Utility supplied tap water.

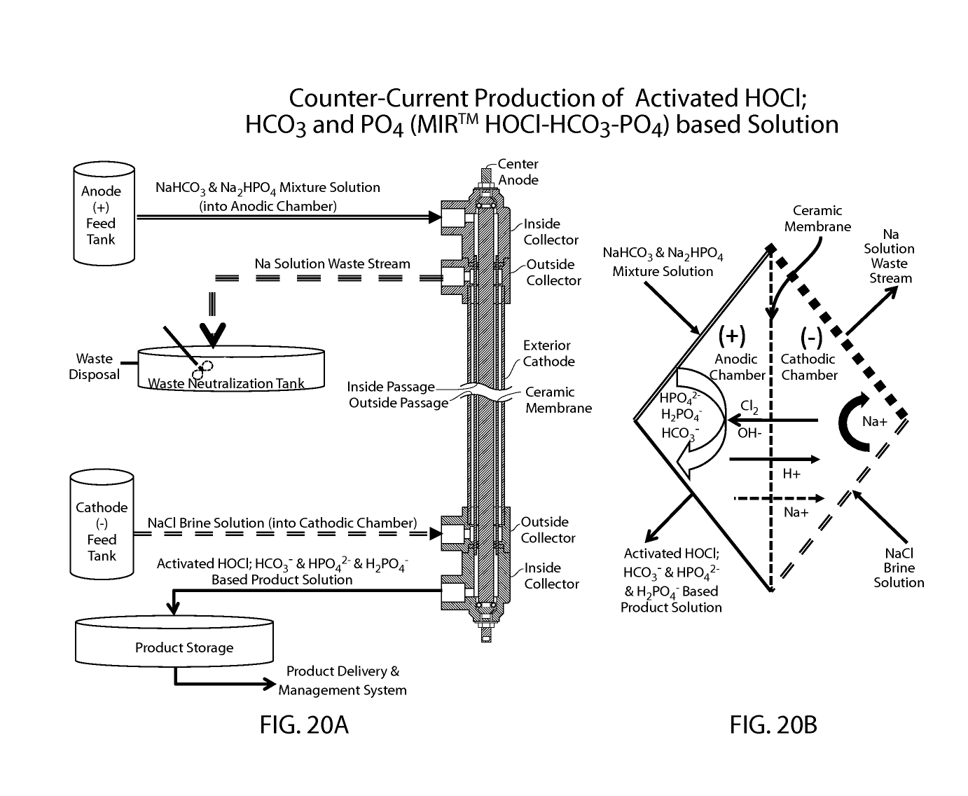

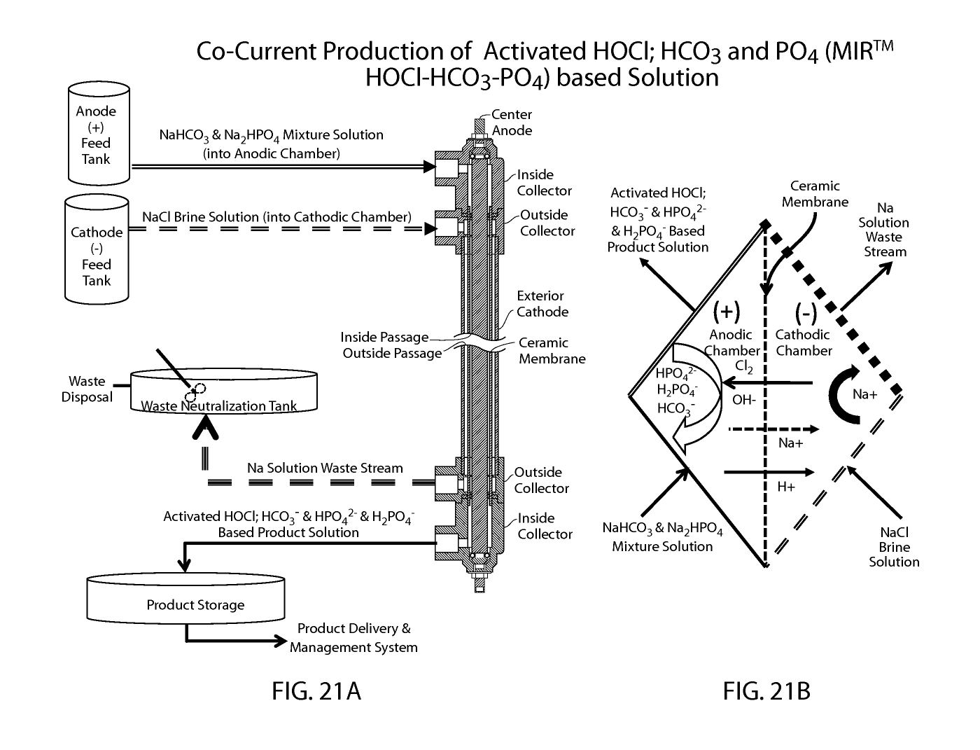

In one particular embodiment, the invention provides a method for synthesis of a solution comprising activated hypochlorous acid (HOCl), activated phosphate ion, and activated carbonate ion, derived from the electrolytic reaction of sodium chloride (NaCl), sodium bicarbonate (NaHCO₃) and disodium phosphate (Na₂HPO₄), which can be carried out in either of two distinct configurations: counter-current single pass production (as illustrated in FIGS. 20A and 20B), or co-current single pass production (FIGS. 21A and 21B).

In some embodiments, the sodium chloride concentrate range during the co-synthesis of sodium chloride and sodium bicarbonate can have conductivities ranging from 2000 μS/cm to 40,000 μS/cm, when using pure salts of sodium chloride (NaCl). The solution consisting a mixture of sodium bicarbonate (NaHCO₃) and disodium phosphate (Na₂HPO₄) feed brine used in the synthesis can have conductivities ranging from 2000 μS/cm to 30,000 μS/cm, when using sodium bicarbonate (NaHCO₃) and disodium phosphate (Na₂HPO₄) salts. The sodium bicarbonate (NaHCO₃) and disodium phosphate (Na₂HPO₄) brine solutions may be prepared separately and then mixed together in the anode chamber feed tank. The anode chamber feed analyte can be a mixture in various combinations depending on whether the target synthesized product is to have more phosphate based activated product or bicarbonate based activated product. Likewise the cathode chamber feed analyte is prepared with the aim of identifying what fraction of the final activated mix of hypochlorus acid and bicarbonate and phosphate based solutions is to be hypochlorus acid.

The activated hypochlorus and phosphate based solution that is collected as product from the anodic chamber has a pH in the range of 7.0-8.5. These syntheses are carried out by feeding the mixture of sodium bicarbonate (NaHCO₃) and disodium phosphate (Na₂HPO₄) brine solution to the anodic chamber and the sodium chloride (NaCl) brine to the cathodic chamber. The sodium (Na⁺) ions from the bicarbonate and phosphate brine mix electromigrate to the cathode feed chamber via the ceramic membrane, while the bicarbonate (HCO₃⁻) and (phosphate (H₂PO₄⁻ and HPO₄²⁻) ions are retained in the anodic chamber. During these synthesizes, the hydroxide (OH⁻) and hydronium (H⁺) ions migrate across the ceramic membrane between the anodic and cathodic chambers. The adjustment of product pH, is therefore carried out by regulating the hydronium (H⁺) ions loss in the cathode chamber waste stream as hydrogen gas (H₂) and the hydroxide (OH⁻) ions loss in the product stream. Either regulating the flow rates and/or applying backpressure on the feed and waste streams adjust the product pH stream.

The electrochemical synthesis of activated hypochlorous acid, phosphate ion and carbonate ion has the following parameters and product ranges, based on measurements made upon production of product: ORP: 500 mV-850 mV; pH: 7.0-8.5; Ampere differential between anode and cathode chambers: 15-40 Amperes. The product Oxidation-Reduction Potential (ORP), pH and resonance parameters will adjust over time. The ORP measurements will degrade as the product ages. As the product ages and the product quality deteriorates, adjusting its dose rates i.e. by reducing its dilution rate, the product can still be used. Therefore product outside the ranges listed above can still be used, and the final decision to not use the product is based on resonance measurements. When the resonance falls below efficacious values, the product is no longer considered for use as a scale inhibitor or biocide.

During the electrochemical synthesis, one of the identifiable markers of activation of the brines to co-generate activated hyphochlorus acid and bicarbonate and phosphate based solution is the cation and anion transfer between the anodic and cathodic chambers resulting in electrical current (or potential difference) between the anode and cathode chamber, that is measured in term of current flowing between the two chambers. This electrical current flowing between the two chambers is measured in terms of amperes, and in the case of the activated based solutions the ampere readings range between 15 and 40 Amps, for the configuration of the FEMs.

In accordance with the above methods, the present invention provides methods for using an in-solution resonance meter to monitor production of co-synthesized activated hypochlorus acid and bicarbonate and phosphate based solution. The resonance meter is used in quantifying the stability of the product; degradation rate of activated product solution and therefore becoming the key factor in deciding when the product use for its de-scaling, scale inhibition and biocidal effects should be discontinued.

In another aspect, the present invention provides methods for using a single pass sodium chloride (NaCl) brine feed to cathodic chamber in conjunction with a mixture of sodium bicarbonate (NaHCO₃) and disodium phosphate (Na₂HPO₄) brine to the anode chamber, by way of counter-current feed of the two feeds to co-synthesis the activated hypochlorus acid and bicarbonate and phosphate based solution, as represented in FIGS. 20A and 20B.

In another aspect, the present invention provides methods for using a single pass sodium chloride (NaCl) brine feed to cathodic chamber in conjunction with a mixture of sodium bicarbonate (NaHCO₃) and disodium phosphate (Na₂HPO₄) brine to the anode chamber, by way of co-current feed of the two feeds to co-synthesis the activated hypochlorus acid and bicarbonate and phosphate based solution, as represented in FIGS. 21A and 21B.

The products produced according to the methods of the present invention can be used in numerous applications to improve water quality, including reduction of biofilms and reduction of mineral scaling.

### Cooling Tower Applications

The products of the present invention can be used in cooling tower applications to control and regulate the deposition of organic and inorganic material on cooling tower contact media and surfaces. The use of activated solutions is, in some embodiments, used as a constant low concentration feed (by way of dilution), to the cooling make-up stream, to regulate the organic and inorganic scaling. In controlling organic fouling in the cooling tower air and water borne pathogens like legionella (the bacterium that causes Legionnaires' disease), are also controlled.

One measure of biological (organic deposition) control in cooling towers is gauged by the loss of oxidation-reduction potential (ORP) of water circulating in the cooling tower. Another way of quantifying the effectiveness of activated solutions in controlling organic fouling is the measure of loss of resonance in the cooling tower over time since the addition of activated solutions. Initially when activated solutions are added to systems the loss of ORP and resonance is expected to be significant as the solutions work to bring the organic foulings under control. Continuous monitoring of ORP and resonance will show that the loss the ORP and resonance reduces over time and a stable condition will be reached, and that organic fouling in the cooling tower is under control. Thus, the activated solutions may be used to effectively reduce existing deposits on cooling tower media surfaces and appurtenances by dissolving or dislodging such deposits from the media and surfaces upon treatment with activated solutions.

The measure of inorganic deposit (scaling) control is observed by reduction of existing deposits on cooling tower media surfaces and appurtenances. The inorganic deposit is dissolved/dislodged from the media and surfaces upon treatment with activated solutions.

Additional benefits of using activated solutions in cooling towers is the potential to increase the number of cycles of circulation of the cooling tower water, thereby reducing the overall water consumption rate. Furthermore the heat exchange capacity of the cooling towers improves with activated solutions application, resulting in improved energy efficiency.

The application of activated in cooling towers can also be extended to chiller water systems and centralized cooling water systems where the control of organic (biological) and inorganic fouling (scale deposits) will increase the energy efficiency of the systems.

Accordingly, the activated products of the present invention can be used to descale (remove inorganic deposits) existing scale in cooling towers, chillers, heat transfer and heat exchange elements as well as to work as antiscalant (as a scale inhibitor) in such systems, while also removing, dislodging and preventing the regrowth of organic deposits (i.e. biofilms, biofoulants, etc.).

### Water Distribution System Applications

The activated solutions of the present invention may also be used in water distribution systems to reduce the potential for biological growth in such distribution systems. The removal of organic and inorganic deposits concurrently with treatment activated solutions comprising hypochlorous acid, results in low/undetected levels of coliform forming units by way of plate count tests.

As a consequent of reduction of organic deposits in water distribution systems, the demand for disinfectant oxidants (free chlorine, total chlorine, chlorine dioxide, etc.) in the distribution systems are reduced. The reduced demand for disinfectant oxidants and the lower availability of organics therefore results in reduced total trihalomethanes (TTHMs) and haloacetic acids (HAA5) formation potential.

Accordingly, the present invention provides novel applications of the activated or hyper-resonating solutions produced using electrochemical synthesis in electromodules to remove, dislodge and prevent the regrowth of organic deposits (i.e. biofilms, biofoulants, etc.), thereby reducing the in-distribution demand for disinfectants by the organic deposits. The reduction and control of organic deposits and amount disinfectant added, will also reduce the TTHM and HAA-5 and formation potential of the water medium (water or treated wastewater effluent using advanced processes).

### Increasing Conveyance Capacity

In yet another application, the activated solutions of the present invention can be used to increase conveyance capacity of water distribution systems by reducing the presence of or potential for inorganic deposits in such distribution systems. Existing inorganic deposits have been noted to be aggressively removed or progressively removed depending on the dose rate of activated solutions. The activated solutions application for inorganic deposit control can be carried out in low dose rates while the water supply system remains operational without any significant water quality changes to customers. The continuous application of activated solutions is known to prevent new deposits on water distribution systems and appurtenances thereby increasing the life, thereby deferring the replacement water supply mains and appurtenances.

Accordingly, the methods and products of the present invention may be used to descale (remove inorganic deposits) existing scale (inorganic deposits) in water distribution systems (including all appurtenances and devices from the water utilities or water purveyors premises to the water user, i.e. including but not limited to pumps, air valves, washout appurtenances, service reservoirs, fire hydrants, water storage tanks, holding tanks, chambers, etc.) as well as to work as antiscalant (i.e., scale inhibitor) in such systems to prevent re-build up of scales and inorganic deposits.

### Water Treatment Processes

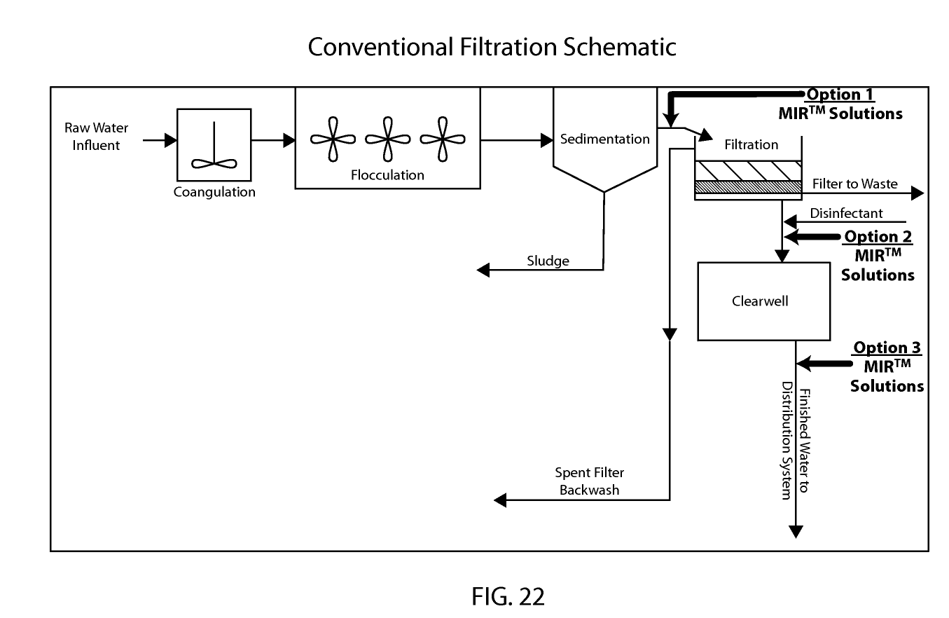

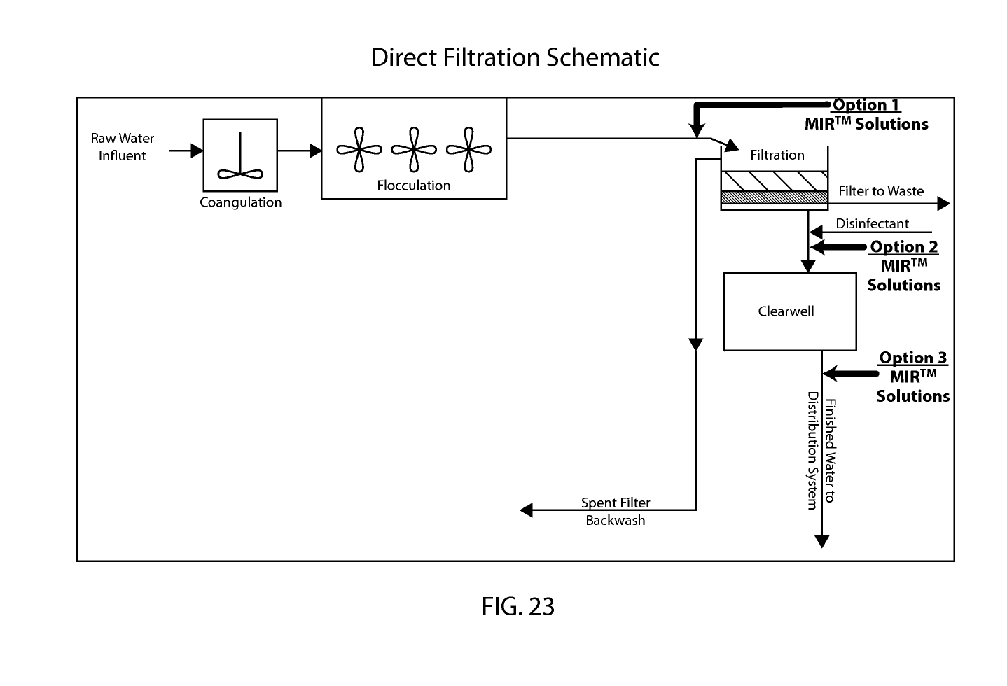

In yet another aspect, the novel methods and products of the present invention may be used to simultaneous control biofouling and scale in conventional water treatment processes that rely on coagulation and flocculation methodologies. In a conventional surface water treatment plant using the coagulation-flocculation process followed by either a sludge collection system using a sedimentation basin (for settled sludge collection) or a dissolved air flotation system (upflow collection system), there are three possible areas of application of activated solutions. In some coagulation-flocculation water treatment systems, the treated water may be directly fed to a filtration system without a sludge removal system. All sludge removal will be in the filtration system. FIG. 22 shows a schematic of a coagulation-flocculation water treatment system with a sedimentation sludge collection system. FIG. 23 shows a schematic of a coagulation-flocculation water treatment system without a sedimentation sludge collection system.

The options of where activated solutions can be added is either or a combination of locations to achieve best organic and inorganic control in the water supply system from such a facility:
Option 1: At a location after the sedimentation tank and before the filtration basin (filtration can be by sand or media filters or by membrane mediated filters)
Option 2: At a location after the filtration basin (filtration can be by sand or media filters or by membrane mediated filters) before clearwell (sometimes also known as ground storage tank or treated water storage tank), in conjunction with water suppliers disinfectant program. Dosing activated solutions at this location helps control the demand for disinfectants in the clearwell.
Option 3: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.

Accordingly, the methods and products of the present invention may be used to dose at various locations or steps in a water supply system, so as to control the inorganic and organic deposit levels in water distribution systems (including all appurtenances and devices from the water utilities or water purveyors premises to the water user, i.e. including but not limited to pumps, air valves, washout appurtenances, fire hydrants, service reservoirs, water storage tanks, holding tanks, chambers, etc.), and, by way of controlling organic deposits, by dosing at such locations using the activated solution, to reduce TTHMs and HAA-5 formation potential in water supply system with water treatment.

### Ground Water Treatment to Hardness Removal

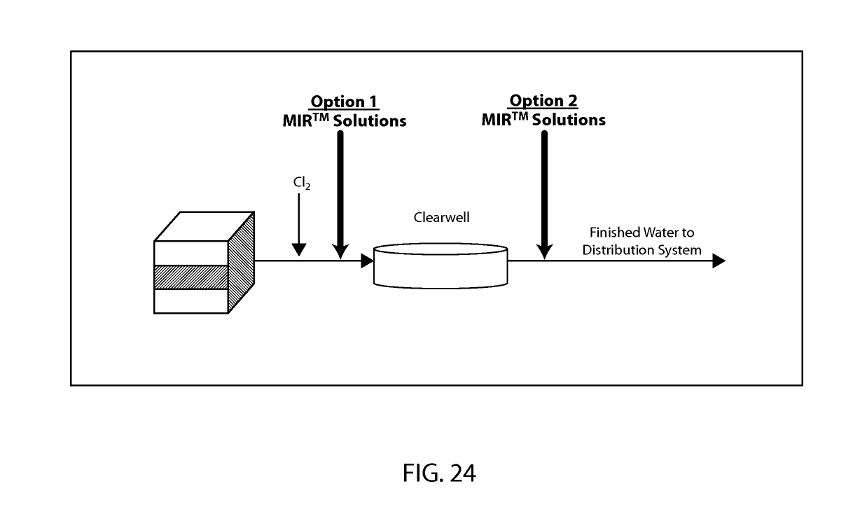

In yet another aspect, the activated solutions of the present invention may further be used in a conventional water softening treatment plant using the coagulant and lime addition. FIG. 24 shows a possible application of the solutions of the present invention used in a direct filtration process of a lime softening plant. Such solutions can be added is either or a combination of locations to achieve best organic and inorganic control in the water supply system from such a facility:
Option 1: At a location after the filtration basin (filtration can be by sand or media filters or by membrane mediated filters) before clearwell (sometimes also known as ground storage tank or treated water storage tank), in conjunction with water suppliers disinfectant program. Dosing activated solutions at this location helps control the demand for disinfectants in the clearwell.
Option 2: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.

Accordingly, the methods and products of the present invention may be used to control the inorganic and organic deposit levels in water distribution systems (including all appurtenances and devices from the water utilities or water purveyors premises to the water user, i.e. including but not limited to pumps, air valves, washout appurtenances, fire hydrants, service reservoirs, water storage tanks, holding tanks, chambers, etc.) and, by way of controlling organic deposits, by dosing at such locations using the activated solution, to reduce TTHMs and HAA-5 formation potential in water supply system with water treatment.

### Biofouling and Scaling Control in Low-Pressure Membrane Systems

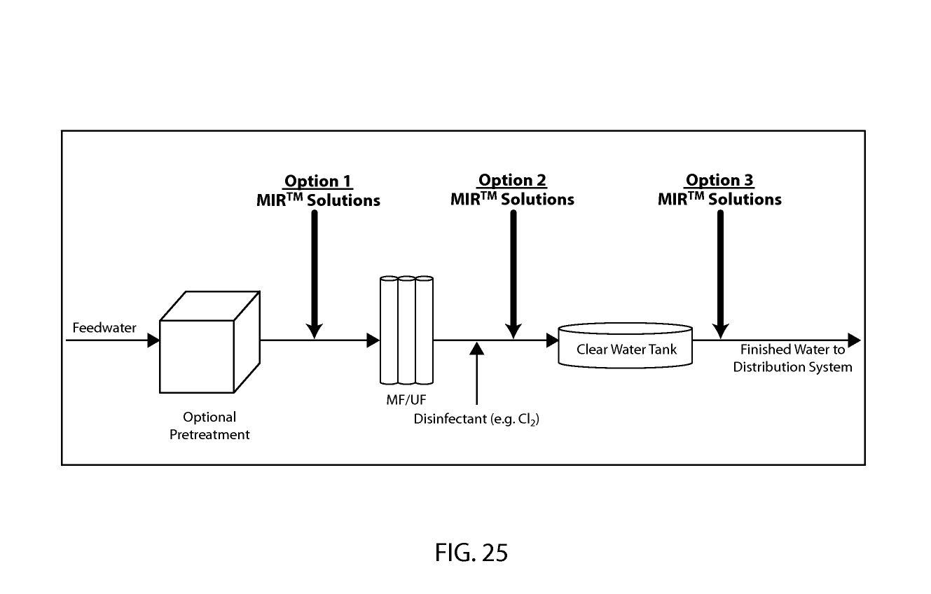

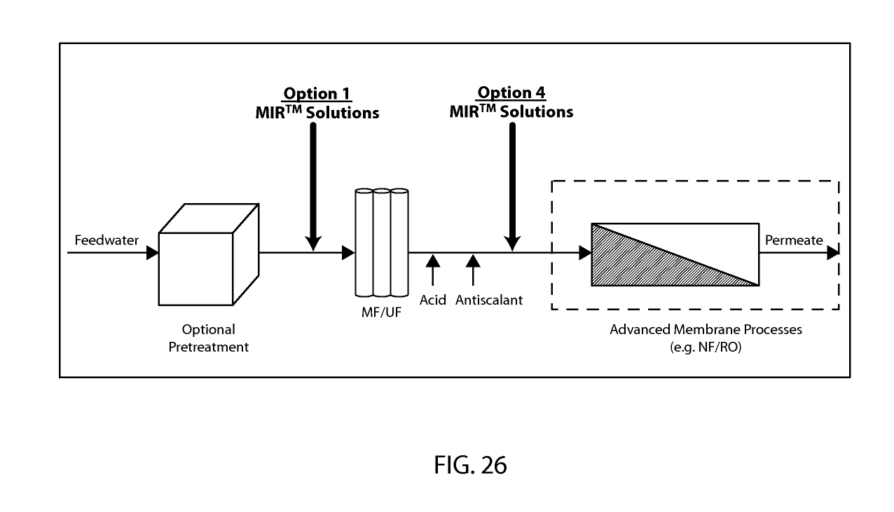

In yet another aspect, the activated solutions of the present invention may be used to control biofouling and scaling in low-pressure membrane systems used in water production. By way of example, FIG. 25 illustrates where the solutions of the present invention can be added, either alone or in combination at locations to achieve the best organic and inorganic control in the water supply system. FIG. 26 shows a low-pressure membrane system (microfiltration/ultrafiltration processes) used in water treatment to filter the water source, with an optional pretreatment process. The optional pretreatment can include but is not limited to coagulation-flocculation system, coagulant, lime, granular activated carbon (GAC), powdered activated carbon (PAC) addition, etc. The options of where activated solutions can be added is either or a combination of locations to achieve best organic and inorganic control in the water supply system from such a facility. In the treatment scheme depicted in FIG. 26, the solutions of the present invention may be added in conjunction with acid (normally for calcium carbonate inhibition) and antiscalant for as scale inhibitor. In other instances, the low membrane treated water can be fed to the advanced membrane processes without acid or antiscalant addition, as activated solutions act as scale inhibitor. Activated solutions can also act as biofouling control in the treatments schemes.

With reference to FIGS. 25, 26, and 27, the options of where activated solutions can be added is either or a combination of locations to achieve best organic and inorganic control in the water supply system from such a facility:
Option 1: As a pretreatment to low-pressure membrane systems (MF/UF) to control biofouling as well as scale control.
Option 2: At a location after the low-pressure membrane system (MF/UF) and before clearwell (sometimes also known as ground storage tank or treated water storage tank), in conjunction with water suppliers disinfectant program. Dosing activated solutions at this location helps to also control the demand for disinfectants in the clearwell.
Option 3: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.
Option 4: As a pretreatment to advanced membrane systems (MF/UF) and activated solutions can be used in conjunction with acid and antiscalants, or in isolation. Activated solutions will act as both scale inhibitor and biofouling control for the advanced membrane processes.

Accordingly, the methods and products of the present invention may be used to control the inorganic and organic fouling on the low pressure and high pressure membrane systems, as well as controlling the inorganic and organic deposit levels in water distribution systems (including all appurtenances and devices from the water utilities or water purveyors premises to the water user, i.e. including but not limited to pumps, air valves, washout appurtenances, fire hydrants, service reservoirs, water storage tanks, holding tanks, chambers, etc.), and by way of controlling organic deposits, by dosing at such locations using the activated solution, to reduce TTHMs and HAA-5 formation potential in water supply system with water treatment.

### Backwash Cycle in Low-Pressure Membrane Systems

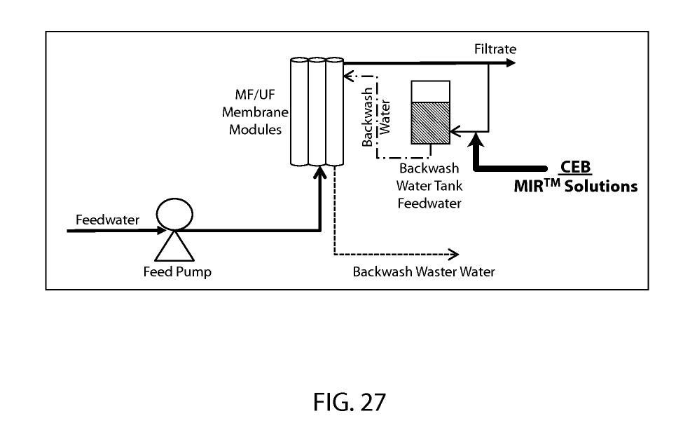

In another aspect, the activated solutions of the present invention may be used to chemically enhance the backwash cycle as part of water production in a low-pressure membrane system, as shown in FIG. 27. Although activated solutions may be used as a chemically enhanced backwash (CEB) solution fed at regular interval between forward filtration cycles of the low pressure membrane system, activated solutions can also be used at higher concentrations, as dictated by manufacturer's specifications, as a clean-in-place (CIP) chemical to remove organic and inorganic foulants in low-pressure membrane systems.

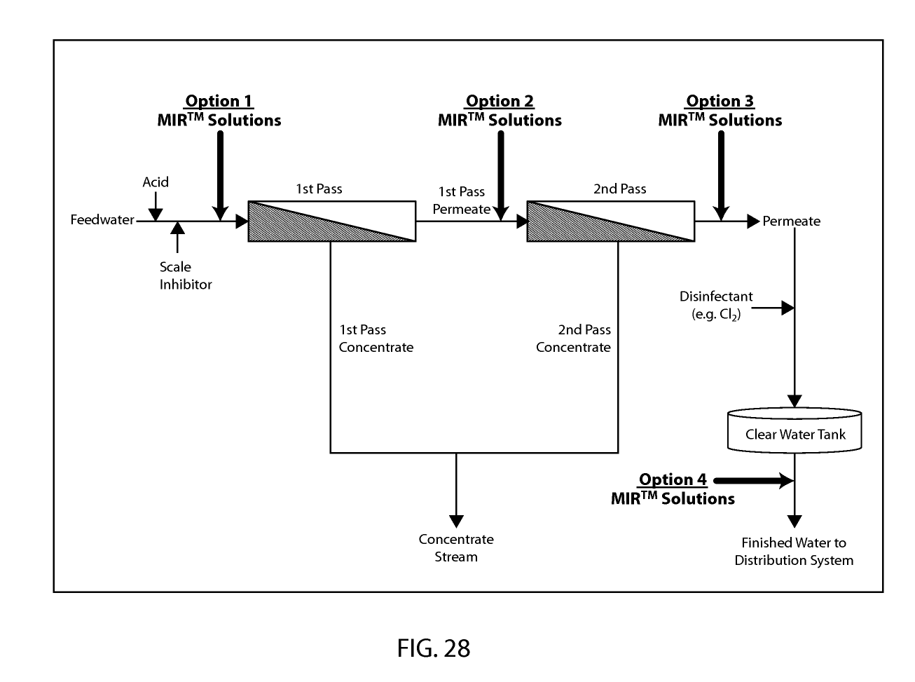

As shown in FIG. 28, the methods and products of the present invention may also be added to control firstly the inorganic and organic fouling potential in high-pressure membrane systems and can also be added to the permeate stream in conjunction with disinfectant before or after the clear water tank. The options of where activated solutions can be added is either or a combination of locations to achieve best organic and inorganic control on both the 2-pass high pressure system, as well as in the water supply system from such a facility:
Option 1: As a pretreatment to 1^{st}-pass in a two pass system to control biofouling and also act as scale inhibitor. Activated solutions can be used either in isolation or in conjunction with an existing acid or antiscalant pretreatment program.
Option 2: As a pretreatment to 2^{nd}-pass in a two pass system to act mainly as a scale inhibitor.
Option 3: At a location after the high-pressure membrane system (NF/RO) process and before clearwell (sometimes also known as ground storage tank or treated water storage tank), in conjunction with water suppliers disinfectant program. Dosing activated solutions at this location helps to also control the demand for disinfectants in the clearwell.
Option 4: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.

Accordingly, the methods and products of the present invention may be used to control the inorganic and organic fouling on the high pressure membrane systems (NF/RO), including all appurtenances and devices from the water utilities or water purveyors premises to the water user, i.e. including but not limited to pumps, air valves, washout appurtenances, fire hydrants, service reservoirs, water storage tanks, holding tanks, chambers, etc.), and by way of controlling organic deposits, by dosing at such locations using the activated solution, to reduce TTHMs and HAA-5 formation potential in water supply system with water treatment.

### High-Pressure Membrane Systems

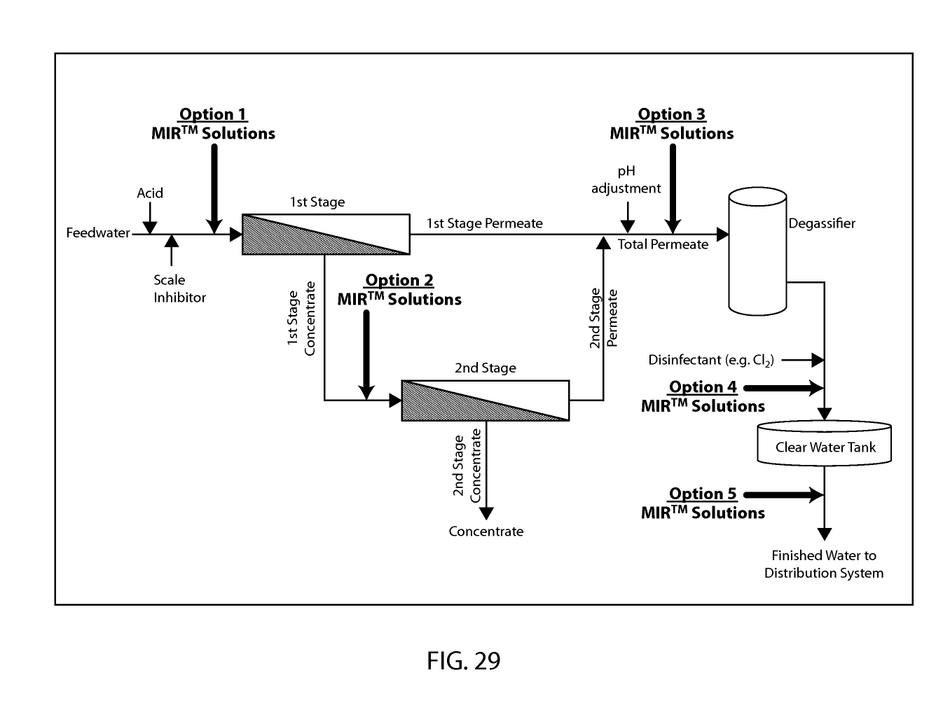

In another aspect, the activated solutions of the present invention can also be used to control the inorganic and organic fouling potential in high-pressure membrane, as shown in Option 1 and Option 2 of FIG. 29. In instances where degassing of permeate is necessary, activated solutions can be added to breakdown hydrogen sulfide or total sulfide and at the same time regulate the growth of bacteria and biofilm on the degassifier media. Activated solutions can also be added to the permeate stream in conjunction with disinfectant before or after the clear water tank, as shown in Option 3 and Option 4 in FIG. 29.

The options of where activated solutions can be added is either or a combination of locations to achieve best organic and inorganic control on both the 2-stage high pressure system, as well as in the pretreatment to a permeate degassifier and in water supply system from such a facility:
Option 1: As a pretreatment to 1^{st}-Stage in a two stage system to control biofouling and also act as scale inhibitor. Activated solutions can be used either in isolation or in conjunction with an existing acid or antiscalant pretreatment program.
Option 2: As a pretreatment to 2^{nd}-pass in a two pass system to act mainly as a scale inhibitor.
Option 3: As a pretreatment to permeate before degassifier to aid in stripping hydrogen sulfide and total sulfide, as well as to regulate biological growth on degassifier media.
Option 4: At a location after the high-pressure membrane system (NF/RO) process and before clearwell (sometimes also known as ground storage tank or treated water storage tank), in conjunction with water suppliers disinfectant program. Dosing activated solutions at this location helps to also control the demand for disinfectants in the clearwell.
Option 5: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.

Accordingly, the methods and solutions made thereby can be used to control the inorganic and organic fouling on the high-pressure membrane systems (NF/RO), as shown as Option 1 and Option 2 in FIG. 29. In particular, in instances where degassing of permeate (Option 3) is necessary, the solutions may be used to aid in stripping of hydrogen sulfide and total sulfide, as well as to regulate biological growth on degassifier media, and to control the inorganic and organic deposit levels in water distribution systems (including all appurtenances and devices from the water utilities or water purveyors premises to the water user, i.e. including but not limited to pumps, air valves, washout appurtenances, fire hydrants, service reservoirs, water storage tanks, holding tanks, chambers, etc.), and by way of controlling organic deposits, by dosing at such locations using the activated solution, to reduce TTHMs and HAA-5 formation potential in water supply system with water treatment. The solutions of the present invention may also be added to the permeate stream in conjunction with disinfectant before or after the clear water tank, shown as Option 4 and Option 5 in FIG. 29.

### Control of Total Sulfide and Sulfide Turbidity in Finished Water

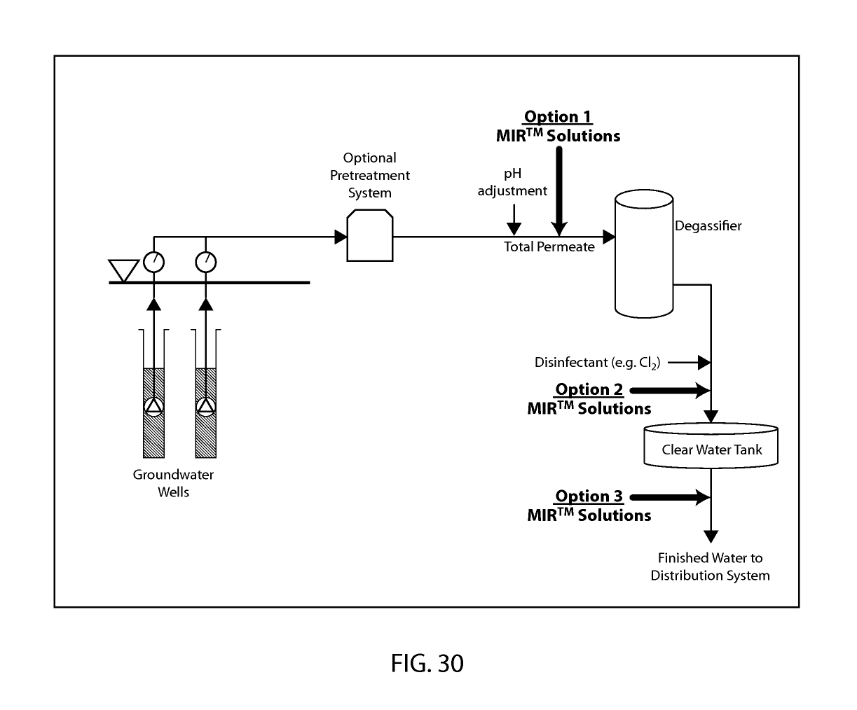

The activated solutions of the present invention can also be added to as a total sulfide stripping aid for groundwater sources, as shown in FIG. 30. Activated solutions can also be added to the permeate stream in conjunction with disinfectant before or after the clear water tank, as shown as Option 2 and Option 3 in FIG. 30.

In the case for the control of total sulfide in groundwater sources there are 3 options where activated solutions can be added in such water supply system:
Option 1: As a pretreatment to permeate before degassifier to aid in stripping hydrogen sulfide and total sulfide, as well as to regulate biological growth on degassifier media.
Option 2: At a location after the groundwater degassifier and before clearwell (sometimes also known as ground storage tank or treated water storage tank), in conjunction with water suppliers disinfectant program. Dosing activated solutions at this location helps to also control the demand for disinfectants in the clearwell.
Option 3: At a location after clearwell also known as point-of entry (POE) to water supply system. Under this Option, the dosing can also be carried out at a distant location within the water supply system, targeting specific sections in the water supply system that requires organic and inorganic deposit controls or where the TTHM and HAA-5 exceed regulatory limits.

Accordingly, the activated solutions may be used to aid in total sulfide stripping in groundwater degassifier as well as to regulate biological growth on degassifier media.

### Biological and Pathogen Control in Wastewater Treatment Discharges

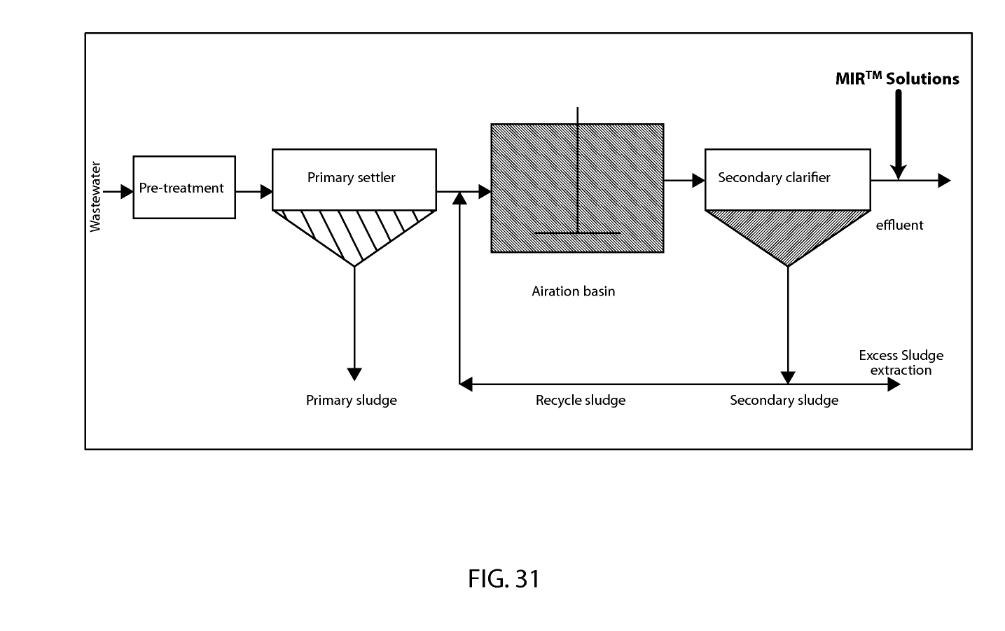

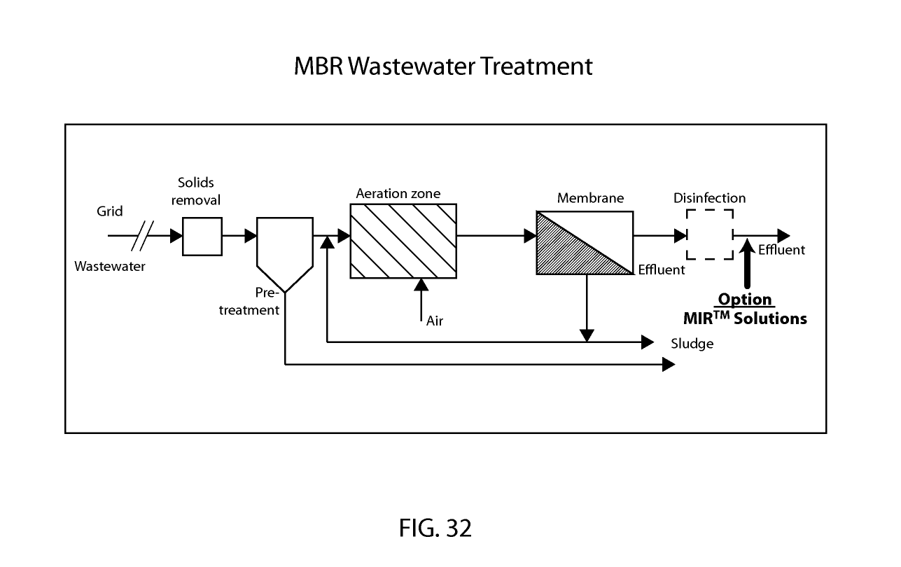

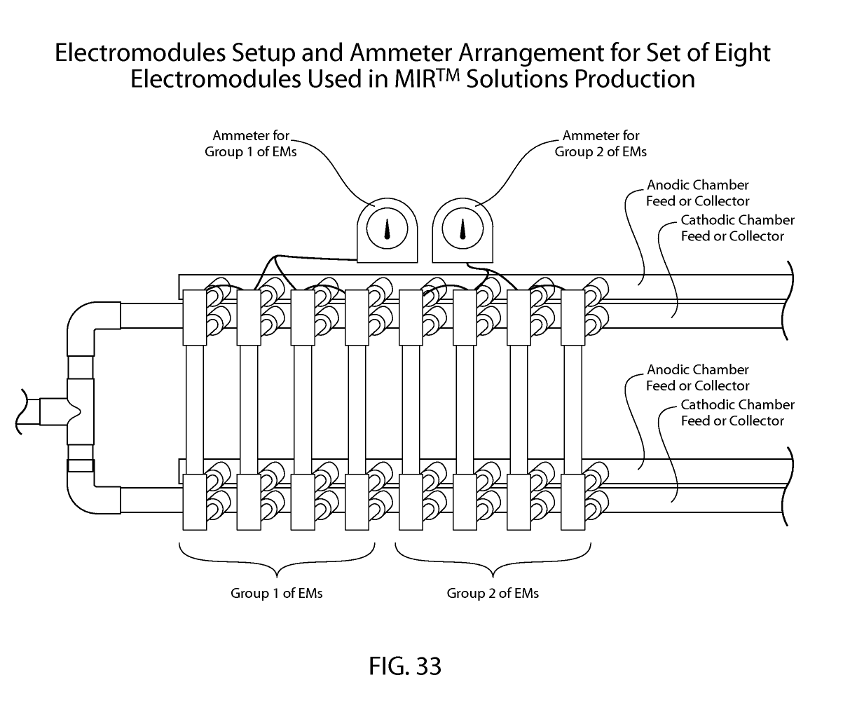

In another aspect, the activated solutions of the present invention can be added to the effluent stream of conventional activated sludge type wastewater treatment, as depicted in FIG. 31, or advanced wastewater treatment processes that include membrane processes, as depicted in FIG. 32. Other equivalent wastewater treatment processes (trickling filters, rotating biological contactors, anaerobic wastewater treatment, fluidized bed reactors, submerged attached growth processes, etc.) are also included under this wastewater treatment domain. Activated solutions are added in wastewater treatment effluents primarily as biofouling and pathogen control and it can be utilized with or without another disinfectant like chlorine, chlorine dioxide, etc.

Accordingly, the activated solutions are useful to control biofouling in effluent transfer system and as pathogen control.

### Combination Products

The activated solutions prepared according to the methods disclosed herein and in the Examples below may also be combined with each other in various ratios. For example, in some embodiments of the present invention, activated bicarbonate ion solution and activated hypochlorous acid solutions may be mixed in various ratios. It has been found that mixtures of activated hypochlorous acid solutions have greater stability and greater activity over time when activated bicarbonate ion solution is combined with the activated hypochlorous acid solution. In some embodiments, the mixture comprises greater than about 2% by volume activated bicarbonate solution. In some embodiments, the mixtures may comprises greater than about 5%, 10%, 15%, 20%, 25%, 30%, 35%, 40%, 45%, 50%, 55%, 60%, 65%, 70%, 75%, 80%, 85%, 90% or greater by volume activated bicarbonate solution.

The activated solutions prepared according to the methods disclosed herein and in the Examples below may also be combined with each other in various ratios. For example, in some embodiments of the present invention, activated phosphate ion solution and activated hypochlorous acid solutions may be mixed in various ratios. Mixtures of activated hypochlorous acid solutions may also have greater stability and greater activity over time when activated phosphate ion solution is combined with the activated hypochlorous acid solution. In some embodiments, the mixture comprises greater than about 2% by volume activated phosphate solution. In some embodiments, the mixtures may comprises greater than about 5%, 10%, 15%, 20%, 25%, 30%, 35%, 40%, 45%, 50%, 60%, 65%, 70%, 75%, 80%, 85%, 90% by volume activated phosphate solution.

The following examples illustrate some of the embodiments of the present invention:

### EXAMPLES

### Electromodules Layout

The activated products manufacturing test station consists of 8 Electro Modules (EMs), configured in parallel by half-inch (½ in.) piping system. The manufacturing test station was designed as half-inch (½ in.) pipe system, and the feed and collector piping to the anodic and cathodic chambers were also half-inch (½ in.) piping. The 8 EMs were split into 2 groups of 4 EMs for the measurement of electric charge. The electric charge differential across the anode and cathode chambers of the groups of 4 EMs during the synthesis of the activated products is measured using ammeters. The layout of the 8 EMs and the positioning of the ammeters are as shown in FIG. 3.

Brine solution feed to the anodic chamber and cathodic chamber were from two 55-gallons drums. Where the production process requires only one feed brine solution, the unused feed tank is isolated using valves. The production methods involving single feed brine is the synthesis (or activation) involving either counter-current or co-current feed with recycle stream. The feed pump to the anode chamber is a Flotec ½ horsepower shallow well pump, while the feed pump to the cathode chamber is a Little Giant@ ¼ horsepower Magnetic drive pump. The layout of the anodic and cathodic chambers feed brine tanks are as depicted in FIG. 9.

### Brine Preparation:

Feed brine solutions are made in reverse osmosis (RO) permeates. Other embodiments using distilled water, deionized water and even public utility supplied water can also be used in brine preparations. The evaluations carried out and reported here are using RO permeate, so as to reduce the introduction of additional anions or cations into the activated product stream, and to increase the purity of the activated product. Brine solutions of varying conductivities for use in the following experiments are prepared as follows:

The mixture feed brine solutions are prepared by preparing each individual feed brine solution separately and then blending in the feed brine tank.

TABLE A
NaCl (sodium chloride) Brine Preparation

| NaCl (oz., 99.9% purity) | Water (gal.) | Conductivity (uS) |
|---|---|---|
| 2.6 | 5 | 8,000 |
| 5.2 | 5 | 16,000 |
| 7.8 | 5 | 24,000 |
| 10.4 | 5 | 32,000 |
| 13 | 5 | 40,000 |

TABLE B
NaHCO3 (sodium bicarbonate) Brine Preparation

| NaHCO3 (lb., 99% purity) | Water (gal.) | Conductivity (uS) |
|---|---|---|
| 0.05 | 1 | 3,500 |
| 0.10 | 1 | 7,000 |
| 0.15 | 1 | 10,500 |
| 0.20 | 1 | 14,000 |
| 0.25 | 1 | 17,500 |
| 0.30 | 1 | 21,000 |
| 0.35 | 1 | 24,500 |
| 0.40 | 1 | 28,000 |
| 0.45 | 1 | 31,500 |
| 0.50 | 1 | 34,000 |

TABLE C
Na2HPO4 (disodium phosphate) Brine Preparation

| Na2HPO4 (oz., 99% purity) | Water (gal.) | Conductivity (uS) |
|---|---|---|
| 3 | 3 | 6,300 |
| 6 | 3 | 12,600 |
| 9 | 3 | 18,900 |
| 12 | 3 | 25,000 |
| 15 | 3 | 31,500 |
| 18 | 3 | 37,800 |

Intermediate concentrations of brine are prepared by adjusting the volume of RO water in the feed brine tank. During testing the concentrate forms of the feed brines are adjusted by adding RO water to dilute the feed brine for the next testing at a lower concentration.

Instrumentation and Measurements:

The pH and conductivity measurements of feed brine solutions and RO permeate used in the synthesis are taken during each cycle of tests. These pH and conductivity measurements are carried out using MYRON L Waterproof 6Psi Multiparameter Meter.

The pH, conductivity, oxidation-reduction potential (ORP), Free Available Chlorine (where applicable) and the Ampere pull across the anodic and cathodic chambers are monitored during the synthesis and production of the activated solutions. The pH, conductivity and ORP readings are also taken on the waste stream. The pH, conductivity, ORP measurements are carried out using MYRON L Waterproof 6Psi Multiparameter Meter. The FAC measurement is carried out using the Iodometric Titration Method in accordance with the ASTM Method D2022. The ampere pull across the anodic and cathodic chamber is measured using a Lucas Totalizer Ammeter with a range of up to 60 amperes.

### 1. Counter-Current Single Pass Production

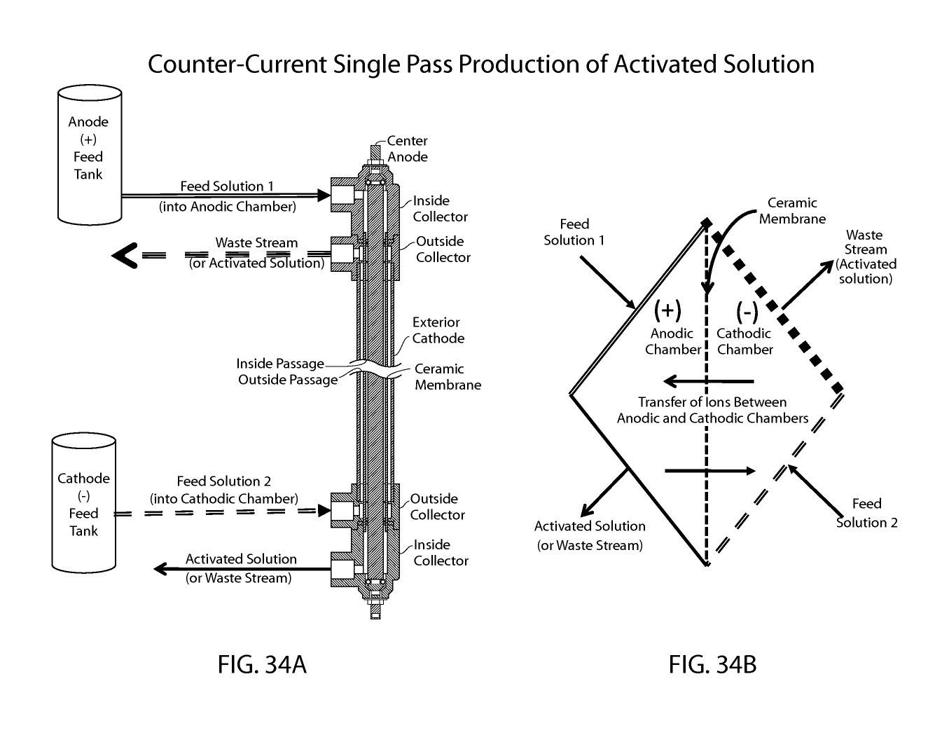

The schematic layout for the counter-current single pass production of activated solution is presented in FIGS. 34A and 34B. The layout shows one of the 8 EMs that is setup in parallel, as depicted in FIG. 3.

In the counter-current single pass production of activated solutions, the flow of the feed solutions through the anodic and cathodic chambers are in opposite directions. In the schematic depicted in FIGS. 34A and 34B, the Feed Solution 1 from the anode feed tank is fed to the anodic chamber via the chamber's top port, while the Feed Solution 2 from the cathode feed tank is fed to the cathodic chamber's bottom port. Both chamber feeds from the feed tank are via constant pressure feed pumps, and the feed flows are regulated using pin valves. Likewise the activation process is also controlled by applying backpressure to the waste and activated solution streams. The backpressures are also applied using pin valves.

The FEM reactor as depicted in FIGS. 34A and 34B is symmetrical across its horizontal axis, and therefore all embodiments that represent switching of feed and product and waste streams in opposite ports of each chamber is also contemplated in alternative embodiments.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed and backpressure valves of the anodic and cathodic chambers are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solutions used in the synthesis are varied in terms of conductivity readings, to obtain the range of feed brine solutions that can be activated.

The counter-current single pass production setup as depicted in FIG. 10 may be utilized for the production of the following activated solutions: hypochlorus acid, bicarbonate based solution, phosphate based solution, hypochlorus acid plus bicarbonate based solution, hypochlorus acid plus phosphate based solution, and hypochlorus acid plus bicarbonate and phosphate based solutions.

### 2. Co-Current Single Pass Production

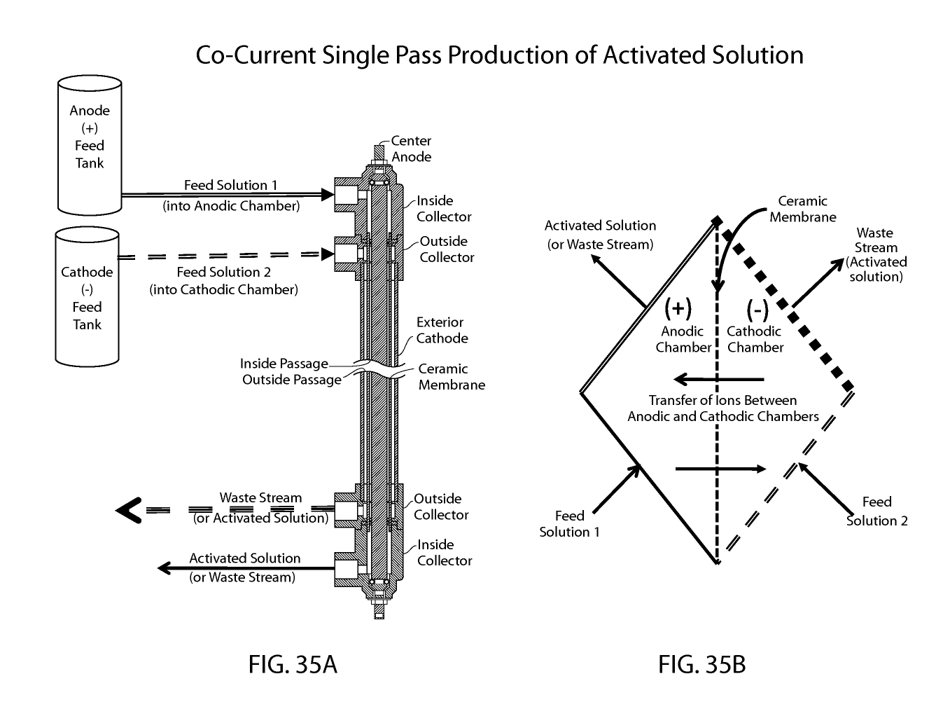

The schematic layout for the co-current single pass production of activated solution is presented in FIGS. 35A and 35B. The layout shows one of the 8 EMs that is setup in parallel, as depicted in FIG. 3.

In the co-current single pass production of activated solutions, the flow of the feed solutions through the anodic and cathodic chambers are in the same directions. In the schematic depicted in FIGS. 35A and 35B, the Feed Solution 1 from the anode feed tank is fed to the anodic chamber via the chamber's top port, while the Feed Solution 2 from the cathode feed tank is also fed to the cathodic chamber's top port. Both chamber feeds from the feed tank are via constant pressure feed pumps, and the feed flows are regulated using pin valves. Likewise the activation process is also controlled by applying backpressure to the waste and activated solution streams. The backpressures are also applied using pin valves.

The FEM reactor as depicted in FIGS. 35A and 35B is symmetrical across its horizontal axis, and therefore all embodiments that represent switching of feed and product and waste streams in opposite ports of each chamber is also covered under this proprietary work.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed and backpressure valves of the anodic and cathodic chambers are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solutions used in the synthesis are varied in terms of conductivity readings, to obtain the range of feed brine solutions that can be activated.

The co-current single pass production setup as depicted in FIG. 11 is applicable for the production of the following activated solutions: hypochlorus acid, bicarbonate based solution, phosphate based solution, hypochlorus acid plus bicarbonate based solution, hypochlorus acid plus phosphate based solution, and hypochlorus acid plus bicarbonate and phosphate based solutions.

### 3. Counter-Current Brine Feed and Recycle Stream Feed Method of Production

3a. Feed Brine in Cathodic Chamber

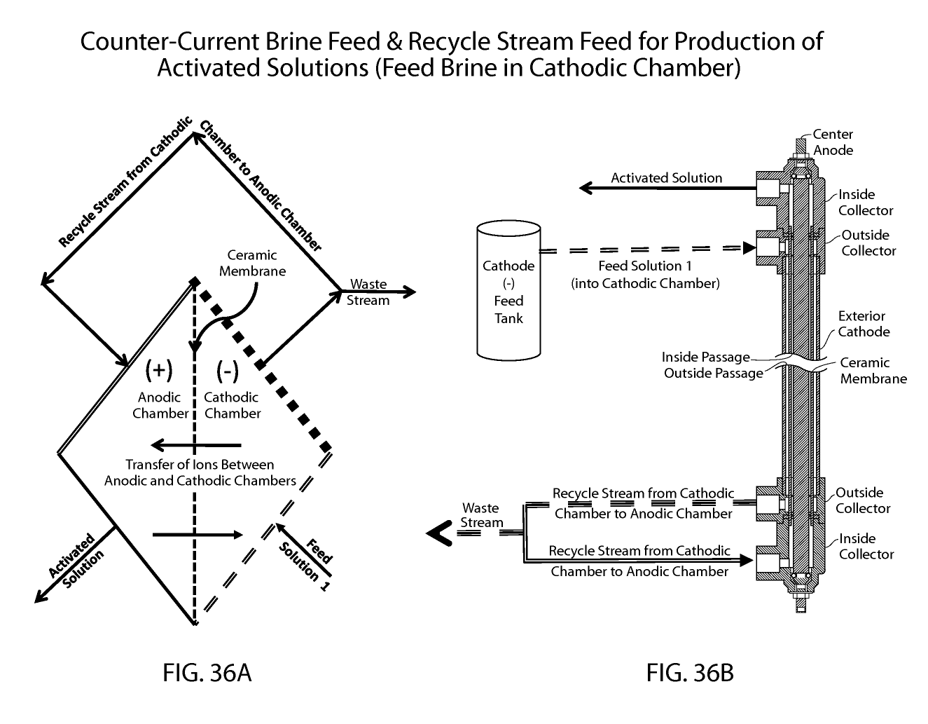

One schematic layout for the counter-current brine feed and recycle stream feed method of producing activated solution is presented in FIGS. 36A and 36B. The layout shows one of the 8 EMs that is setup in parallel, as depicted in FIG. 3, and the feed brine solution is fed to the cathodic chamber.

In the counter-current brine and recycle feed system to produce activated solutions, the flow of the feed solution through the cathodic chamber and the recirculation of the waste stream through the anodic chamber are in the opposite directions. In the schematic depicted in FIGS. 36A and 36B, the Feed Solution 1 from the cathode feed tank is fed to the cathodic chamber via the chamber's top port, and the waste stream from the cathodic chamber's bottom port is transferred to the anodic chamber's bottom port as feed to the anodic chamber. The cathode feed pump is the only pump operational and the pump pushes the flow through the cathodic and anodic chambers. Pin valve on the cathodic feed line is one regulator to control the activation process. Likewise applying backpressure to the waste line i.e. the outlet line from the anodic chamber, using a pin valve, also controls the activation process.

In the counter-current brine and recycle feed system as depicted in FIG. 12, the waste stream is a part of the flow that is recycled to the anodic chamber from the cathodic chamber. The brine feed rate and pressure adjustments in the feed, waste and activated solution streams are aimed at regulating the pH of the activated solution. The flow differential that happens as a result of the pressure and flow rate adjustments will determine the loss of hydroxyl ions in the waste stream and the hydronium ions in the form of hydrogen gas in the product stream, thereby adjusting the pH of the activated solution.

The FEM reactor as depicted in FIGS. 36A and 36B is symmetrical across its horizontal axis, and therefore all embodiments that represent switching of feed, recycle stream and waste streams in opposite ports of each chamber is also covered under this proprietary work.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed valve to the cathodic chamber and the backpressure valve at the outlet of the anodic chamber are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solution used in the synthesis is varied in terms of conductivity readings, to obtain the range of feed brine solutions that can be activated.

The counter-current brine and recycle feed system as depicted in FIGS. 36A and 36B is applicable for the production of activated hypochlorus acid.

3b. Feed Brine in Anodic Chamber

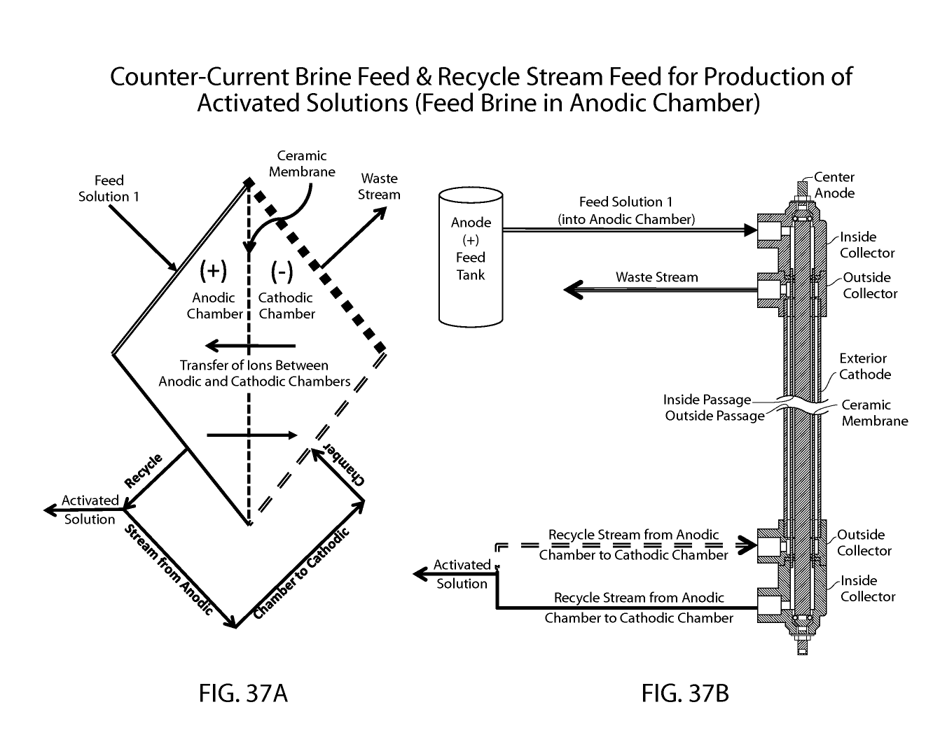

The alternative schematic layout for the counter-current brine feed and recycle stream feed method of producing activated solution is presented in FIGS. 37A and 37B. The layout shows one of the 8 EMs that is setup in parallel, as depicted in FIG. 3, and the feed brine solution is fed to the anodic chamber.

In this configuration of counter-current brine and recycle feed system to produce activated solutions, the flow of the feed solution through the anodic chamber and the recirculation of the waste stream through the cathodic chamber are in the opposite directions. In the schematic depicted in FIGS. 37A and 37B, the Feed Solution 1 from the anode feed tank is fed to the anodic chamber via the chamber's top port, and the waste stream from the anodic chamber's bottom port is transferred to the cathodic chamber's bottom port as feed to the cathodic chamber. The anode feed pump is the only pump operational and the pump pushes the flow through the anodic and cathodic chambers. Pin valve on the anodic feed line is one regulator to control the activation process. Likewise applying backpressure to the product line i.e. the outlet line from the recirculation stream from the anodic to the cathodic chamber, using a pin valve, also controls the activation process.

In the counter-current brine and recycle feed system as depicted in FIGS. 37A and 37B, the product stream is a part of the flow that is recycled to the cathodic chamber from the anodic chamber. The brine feed rate and pressure adjustments in the feed, waste and activated solution streams are aimed at regulating the pH of the activated solution. The flow differential that happens as a result of the pressure and flow rate adjustments will determine the loss of hydroxyl ions in the product stream and the hydronium ions in the form of hydrogen gas in the waste stream, thereby adjusting the pH of the activated solution.

The FEM reactor as depicted in FIGS. 37A and 37B is symmetrical across its horizontal axis, and therefore all embodiments that represent switching of feed, recycle stream and waste streams in opposite ports of each chamber is also covered under this proprietary work.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed valve to the anodic chamber and the backpressure valve at the outlet of the cathodic chamber are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solution used in the synthesis is varied in terms of conductivity readings, to obtain the range of feed brine solutions that can be activated.

The counter-current brine and recycle feed system as depicted in FIGS. 37A and 37B is applicable for the production of activated bicarbonate and phosphate based solutions.

### 4. Co-Current Brine Feed and Recycle Stream Feed Method of Production

4a. Feed Brine in Cathodic Chamber

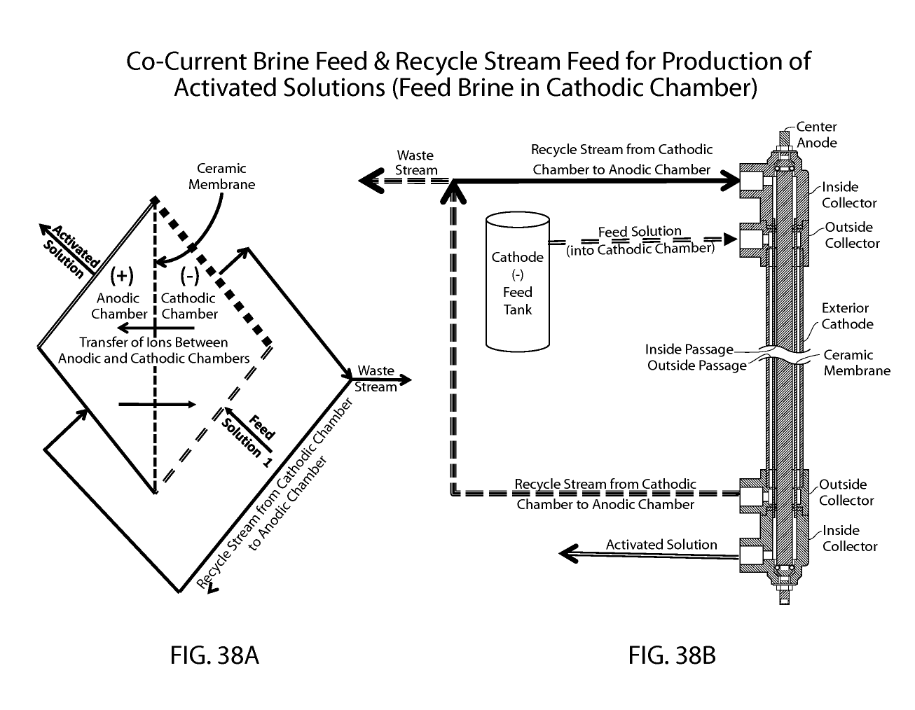

One schematic layout for the co-current brine feed and recycle stream feed method of producing activated solution is presented in FIGS. 38A and 38B. The layout shows one of the 8 EMs that is setup in parallel, as depicted in FIG. 9, and the feed brine solution is fed to the cathodic chamber.

In the counter-current brine and recycle feed system to produce activated solutions, the flow of the feed solution through the cathodic chamber and the recirculation of the waste stream through the anodic chamber are in the same directions. In the schematic depicted in FIGS. 38A and 38B, the Feed Solution 1 from the cathode feed tank is fed to the cathodic chamber via the chamber's top port, and the waste stream from the cathodic chamber's bottom port is transferred to the anodic chamber's top port as feed to the anodic chamber. The cathode feed pump is the only pump operational and the pump pushes the flow through the cathodic and anodic chambers. Pin valve on the cathodic feed line is one regulator to control the activation process. Likewise applying backpressure to the waste line i.e. the outlet line from the anodic chamber, using a pin valve, also controls the activation process.

In the co-current brine and recycle feed system as depicted in FIGS. 38A and 38B, the waste stream is a part of the flow that is recycled to the anodic chamber from the cathodic chamber. The brine feed rate and pressure adjustments in the feed, waste and activated solution streams are aimed at regulating the pH of the activated solution. The flow differential that happens as a result of the pressure and flow rate adjustments will determine the loss of hydronium ions in the form of hydrogen gas in the waste stream and the hydroxyl ions in the product stream, thereby adjusting the pH of the activated solution.

The FEM reactor as depicted in FIGS. 38A and 38B is symmetrical across its horizontal axis, and therefore all embodiments that represent switching of feed, recycle stream and waste streams in opposite ports of each chamber is also covered under this proprietary work.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed valve to the cathodic chamber and the backpressure valve at the outlet of the anodic chamber are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solution used in the synthesis is varied in terms of conductivity readings, to obtain the range of feed brine solutions that can be activated.

The co-current brine and recycle feed system as depicted in FIGS. 38A and 38B may be used for the production of activated hypochlorus acid.

4b. Feed Brine in Anodic Chamber

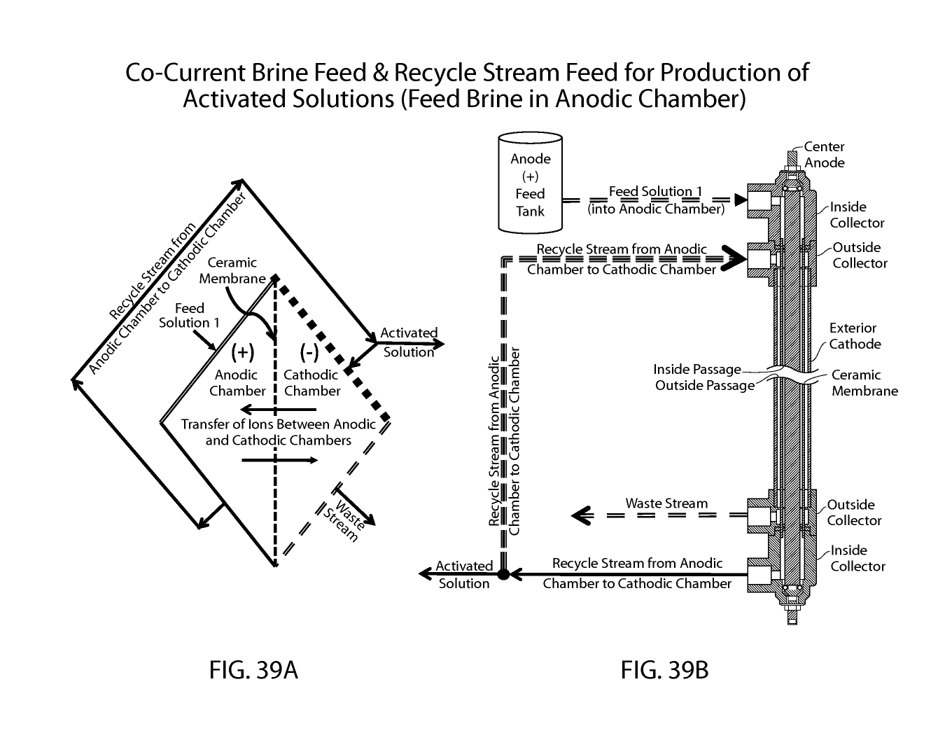

The alternative schematic layout for the co-current brine feed and recycle stream feed method of producing activated solution is presented in FIGS. 39A and 39B. The layout shows one of the 8 EMs that is setup in parallel, as depicted in FIG. 3, and the feed brine solution is fed to the anodic chamber.

In this configuration of co-current brine and recycle feed system to produce activated solutions, the flow of the feed solution through the anodic chamber and the recirculation of the waste stream through the cathodic chamber are in the same directions. In the schematic depicted in FIGS. 39A and 39B, the Feed Solution 1 from the anode feed tank is fed to the anodic chamber via the chamber's top port, and the waste stream from the anodic chamber's bottom port is transferred to the cathodic chamber's top port as feed to the cathodic chamber. The anode feed pump is the only pump operational and the pump pushes the flow through the anodic and cathodic chambers. Pin valve on the anodic feed line is one regulator to control the activation process. Likewise applying backpressure to the product line i.e. the outlet line from the recirculation stream from the anodic to the cathodic chamber, using a pin valve, also controls the activation process.

In the co-current brine and recycle feed system as depicted in FIGS. 39A and 39B, the product stream is a part of the flow that is recycled to the cathodic chamber from the anodic chamber. The brine feed rate and pressure adjustments in the feed, waste and activated solution streams are aimed at regulating the pH of the activated solution. The flow differential that happens as a result of the pressure and flow rate adjustments will determine the loss of hydroxyl ions in the product stream and the hydronium ions in the form of hydrogen gas in the waste stream, thereby adjusting the pH of the activated solution.

The FEM reactor as depicted in FIGS. 39A and 39B5 is symmetrical across its horizontal axis, and therefore all embodiments that represent switching of feed, recycle stream and waste streams in opposite ports of each chamber is also covered under this proprietary work.

The synthesis of the feed brine solution is monitored for the following:
a) Amperes pull across the anodic and cathodic chamber by registering the Ampere measurements across each set of 4 EMs on the Lucas Totalizer Ammeter;
b) Measurement of pH, conductivity and ORP of the activated solution stream using the MYRON L Waterproof 6Psi Multiparameter Meter;
c) Measurement of pH, conductivity and ORP of the waste stream using the MYRON L Waterproof 6Psi Multiparameter Meter;
d) Quantifying of Free Available Chlorine (FAC) in synthesis that involve activation of hypochlorus acid (HOCl) using the Iodometric Titration Method; and
e) Measurement of flow rates in the activated solution and waste streams.

The feed valve to the anodic chamber and the backpressure valve at the outlet of the cathodic chamber are adjusted during each test run while monitoring the pH and Ampere pull across the Lucas Totalizer Ammeter. When the pH of the activated solution is within the desired range for the intended application (and this depends on the nature of the activated solution), the pH, conductivity and ORP measurements for both the activated solution and waste streams are recorded. Where applicable the FAC is quantified by Iodometric titration and recorded.

Feed brine solution used in the synthesis is varied in terms of conductivity readings, to obtain the range of feed brine solutions that can be activated.

The co-current brine and recycle feed system as depicted in FIG. 15 may be used for the production of activated bicarbonate and phosphate based solutions.

The goals of the different activation processes, is to produce activated solutions that are pH neutral and also within the pH range chemicals used in water treatment applications.

The experimental goals of hypochlorus acid activation are a pH of between 6.5 and 7.5, whereas the goals for products consisting bicarbonate and phosphate based activated products is a pH not exceeding 8.5. When the pH of the activated solutions is adjusted to within the target range, feed and backpressure valves will be adjusted to get as high an ORP for the particular feed brine synthesis.

### Results for Activation of Hypochlorus Acid Solution

### 1. Counter-Current Single Pass Production (FIG. 4)

A total of three runs were carried out and the results are presented in Tables 1-3.

TABLE 1

| | Anode | Cathode | |
|---|---|---|---|
| | Feed | Feed | |
| | RO Water | NaCl | Units |
| Conductivity | 72 | 7435 | uS |
| pH | 7.03 | 8.14 | pH units |
| | Product | Waste | Units |
| Flow | 1 L/94 sec | 1 L/6 sec | — |
| pH | 6.6 | 12.87 | pH units |
| Cond | 3143 | 7655 | uS |
| ORP | 320 | −22 | mV |
| Amps Pull | 5 | 5 | Amps |
| FAC | 197.5 | NA | ppm |

TABLE 2

| | Anode | Cathode | |
|---|---|---|---|
| | Feed | Feed | |
| | RO Water | NaCl | Units |
| Conductivity | 72 | 13,150 | uS |
| pH | 7.03 | 8.42 | pH units |
| | Product | Waste | Units |
| Flow | 1 L/97 sec | 1 L/5.4 sec | — |
| pH | 6.65 | 12.56 | pH units |
| Cond | 4230 | 13350 | uS |
| ORP | 335 | −35 | mV |
| Amps Pull | 5 | 5 | Amps |
| FAC | 212.5 | NA | ppm |

TABLE 3

| | Anode | Cathode | |
|---|---|---|---|
| | Feed | Feed | |
| | RO Water | NaCl | Units |
| Conductivity | 72 | 17,430 | uS |
| pH | 7.03 | 8.67 | pH units |
| | Product | Waste | Units |
| Flow | 1 L/102 sec | 1 L/6.3 sec | — |
| pH | 6.5 | 12.68 | pH units |
| Cond | 4650 | 17850 | uS |
| ORP | 342 | 13 | mV |
| Amps Pull | 5 | 5 | Amps |
| FAC | 217.5 | NA | ppm |

For the counter-current single pass activation of hypochlorus acid solution, the conductivity of the cathodic chamber feed solution was varied between conductivity of between 7,400 and 17,800 μS. The wastage flow rate from the cathodic chamber was noted to be higher than the product feed (between 16 and 18 times by volume) and the wastage rate increased as the NaCl feed brine conductivity increased. The waste flow adjustment is necessary to control the activated solution pH to be within the target range of between 6.5 and 7.5. The FAC content of the product only increased marginally from 197.5 ppm to 217.5 ppm though the feed brine conductivity was increased about 2.5 times, and this corresponded to the low ORP measurements observed. The synthesis only had 5 Amps pull across each set of 4 EMs.

### 2. Co-Current Single Pass Production (FIG. 5)

A total of three runs were carried out and the results are presented in Tables 4-6.

TABLE 4

| | Anode | Cathode | |
|---|---|---|---|
| | Feed | Feed | |
| | RO Water | NaCl | Units |
| Conductivity | 63.5 | 8035 | uS |
| pH | 6.98 | 8.37 | pH units |
| | Product | Waste | Units |
| Flow | 1 L/62 sec | 1 L/8 sec | — |
| pH | 6.6 | 12.15 | pH units |
| Cond | 3450 | 8550 | uS |
| ORP | 318 | 22 | mV |
| Amps Pull | 15 | 15 | Amps |
| FAC | 200 | NA | ppm |

TABLE 5

| | Anode | Cathode | |
|---|---|---|---|
| | Feed | Feed | |
| | RO Water | NaCl | Units |
| Conductivity | 63.5 | 10230 | uS |
| pH | 6.98 | 8.39 | pH units |
| | Product | Waste | Units |
| Flow | 1 L/67 sec | 1 L/5 sec | — |
| pH | 6.7 | 12.24 | pH units |
| Cond | 3700 | 10480 | uS |
| ORP | 327 | −18 | mV |
| Amps Pull | 15 | 15 | Amps |
| FAC | 222.5 | NA | ppm |

TABLE 6

| | Anode | Cathode | |
|---|---|---|---|
| | Feed | Feed | |
| | RO Water | NaCl | Units |
| Conductivity | 63.5 | 16,140 | uS |
| pH | 6.98 | 8.71 | pH units |
| | Product | Waste | Units |
| Flow | 1 L/84 sec | 1 L/5 sec | — |
| pH | 6.5 | 12.18 | pH units |
| Cond | 3945 | 16,375 | uS |
| ORP | 345 | −87 | mV |
| Amps Pull | 20 | 20 | Amps |
| FAC | 247 | NA | ppm |

For the co-current single pass activation of hypochlorus acid solution, the conductivity of the cathodic chamber feed solution was varied between conductivity of between 8,000 and 16,100 μS. The wastage flow rate from the cathodic chamber was noted to be higher than the product feed (between 8 and 16 times by volume) and the wastage rate increased as the NaCl feed brine conductivity increased. The waste flow adjustment is necessary to control the activated solution pH to be within the target range of between 6.5 and 7.5. The FAC content of the product only increased marginally from 200 ppm to 247 ppm though the feed brine conductivity was increased about 2 times, and this corresponded to the low ORP measurements observed. The synthesis had 15 Amps pull across each set of 4 EMs, at the lower concentration, while the amps pull increased to 20 Amps at the highest feed brine concentration tested.

### 3. Counter-Current Brine Feed and Recycle Stream Feed (FIG. 6)

A total of three runs were carried out and the results are presented in Tables 7-9.

TABLE 7

| | Anode | | |
|---|---|---|---|
| | Feed | Cathode | |
| | NaCl | Feed | |
| | recycle | NaCl | Units |
| Conductivity | NA | 6400 | uS |
| pH | NA | 8.32 | pH units |
| | Product | Waste | Units |
| Flow | 1 L/32 sec | 1 L/79 sec | — |
| pH | 6.9 | 12.13 | pH units |
| Cond | 6150 | 6850 | uS |
| ORP | 715 | −110 | mV |
| Amps Pull | 30 | 30 | Amps |
| FAC | 325 | NA | ppm |

TABLE 8

| | Anode | | |
|---|---|---|---|
| | Feed | Cathode | |
| | NaCl | Feed | |
| | recycle | NaCl | Units |
| Conductivity | NA | 12150 | uS |
| pH | NA | 8.42 | pH units |
| | Product | Waste | Units |
| Flow | 1 L/38.3 sec | 1 L/75 sec | — |
| pH | 7.52 | 12.1 | pH units |
| Cond | 11470 | 13860 | uS |
| ORP | 757 | −115 | mV |
| Amps Pull | 35 | 35 | Amps |
| FAC | 426 | NA | ppm |

TABLE 9

| | Anode | | |
|---|---|---|---|
| | Feed | Cathode | |
| | NaCl | Feed | |
| | recycle | NaCl | Units |
| Conductivity | NA | 18450 | uS |
| pH | NA | 8.76 | pH units |
| | Product | Waste | Units |
| Flow | 1 L/43.8 sec | 1 L/72 sec | — |
| pH | 7.53 | 11.7 | pH units |
| Cond | 16850 | 20450 | uS |
| ORP | 832 | −76 | mV |
| Amps Pull | 30 | 30 | Amps |
| FAC | 437 | NA | ppm |

For the counter-current brine feed and recycle stream feed way of activation of hypochlorus acid solution, the conductivity of the cathodic chamber feed solution was varied between conductivity of between 6,400 and 18,500 μS. The wastage flow rate from the cathodic chamber was noted to be lower than the product feed (between 1.6 and 2.5 times by volume) and the wastage rate decreased as the NaCl feed brine conductivity increased. The waste flow adjustment is necessary to control the activated solution pH to be within the target range of between 6.5 and 7.5. The FAC content of the product increased from 325 ppm to 437 ppm as the feed brine conductivity was increased about 3 times, while the ORP measurements was observed to increase from 715 mV to 832 mV. The synthesis had between 30 and 35 Amps pull across each set of 4 EMs, with the Amps pull at the mid concentration range of about 12,100 μS had an Amps pull of 35 Amps.

### 4. Co-Current Brine Feed and Recycle Stream Feed (FIG. 7)

A total of five runs were carried out and the results are presented in Tables 10-14.

TABLE 10

| | Anode | | |
|---|---|---|---|
| | Feed | Cathode | |
| | NaCl | Feed | |
| | recycle | NaCl | Units |
| Conductivity | NA | 7900 | uS |
| pH | NA | 8.51 | pH units |
| | Product | Waste | Units |
| Flow | 1 L/27 sec | 1 L/89 sec | — |
| pH | 7.2 | 11.9 | pH units |
| Cond | 14150 | 12410 | uS |
| ORP | 810 | −120 | mV |
| Amps Pull | 40 | 40 | Amps |
| FAC | 467 | NA | ppm |

TABLE 11

| | Anode | Cathode | |
|---|---|---|---|
| | NaCl | Feed | Feed |
| | recycle | NaCl | Units |
| Conductivity | NA | 7900 | uS |
| pH | NA | 8.51 | pH units |
| | Product | Waste | Units |
| Flow | 1 L/26.3 sec | 1 L/77 sec | — |
| pH | 7.39 | 12.1 | pH units |
| Cond | 7850 | 8055 | uS |
| ORP | 800 | −89 | mV |
| Amps Pull | 35 | 35 | Amps |
| FAC | 275 | NA | ppm |

TABLE 12

| | Anode | Cathode | |
|---|---|---|---|
| | NaCl | Feed | Feed |
| | recycle | NaCl | Units |
| Conductivity | NA | 13290 | uS |
| pH | NA | 8.85 | pH units |
| | Product | Waste | Units |
| Flow | 1 L/24 sec | 1 L/101 sec | — |
| pH | 7.21 | 11.7 | pH units |
| Cond | 13150 | 15260 | uS |
| ORP | 831 | −140 | mV |
| Amps Pull | 40 | 40 | Amps |
| FAC | 557 | NA | ppm |

TABLE 13

| | Anode | Cathode | |
|---|---|---|---|
| | NaCl | Feed | Feed |
| | recycle | NaCl | Units |
| Conductivity | NA | 35,200 | uS |
| pH | NA | 8.96 | pH units |
| | Product | Waste | Units |
| Flow | 1 L/28 sec | 1 L/95 sec | — |
| pH | 7.46 | 12.15 | pH units |
| Cond | 30,200 | 52,100 | uS |
| ORP | 896 | −92 | mV |
| Amps Pull | 40 | 40 | Amps |
| FAC | 1695 | NA | ppm |

TABLE 14

| | Anode | Cathode | |
|---|---|---|---|
| | NaCl | Feed | Feed |
| | recycle | NaCl | Units |
| Conductivity | NA | 3600 | uS |
| pH | NA | 8.39 | pH units |
| | Product | Waste | Units |
| Flow | 1 L/24.8 sec | 1 L/65 sec | — |
| pH | 7.02 | 11.95 | pH units |
| Cond | 3350 | 4315 | uS |
| ORP | 790 | −27 | mV |
| Amps Pull | 35 | 35 | Amps |
| FAC | 198 | NA | ppm |

For the co-current brine feed and recycle stream feed way of activation of hypochlorus acid solution, the conductivity of the cathodic chamber feed solution was varied between conductivity of between 3,600 and 35,200 μS. The wastage flow rate from the cathodic chamber was noted to be lower than the product feed (between 2.6 and 4.2 times by volume) and the wastage rate decreased as the NaCl feed brine conductivity increased. The waste flow adjustment is necessary to control the activated solution pH to be within the target range of between 6.5 and 7.5. The FAC content of the product increased from 198 ppm to 1695 ppm as the feed brine conductivity was increased about 10 times, while the ORP measurements was observed to increase from 790 mV to 896 mV. The synthesis had between 35 and 40 Amps pull across each set of 4 EMs, with the Amps pull at the two different concentrations of 13,290 μS and 35,200 μS had Amps pull of 40 Amps.

The electrochemical synthesis of sodium chloride brine to produce activated hypochlorus acid showed the following product characteristics: FAC: 200 ppm-1700 ppm; ORP: 320 mV-900 mV; pH: 6.5-7.5; Ampere differential between anode and cathode chambers: 5-40 Amperes.

The synthesis using the single pass method of activation of hypochlorus acid produces lower strength activation hypochlorus solutions in terms of ORP, pH, FAC and the amperes pull across the anodic and cathodic chambers. The principal reason for the reduced inactivation by the single pass method is the build up of hydrogen gas during synthesis, which puts additional backpressure resulting in less chlorine gas transfer to the anodic chamber. The hydrogen gas build up happens when flows are adjusted to control the pH. The hydrogen gas build up is noted by way of fluctuating amperes readings and varying amperes readings between the two groups 4 EMs.

In summary the synthesis and activation of hypochlorus acid solutions can happen in all 4 modes of operations, however the co-current synthesis with recycling gives the best results in terms of activation, as well as product flow rate relative to waste flow rate. The synthesis by the other modes can be improved by varying the sizes of piping (instead of the homogeneous piping sizes) that will allow between venting of hydrogen gas for improved pH adjustment and activation.

### Results for Activation of Bicarbonate Based Solution

### 1. Counter-Current Single Pass Production (FIG. 8)

A total of four runs were carried out and the results are presented in Tables 15-18.

TABLE 15

| | Anode | Cathode | |
|---|---|---|---|
| | Feed | Feed | |
| | NaHCO3 | RO Permeate | Units |
| Conductivity | 8273 | 99.2 | uS |
| pH | 8.51 | 6.98 | pH units |
| | Product | Waste | Units |
| Flow | 1 L/30 sec | 1 L/15 sec | — |
| pH | 7.53 | 10.16 | pH units |
| Cond | 7880 | 1092 | uS |
| ORP | 893 | −800 | mV |
| Amps Pull | 15 | 15 | Amps |
| FAC | NA | NA | ppm |

TABLE 16

| | Anode | Cathode | |
|---|---|---|---|
| | Feed | Feed | |
| | NaHCO3 | RO Permeate | Units |
| Conductivity | 25670 | 99.2 | uS |
| pH | 10.43 | 6.98 | pH units |
| | Product | Waste | Units |
| Flow | 1 L/56 sec | 1 L/6 sec | — |
| pH | 7.97 | 10.01 | pH units |
| Cond | 23500 | 570 | uS |
| ORP | 681 | −200 | mV |
| Amps Pull | 15 | 15 | Amps |
| FAC | NA | NA | ppm |

TABLE 17

| | Anode | Cathode | |
|---|---|---|---|
| | Feed | Feed | |
| | NaHCO3 | RO Permeate | Units |
| Conductivity | 35,000 | 102.6 | uS |
| pH | 10.23 | 7.12 | pH units |
| | Product | Waste | Units |
| Flow | 1 L/34 sec | 1 L/38 sec | — |
| pH | 7.57 | 10.09 | pH units |
| Cond | 34700 | 4,200 | uS |
| ORP | 750 | −200 | mV |
| Amps Pull | 15 | 15 | Amps |
| FAC | NA | NA | ppm |

TABLE 18

| | Anode | Cathode | |
|---|---|---|---|
| | Feed | Feed | |
| | NaHCO3 | RO Permeate | Units |
| Conductivity | 48,000 | 102.6 | uS |
| pH | 10.26 | 7.12 | pH units |
| | Product | Waste | Units |
| Flow | 1 L/120 sec | 1 L/60 sec | — |
| pH | 7.87 | 10.14 | pH units |
| Cond | 44,600 | 5,300 | uS |
| ORP | 630 | −78 | mV |
| Amps Pull | 15 | 15 | Amps |
| FAC | NA | NA | ppm |

For the counter-current single pass activation of bicarbonate-based solution, the conductivity of the anodic chamber feed solution was varied between conductivity range of 8,300 and 48,000 μS. The wastage flow rate from the cathodic chamber was higher than the product flow rate (between 2 and 9 times by volume) and activation was also possible when the product flow rate was slightly higher at 1.1 times the waste flow rate at a feed conductivity of 35,000 μS. The waste flow adjustment is necessary to control the activated solution pH to be within the target range of between 6.5 and 8.5. The ORP of the activated solution ranged from 630 mV to 896 mV, with the higher ORP observed at lower feed brine concentrations in terms of conductivity. The synthesis pulled 15 Amps across each set of 4 EMs, and the Amps pull did not increase with feed conductivity.

### 2. Co-Current Single Pass Production (FIG. 9)

A total of three runs were carried out and the results are presented in Tables 19-21.

TABLE 19

| | Anode | Cathode | |
|---|---|---|---|
| | Feed | Feed | |
| | NaHCO3 | RO Permeate | Units |
| Conductivity | 8673 | 99.2 | uS |
| pH | 8.97 | 6.98 | pH units |
| | Product | Waste | Units |
| Flow | 1 L/39 sec | 1 L/14.2 sec | — |
| pH | 7.3 | 10.07 | pH units |
| Cond | 7280 | 845 | uS |
| ORP | 580 | −285 | mV |
| Amps Pull | 5 | 5 | Amps |
| FAC | NA | NA | ppm |

TABLE 20

| | Anode | Cathode | |
|---|---|---|---|
| | Feed | Feed | |
| | NaHCO3 | RO Permeate | Units |
| Conductivity | 13,760 | 99.2 | uS |
| pH | 9.37 | 6.98 | pH units |
| | Product | Waste | Units |
| Flow | 1 L/45 sec | 1 L/16 sec | — |
| pH | 7.37 | 10.12 | pH units |
| Cond | 13180 | 977 | uS |
| ORP | 595 | −677 | mV |
| Amps Pull | 5 | 5 | Amps |
| FAC | NA | NA | ppm |

TABLE 21

| | Anode | Cathode | |
|---|---|---|---|
| | Feed | Feed | |
| | NaHCO3 | RO Permeate | Units |
| Conductivity | 25670 | 99.2 | uS |
| pH | 10.43 | 6.98 | pH units |
| | Product | Waste | Units |
| Flow | 1 L/60 sec | 1 L/17.3 sec | — |
| pH | 7.93 | 10.16 | pH units |
| Cond | 23600 | 1,458 | uS |
| ORP | 685 | −691 | mV |
| Amps Pull | 12 | 12 | Amps |
| FAC | NA | NA | ppm |

For the co-current single pass activation of bicarbonate-based solution, the conductivity of the anodic chamber feed solution was varied between conductivity range of 8,700 and 23,600 μS. The wastage flow rate from the cathodic chamber was higher than the product flow rate (between 2.7 and 3.5 times by volume). The waste flow adjustment is necessary to control the activated solution pH to be within the target range of between 6.5 and 8.5. The ORP of the activated solution ranged from 580 mV to 685 mV, with the higher ORP observed at the higher feed brine concentration in terms of conductivity. The synthesis pulled about 5 Amps generally but at the higher feed conductivity of 23,600 μS, the amps pull was higher at 12 Amps across each set of 4 EMs.

### 3. Counter-Current Brine Feed and Recycle Stream Feed (FIG. 10)

A total of three runs were carried out and the results are presented in Tables 22-24.

TABLE 22

| | Anode Feed | Cathode Feed | |
|---|---|---|---|
| | NaHCO3 | HCO3 Recycle | Units |
| Conductivity | 8377 | NA | uS |
| pH | 8.94 | NA | pH units |
| | Product | Waste | Units |
| Flow | 1 L/118 sec | 1 L/5.4 sec | — |
| pH | 7.12 | 9.77 | pH units |
| Cond | 8133 | 1,998 | uS |
| ORP | 525 | −25 | mV |
| Amps Pull | 1 | 1 | Amps |
| FAC | NA | NA | ppm |

TABLE 23

| | Anode Feed | Cathode Feed | |
|---|---|---|---|
| | NaHCO3 | HCO3 Recycle | Units |
| Conductivity | 9,744 | NA | uS |
| pH | 9.16 | NA | pH units |
| | Product | Waste | Units |
| Flow | 1 L/105 sec | 1 L/6.3 sec | — |
| pH | 7.05 | 9.83 | pH units |
| Cond | 9106 | 1,655 | uS |
| ORP | 510 | −78 | mV |
| Amps Pull | 1 | 1 | Amps |
| FAC | NA | NA | ppm |

TABLE 24

| | Anode Feed | Cathode Feed | |
|---|---|---|---|
| | NaHCO3 | HCO3 Recycle | Units |
| Conductivity | 12,660 | NA | uS |
| pH | 9.85 | NA | pH units |
| | Product | Waste | Units |
| Flow | 1 L/123 | 1 L/4.5 sec | — |
| pH | 6.8 | 9.45 | pH units |
| Cond | 12057 | 1,257 | uS |
| ORP | 500 | −23 | mV |
| Amps Pull | 1 | 1 | Amps |
| FAC | NA | NA | ppm |

For the counter-current brine feed and recycle stream feed way of activation of bicarbonate based solution, the conductivity of the anodic chamber feed solution was varied between conductivity of between 8,400 and 12,700 μS. The wastage flow rate from the cathodic chamber was noted to be higher than the product flow (between 17 and 27 times by volume). The waste flow adjustment is necessary to control the activated solution pH to be within the target range of between 6.5 and 8.5. The ORP measurements were observed to range between 500 mV and 525 mV, and the varying of the feed brine conductivity did not impact the ORP. The synthesis had a nominal Amps pull of about 1 Amp across each set of 4 EMs.

### 4. Co-Current Brine Feed and Recycle Stream Feed (FIG. 11)

A total of three runs were carried out and the results are presented in Tables 25-27.

TABLE 25

| | Anode Feed | Cathode Feed | |
|---|---|---|---|
| | NaHCO3 | HCO3 Recycle | Units |
| Conductivity | 8377 | NA | uS |
| pH | 8.94 | NA | pH units |
| | Product | Waste | Units |
| Flow | 1 L/128 sec | 1 L/6 sec | — |
| pH | 6.9 | 10.11 | pH units |
| Cond | 7648 | 1,934 | uS |
| ORP | 505 | −15 | mV |
| Amps Pull | 1 | 1 | Amps |
| FAC | NA | NA | ppm |

TABLE 26

| | Anode Feed | Cathode Feed | |
|---|---|---|---|
| | NaHCO3 | HCO3 Recycle | Units |
| Conductivity | 9,744 | NA | uS |
| pH | 9.16 | NA | pH units |

| | Product | Waste | Units |
|---|---|---|---|
| Flow | 1 L/116 sec | 1 L/4.8 sec | — |
| pH | 6.9 | 10.17 | pH units |
| Cond | 8897 | 1,666 | uS |
| ORP | 500 | −27 | mV |
| Amps Pull | 1 | 1 | Amps |
| FAC | NA | NA | ppm |

TABLE 27

| | Anode Feed | Cathode Feed | |
|---|---|---|---|
| | NaHCO3 | HCO3 Recycle | Units |
| Conductivity | 12,660 | NA | uS |
| pH | 9.85 | NA | pH units |

| | Product | Waste | Units |
|---|---|---|---|
| Flow | 1 L/143 | 1 L/3 sec | — |
| pH | 6.7 | 10.24 | pH units |
| Cond | 11660 | 1,288 | uS |
| ORP | 496 | −16 | mV |
| Amps Pull | 1 | 1 | Amps |
| FAC | NA | NA | ppm |

For the co-current brine feed and recycle stream feed way of activation of bicarbonate based solution, the conductivity of the anodic chamber feed solution was varied between conductivity of between 8,400 and 12,700 μS. The wastage flow rate from the cathodic chamber was noted to be higher than the product flow (between 21 and 48 times by volume). The waste flow adjustment is necessary to control the activated solution pH to be within the target range of between 6.5 and 8.5. The ORP measurements were observed to range between 496 mV and 505 mV, and the varying of the feed brine conductivity by about 1.5 times did not impact the ORP. The synthesis had a nominal Amps pull of about 1 Amp across each set of 4 EMs.

The electrochemical synthesis of sodium bicarbonate brine to produce activated bicarbonate showed the following product characteristics: ORP: 500 mV-900 mV; pH: 6.7-8.0; Ampere differential between anode and cathode chambers: 1-15 Amperes.

The synthesis using the single pass method of activation of bicarbonate based solutions produces higher strength activated solutions in terms of ORP and the amperes pull across the anodic and cathodic chambers. The single pass counter-current synthesis produces somewhat slightly higher strength activated bicarbonate solutions, based on observed ORP readings. The synthesis using recycle stream produces weaker activated solutions and the activation itself is at very low Amps pull of about 1 Amp across 4 EMs. The activation is also observed to be stronger in terms of ORP measurements and Amps pull, when the feed brine solution is of lower concentration in terms of conductivity.

In summary the synthesis and activation of bicarbonate based solutions is best achieved with the single pass counter-current and co-current modes of operations. The synthesis using the recycle stream is weaker and is considered only for applications where on-site production and applications of the activated solutions are needed.

### Results for Activation of Phosphate Based Solution

### 1. Counter-Current Single Pass Production (FIG. 12)

A total of four runs were carried out and the results are presented in Tables 28-31.

TABLE 28

| | Anode Feed | Cathode Feed | |
|---|---|---|---|
| | Na2HPO4 | RO Permeate | Units |
| Conductivity | 28,600 | 111.6 | uS |
| pH | 8.85 | 7.03 | pH units |

| | Product | Waste | Units |
|---|---|---|---|
| Flow | 1 L/34.4 sec | 1 L/15.5 sec | — |
| pH | 8.15 | 11.07 | pH units |
| Cond | 27930 | 2,365 | uS |
| ORP | 389 | −311 | mV |
| Amps Pull | 30 | 30 | Amps |
| FAC | NA | NA | ppm |

TABLE 29

| | Anode Feed | Cathode Feed | |
|---|---|---|---|
| | Na2HPO4 | RO Permeate | Units |
| Conductivity | 20,410 | 111.6 | uS |
| pH | 8.94 | 7.03 | pH units |

| | Product | Waste | Units |
|---|---|---|---|
| Flow | 1 L/29.2 sec | 1 L/207 sec | — |
| pH | 7.68 | 12.15 | pH units |
| Cond | 19920 | 20,070 | uS |
| ORP | 512 | −892 | mV |
| Amps Pull | 30 | 30 | Amps |
| FAC | NA | NA | ppm |

TABLE 30

| | Anode Feed | Cathode Feed | |
|---|---|---|---|
| | Na2HPO4 | RO Permeate | Units |
| Conductivity | 20,410 | 111.6 | uS |
| pH | 8.94 | 7.03 | pH units |

| | Product | Waste | Units |
|---|---|---|---|
| Flow | 1 L/59 sec | 1 L/76 sec | — |
| pH | 7.65 | 11.56 | pH units |
| Cond | 16110 | 13,580 | uS |
| ORP | 740 | −880 | mV |
| Amps Pull | 25 | 25 | Amps |
| FAC | NA | NA | ppm |

TABLE 31

| | Anode Feed | Cathode Feed | |
|---|---|---|---|
| | Na2HPO4 | RO Permeate | Units |
| Conductivity | 7,590 | 111.6 | uS |
| pH | 9.08 | 7.03 | pH units |

| | Product | Waste | Units |
|---|---|---|---|
| Flow | 1 L/38 sec | 1 L/102 sec | — |
| pH | 7.3 | 11.37 | pH units |
| Cond | 7415 | 6,362 | uS |
| ORP | 846 | −637 | mV |
| Amps Pull | 30 | 30 | Amps |
| FAC | NA | NA | ppm |

For the counter-current single pass activation of phosphate-based solution, the conductivity of the anodic chamber feed solution (disodium phosphate solution) was varied between conductivity range of 7,600 and 28,600 μS. The wastage flow rate from the cathodic chamber was higher than the product flow rate at the very high feed brine conductivity of 28,600 μS. The waste flow adjustment is necessary to control the activated solution pH to be within the target range of between 6.5 and 8.5. However at feed brine conductivity readings lower than 20000 μS, the waste flow rate was noted to be lower than the product flow rate. The ORP of the activated solution ranged from 389 mV to 846 mV, with the lowest ORP observed at higher feed brine concentrations in terms of conductivity. The synthesis pulled between 25 and 30 Amps across each set of 4 EMs, with the low feed brine also able to pull 30 Amps across the anodic and cathodic chambers.

### 2. Co-Current Single Pass Production (FIG. 13)

A total of three runs were carried out and the results are presented in Tables 32-34.

TABLE 32

| | Anode Feed | Cathode Feed | |
|---|---|---|---|
| | Na2HPO4 | RO Permeate | Units |
| Conductivity | 28,600 | 111.6 | uS |
| pH | 8.85 | 7.03 | pH units |

| | Product | Waste | Units |
|---|---|---|---|
| Flow | 1 L/47 sec | 1 L/51 sec | — |
| pH | 7.5 | 10.85 | pH units |
| Cond | 22403 | 2,948 | uS |
| ORP | 415 | −189 | mV |
| Amps Pull | 15 | 15 | Amps |
| FAC | NA | NA | ppm |

TABLE 33

| | Anode Feed | Cathode Feed | |
|---|---|---|---|
| | Na2HPO4 | HPO4 Recycle | Units |
| Conductivity | 20,410 | 111.6 | uS |
| pH | 8.94 | 7.03 | pH units |

| | Product | Waste | Units |
|---|---|---|---|
| Flow | 1 L/47 sec | 1 L/51 sec | — |
| pH | 7.3 | 10.9 | pH units |
| Cond | 19815 | 2,686 | uS |
| ORP | 470 | −195 | mV |
| Amps Pull | 15 | 15 | Amps |
| FAC | NA | NA | ppm |

TABLE 34

| | Anode Feed | Cathode Feed | |
|---|---|---|---|
| | Na2HPO4 | RO Permeate | Units |
| Conductivity | 7,590 | 111.6 | uS |
| pH | 9.08 | 7.03 | pH units |

| | Product | Waste | Units |
|---|---|---|---|
| Flow | 1 L/43 sec | 1 L/87 sec | — |
| pH | 7.9 | 11.4 | pH units |
| Cond | 6647 | 7,316 | uS |
| ORP | 635 | −237 | mV |
| Amps Pull | 25 | 25 | Amps |
| FAC | NA | NA | ppm |

For the co-current single pass activation of phosphate-based solution, the conductivity of the anodic chamber feed solution (disodium phosphate solution) was varied between conductivity range of 7,600 and 28,600 μS. When the feed brine conductivity was reduced from 28,600 μS in Run 1 to 20,410 μS in Run 2, the pH of the product dropped, and the ORP increased. The higher ORP was observed under the conditions of a lower feed brine concentration as in Run 3, and the Amps pull was also higher. The wastage flow rate from the cathodic chamber was held constant between Runs 1 and 2, but Run 3 waste flow was about 2 times lower than the product rate, while the higher ORP was observed, albeit at a higher pH of 7.9. The waste flow adjustment is necessary to control the activated solution pH to be within the target range of between 6.5 and 8.5. The synthesis pulled Amps between 15 and 25 Amps with the lower feed concentration deriving higher Amps pull.

### 3. Counter-Current Brine Feed and Recycle Stream Feed (FIG. 14)

A total of three runs were carried out and the results are presented in Tables 35-37.

TABLE 35

| | Anode Feed | Cathode Feed | |
|---|---|---|---|
| | Na2HPO4 | HPO4 Recycle | Units |
| Conductivity | 20,410 | NA | uS |
| pH | 8.94 | NA | pH units |

| | Product | Waste | Units |
|---|---|---|---|
| Flow | 1 L/89 sec | 1 L/13.5 sec | — |
| pH | 7.4 | 11.16 | pH units |
| Cond | 18,463 | 3,245 | uS |
| ORP | 427 | −120 | mV |
| Amps Pull | 1 | 1 | Amps |
| FAC | NA | NA | ppm |

TABLE 36

| | Anode Feed | Cathode Feed | |
|---|---|---|---|
| | Na2HPO4 | HPO4 Recycle | Units |
| Conductivity | 7,590 | NA | uS |
| pH | 9.08 | NA | pH units |

| | Product | Waste | Units |
|---|---|---|---|
| Flow | 1 L/86 | 1 L/15 sec | — |
| pH | 7.56 | 10.98 | pH units |
| Cond | 7476 | 1,814 | uS |
| ORP | 457 | −77 | mV |
| Amps Pull | 5 | 5 | Amps |
| FAC | NA | NA | ppm |

TABLE 37

| | Anode Feed | Cathode Feed | |
|---|---|---|---|
| | Na2HPO4 | HPO4 Recycle | Units |
| Conductivity | 5,436 | NA | uS |
| pH | 9.13 | NA | pH units |

| | Product | Waste | Units |
|---|---|---|---|
| Flow | 1 L/75 sec | 1 L/16 sec | — |
| pH | 7.8 | 10.99 | pH units |
| Cond | 5223 | 1,776 | uS |
| ORP | 465 | −26 | mV |
| Amps Pull | 5 | 5 | Amps |
| FAC | NA | NA | ppm |

For the counter-current brine feed and recycle stream feed way of activation of phosphate-based solution, the conductivity of the anodic chamber feed solution was varied between conductivity of between 5,400 and 20,400 μS. The wastage flow rate from the cathodic chamber was noted to be higher than the product flow (between 4.7 and 6.6 times by volume). The waste flow adjustment is necessary to control the activated solution pH to be within the target range of between 6.5 and 8.5. The ORP measurements were observed to range between 427 mV and 465 mV, and the varying of the feed brine conductivity did not impact the ORP significantly. The synthesis had a low Amps pull of about 5 Amp across each set of 4 EMs, when the feed conductivity was low, while at the higher feed conductivity the Amps pull was a nominal 1 Amps.

### 4. Co-Current Brine Feed and Recycle Stream Feed (FIG. 15)

A total of three runs were carried out and the results are presented in Tables 38-40.

TABLE 38

| | Anode Feed | Cathode Feed | |
|---|---|---|---|
| | Na2HPO4 | HPO4 Recycle | Units |
| Conductivity | 20,410 | NA | uS |
| pH | 8.94 | NA | pH units |

| | Product | Waste | Units |
|---|---|---|---|
| Flow | 1 L/94.2 sec | 1 L/7.9 sec | — |
| pH | 7.2 | 11.19 | pH units |
| Cond | 17,934 | 3,367 | uS |
| ORP | 415 | −87 | mV |
| Amps Pull | 1 | 1 | Amps |
| FAC | NA | NA | ppm |

TABLE 39

| | Anode Feed | Cathode Feed | |
|---|---|---|---|
| | Na2HPO4 | HPO4 Recycle | Units |
| Conductivity | 7,590 | NA | uS |
| pH | 9.08 | NA | pH units |

| | Product | Waste | Units |
|---|---|---|---|
| Flow | 1 L/91 sec | 1 L/18.2 sec | — |
| pH | 7.61 | 11.01 | pH units |
| Cond | 6669 | 1,752 | uS |
| ORP | 423 | −125 | mV |
| Amps Pull | 5 | 5 | Amps |
| FAC | NA | NA | ppm |

TABLE 40

| | Anode Feed | Cathode Feed | |
|---|---|---|---|
| | Na2HPO4 | HPO4 Recycle | Units |
| Conductivity | 5,436 | NA | uS |
| pH | 9.13 | NA | pH units |

| | Product | Waste | Units |
|---|---|---|---|
| Flow | 1 L/77 sec | 1 L/17 sec | — |
| pH | 7.67 | 11.03 | pH units |
| Cond | 5121 | 1,915 | uS |
| ORP | 433 | −87 | mV |
| Amps Pull | 5 | 5 | Amps |
| FAC | NA | NA | ppm |

For the co-current brine feed and recycle stream feed way of activation of phosphate-based solution, the conductivity of the anodic chamber feed solution was varied between conductivity of between 5,400 and 20,400 μS. The wastage flow rate from the cathodic chamber was noted to be higher than the product flow (between 4.5 and 11.9 times by volume). The waste flow adjustment is necessary to control the activated solution pH to be within the target range of between 6.5 and 8.5. The ORP measurements were observed to range between 415 mV and 433 mV, and the varying of the feed brine conductivity did not impact the ORP significantly. The synthesis had a low Amps pull of about 5 Amp across each set of 4 EMs, when the feed conductivity was low, while at the higher feed conductivity the Amps pull was a nominal 1 Amps.

The electrochemical synthesis of disodium phosphate brine to produce activated bicarbonate showed the following product characteristics: ORP: 400 mV-850 mV; pH: 7.2-8.5; Ampere differential between anode and cathode chambers: 1-30 Amperes.

The synthesis using the single pass method of activation of phosphate-based solutions produces higher strength activated solutions in terms of ORP and the amperes pull across the anodic and cathodic chambers. The single pass counter-current synthesis produces somewhat slightly higher strength activated bicarbonate solutions, based on marginally higher ORP readings for the test conditions highlighted here. The synthesis using recycle stream produces weaker activated solutions and the activation itself is at very low Amps pull of about 1 to 5 Amp across 4 EMs.

In summary the synthesis and activation of phosphate based solutions is best achieved with the single pass counter-current and co-current modes of operations. Between these two modes of operations, the counter-current mode is observed as more effective at activating the solution, and in both cases the activation effectiveness is higher at low feed brine conductivity. The synthesis using the recycle stream is weaker and is considered only for applications where on-site production and applications of the activated solutions are needed.

### Results for Co-Activation of Hypochlorus Acid and Bicarbonate Based Solution

### 1. Counter-Current Single Pass Production (FIG. 16)

A total of seven runs were carried out and the results are presented in Tables 41-47.

TABLE 41

| | Anode Feed | Cathode Feed | |
|---|---|---|---|
| | NaHCO3 | NaCl | Units |
| Conductivity | 8276 | 25,880 | uS |
| pH | 8.44 | 8.13 | pH units |
| | Product | Waste | Units |
| Flow | 1 L/25 sec | 1 L/155 sec | — |
| pH | 7.69 | 12.38 | pH units |
| Cond | 8026 | 28320 | uS |
| ORP | 803 | −913 | mV |
| Amps Pull | 15 | 15 | Amps |
| FAC | 37.5 | NA | ppm |

TABLE 42

| | Anode Feed | Cathode Feed | |
|---|---|---|---|
| | NaHCO3 | NaCl | Units |
| Conductivity | 5748 | 27,000 | uS |
| pH | 8.43 | 8.47 | pH units |
| | Product | Waste | Units |
| Flow | 1 L/40 sec | 1 L/27 sec | — |
| pH | 7.18 | 10.0 | pH units |
| Cond | 5644 | 24,880 | uS |
| ORP | 855 | −771 | mV |
| Amps Pull | 9 | 9 | Amps |
| FAC | 62 | NA | ppm |

TABLE 43

| | Anode Feed | Cathode Feed | |
|---|---|---|---|
| | NaHCO3 | NaCl | Units |
| Conductivity | 5748 | 27,000 | uS |
| pH | 8.43 | 8.47 | pH units |
| | Product | Waste | Units |
| Flow | 1 L/55 sec | 1 L/26.5 sec | — |
| pH | 6.92 | 10.65 | pH units |
| Cond | 5950 | 25000 | uS |
| ORP | 871 | −815 | mV |
| Amps Pull | 10 | 10 | Amps |
| FAC | 50 | NA | ppm |

TABLE 44

| | Anode Feed | Cathode Feed | |
|---|---|---|---|
| | NaHCO3 | NaCl | Units |
| Conductivity | 5748 | 27,000 | uS |
| pH | 8.43 | 8.47 | pH units |
| | Product | Waste | Units |
| Flow | 1 L/38.7 sec | 1 L/18.6 sec | — |
| pH | 7.31 | 10.9 | pH units |
| Cond | 5783 | 25000 | uS |
| ORP | 858 | −822 | mV |
| Amps Pull | 20 | 20 | Amps |
| FAC | 32.5 | NA | ppm |

TABLE 45

| | Anode Feed | Cathode Feed | |
|---|---|---|---|
| | NaHCO3 | NaCl | Units |
| Conductivity | 25,900 | 7250 | uS |
| pH | 8.02 | 7.98 | pH units |
| | Product | Waste | Units |
| Flow | 1 L/38.7 sec | 1 L/19.3 sec | — |
| pH | 7.5 | 9.78 | pH units |
| Cond | 25,380 | 10,600 | uS |
| ORP | 845 | −764 | mV |
| Amps Pull | 40 | 40 | Amps |
| FAC | 80 | NA | ppm |

TABLE 46

| | Anode Feed | Cathode Feed | |
|---|---|---|---|
| | NaHCO3 | NaCl | Units |
| Conductivity | 25,900 | 7250 | uS |
| pH | 8.02 | 7.98 | pH units |
| | Product | Waste | Units |
| Flow | 1 L/38.7 sec | 1 L/26.2 sec | — |
| pH | 7.48 | 9.95 | pH units |
| Cond | 25370 | 10000 | uS |
| ORP | 852 | −784 | mV |
| Amps Pull | 35 | 35 | Amps |
| FAC | 55 | NA | ppm |

TABLE 47

| | Anode Feed | Cathode Feed | |
|---|---|---|---|
| | NaHCO3 | NaCl | Units |
| Conductivity | 25,900 | 7250 | uS |
| pH | 8.02 | 7.98 | pH units |
| | Product | Waste | Units |
| Flow | 1 L/28.3 sec | 1 L/28.5 sec | — |
| pH | 7.48 | 9.86 | pH units |
| Cond | 25390 | 10040 | uS |
| ORP | 850 | −774 | mV |
| Amps Pull | 30 | 30 | Amps |
| FAC | 37.5 | NA | ppm |

For the counter-current single pass activation with one feed brine solution each in the anodic (sodium bicarbonate) and cathodic (sodium chloride) chambers, the feed solutions in the chambers were varied to create a concentration gradient between the chambers. The anodic chamber feed brine conductivity was varied between 5750 and 25,900 μS. The cathodic chamber feed brine conductivity was varied between 7250 and 27,000 μS.

The waste flow rate from the cathodic chamber ranged between 1.5 faster and 6.2 times slower than the product flow rate, when the cathodic chamber (sodium chloride) feed brine conductivity was higher than the anodic chamber (sodium bicarbonate) feed conductivity. On the other hand the waste flow rate from the cathodic chamber ranged between 2 times faster and being comparable to the product flow rate, when the cathodic chamber (sodium chloride) feed brine conductivity was lower than the anodic chamber (sodium bicarbonate) feed conductivity. The waste flow adjustment is necessary to control the activated solution pH to be within the target range of between 6.5 and 8.5.

The ORP of the activated solution ranged between 803 mV and 871 mV, with the ORP readings being higher when the cathodic chamber (sodium chloride) feed brine conductivity was higher than the anodic chamber (sodium bicarbonate) feed conductivity. On the other hand the higher Amps pull in the range of 30-40 Amps were observed when the cathodic chamber (sodium chloride) feed brine conductivity was lower than the anodic chamber (sodium bicarbonate) feed conductivity. The FAC in the activated solutions ranged from 37.5 and 80 ppm.

The pH of the activated solution was broader when the cathodic chamber (sodium chloride) feed brine conductivity was higher than the anodic chamber (sodium bicarbonate) feed conductivity, ranging between 7 and 7.7, while the pH was tighter at around 7.5 for the cases when cathodic chamber (sodium chloride) feed brine conductivity was lower.

### 2. Co-Current Single Pass Production (FIG. 17)

A total of four runs were carried out and the results are presented in Tables 48-51.

TABLE 48

| | Anode Feed | Cathode Feed | |
|---|---|---|---|
| | NaHCO3 | NaCl | Units |
| Conductivity | 8276 | 25,880 | uS |
| pH | 8.44 | 8.13 | pH units |
| | Product | Waste | Units |
| Flow | 1 L/32 sec | 1 L/84 sec | — |
| pH | 8.46 | 12.15 | pH units |
| Cond | 8113 | 26755 | uS |
| ORP | 552 | −611 | mV |
| Amps Pull | 10 | 10 | Amps |
| FAC | 27.5 | NA | ppm |

TABLE 49

| | Anode Feed | Cathode Feed | |
|---|---|---|---|
| | NaHCO3 | NaCl | Units |
| Conductivity | 5748 | 27000 | uS |
| pH | 8.43 | 8.47 | pH units |
| | Product | Waste | Units |
| Flow | 1 L/72 sec | 1 L/15 sec | — |
| pH | 7.24 | 10.13 | pH units |
| Cond | 5412 | 25,725 | uS |
| ORP | 405 | −337 | mV |
| Amps Pull | 2 | 2 | Amps |
| FAC | 15 | NA | ppm |

TABLE 50

| | Anode Feed | Cathode Feed | |
|---|---|---|---|
| | NaHCO3 | NaCl | Units |
| Conductivity | 25,900 | 7250 | uS |
| pH | 8.02 | 7.98 | pH units |
| | Product | Waste | Units |
| Flow | 1 L/45.3 sec | 1 L/15.7 sec | — |
| pH | 7.9 | 10.15 | pH units |
| Cond | 26,150 | 9,823 | uS |
| ORP | 584 | −335 | mV |
| Amps Pull | 15 | 15 | Amps |
| FAC | 35 | NA | ppm |

TABLE 51

| | Anode Feed | Cathode Feed | |
|---|---|---|---|
| | NaHCO3 | NaCl | Units |
| Conductivity | 25,900 | 7250 | uS |
| pH | 8.02 | 7.98 | pH units |
| | Product | Waste | Units |
| Flow | 1 L/45.3 sec | 1 L/20.4 sec | — |
| pH | 8.2 | 10.24 | pH units |
| Cond | 26,730 | 11230 | uS |
| ORP | 465 | −556 | mV |
| Amps Pull | 10 | 10 | Amps |
| FAC | 27.5 | NA | ppm |

For the co-current single pass activation with one feed brine solution each in the anodic (sodium bicarbonate) and cathodic (sodium chloride) chambers, the feed solutions in the chambers were varied to create a concentration gradient between the chambers. The anodic chamber feed brine conductivity was varied between 5750 and 25,904 μS. The cathodic chamber feed brine conductivity was varied between 7250 and 27,004 μS.

The waste flow rate from the cathodic chamber ranged between 4.8 times faster and 2.6 times slower than the product flow rate, when the cathodic chamber (sodium chloride) feed brine conductivity was higher than the anodic chamber (sodium bicarbonate) feed conductivity. On the other hand the waste flow rate from the cathodic chamber ranged between 2.2 and 2.9 times faster than the product flow rate, when the cathodic chamber (sodium chloride) feed brine conductivity was lower than the anodic chamber (sodium bicarbonate) feed conductivity. The waste flow adjustment is necessary to control the activated solution pH to be within the target range of between 6.5 and 8.5.

The ORP of the activated solution ranged between 405 mV and 584 mV while the Amps pull ranged from 2-15 Amps across each set of 4 EMs. The FAC in the activated solutions ranged from 15 and 35 ppm.

The pH of the activated solution was the highest at about 8.5, when the waste flow rate was slowed down to about 2.6 times the product flow under the conditions of the cathodic chamber feed brine being higher concentration than the anodic chamber (Run 1). Under the same conditions of the cathodic chamber feed brine being higher concentration than the anodic chamber (Run 1), when the waste flow rate was increased and was faster than the product flow rate at about 4.8 times, the product pH was about 7.2.

The electrochemical co-synthesis of sodium bicarbonate brine and sodium chloride brine to produce activated hypochlorus acid and bicarbonate based solutions showed the following product characteristics: ORP: 400 mV-850 mV; pH: 7.2-8.5; FAC: 15-80 ppm; Ampere differential between anode and cathode chambers: 2-40 Amperes.

The higher ORP and FAC content in the activated solution were in the conditions of counter-current feed between the feeds in the anodic and cathodic chambers. However both modes of synthesizing and co-activating hypochlorus acid and bicarbonate based solutions are favorable. The FAC content is lower than the conditions where only hypochlorus acid is activated, and hence the deduction is that the FAC concentration is not critical towards the activated solutions holding high ORP, in the co-synthesis products. By increasing the waste flowrate proportion the pH of the final product can be lowered, and the activation can be optimized by lowering the pH of the activated solution to be as low as possible while increasing the ORP of the activated solution.

### Results for Co-Activation of Hypochlorus Acid and Phosphate Based Solution

### 1. Counter-Current Single Pass Production (FIG. 18)

A total of five runs were carried out and the results are presented in Tables 52-56.

TABLE 52

| | Anode Feed | Cathode Feed | |
|---|---|---|---|
| | Na2PO4 | NaCl | Units |
| Conductivity | 7590 | 21580 | uS |
| pH | 9.08 | 8.85 | pH units |
| | Product | Waste | Units |
| Flow | 1 L/67.6 | 1 L/46.5 sec | — |
| pH | 7.13 | 11.46 | pH units |
| Cond | 6940 | 19940 | uS |
| ORP | 812 | −135 | mV |
| Amps Pull | 10 | 10 | Amps |
| FAC | 0 | NA | ppm |

TABLE 53

| | Anode Feed | Cathode Feed | |
|---|---|---|---|
| | Na2PO4 | NaCl | Units |
| Conductivity | 7590 | 21580 | uS |
| pH | 9.08 | 8.85 | pH units |
| | Product | Waste | Units |
| Flow | 1 L/67.6 sec | 1 L/17.8 sec | — |
| pH | 7.2 | 10.95 | pH units |
| Cond | 9793 | 21250 | uS |
| ORP | 850 | −827 | mV |
| Amps Pull | 30 | 30 | Amps |
| FAC | 40 | NA | ppm |

TABLE 54

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |
| | Product | Waste | Units |
| Flow | 1 L/58.8 sec | 1 L/76 sec | — |
| pH | 7.43 | 11.48 | pH units |
| Cond | 16170 | 11520 | uS |
| ORP | 766 | −825 | mV |
| Amps Pull | 15 | 15 | Amps |
| FAC | 0 | NA | ppm |

TABLE 55

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |
| | Product | Waste | Units |
| Flow | 1 L/58.8 sec | 1 L/43.1 sec | — |
| pH | 7.3 | 11.45 | pH units |
| Cond | 16020 | 10220 | uS |
| ORP | 803 | −830 | mV |
| Amps Pull | 18 | 18 | Amps |
| FAC | 10 | NA | ppm |

TABLE 56

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |

| | Product | Waste | Units |
|---|---|---|---|
| Flow | 1 L/58.8 sec | 1 L/17.8 | — |
| pH | 7.38 | 11.5 | pH units |
| Cond | 15,700 | 9,116 | uS |
| ORP | 810 | −854 | mV |
| Amps Pull | 30 | 30 | Amps |
| FAC | 22.5 | NA | ppm |

For the counter-current single pass activation with one feed brine solution each in the anodic (disodium phosphate) and cathodic (sodium chloride) chambers, the feed solutions in the chambers were varied to create a concentration gradient between the chambers. The anodic chamber feed brine conductivity was varied between 7600 and 16,800 μS. The cathodic chamber feed brine conductivity was varied between 7600 and 21,580 μS.

The waste flow rate from the cathodic chamber ranged between 1.5 faster and 3.8 times faster than the product flow rate, when the cathodic chamber (sodium chloride) feed brine conductivity was higher than the anodic chamber (disodium phosphate) feed conductivity. On the other hand the waste flow rate from the cathodic chamber ranged between 3.3 times faster and 1.3 times slower than the product flow rate, when the cathodic chamber (sodium chloride) feed brine conductivity was lower than the anodic chamber (disodium phosphate) feed conductivity. The waste flow adjustment is necessary to control the activated solution pH to be within the target range of between 6.5 and 8.5.

The ORP of the activated solution ranged between 766 mV and 850 mV, with the ORP readings being higher when the cathodic chamber (sodium chloride) feed brine conductivity was higher than the anodic chamber (disodium phosphate) feed conductivity. The Amps pull in the range of 10-30 Amps across each set of 4 EMs, was noted and high Amps pull of 30 Amps were observed when the concentration of either feed brines were higher. The FAC in the activated solutions ranged from 0 and 40 ppm, and the zero FAC was observed when the concentration of either feed brines were higher. The pH of the activated solution ranged between 7.13 and 7.43.

### 2. Co-Current Single Pass Production (FIG. 19)

A total of five runs were carried out and the results are presented in Tables 57-61.

TABLE 57

| | Anode Feed | Cathode Feed | |
|---|---|---|---|
| | Na2PO4 | NaCl | Units |
| Conductivity | 7590 | 21580 | uS |
| pH | 9.08 | 8.85 | pH units |

| | Product | Waste | Units |
|---|---|---|---|
| Flow | 1 L/87.3 | 1 L/26.5 sec | — |
| pH | 7.7 | 10.89 | pH units |
| Cond | 69 | 21310 | uS |
| ORP | 570 | −376 | mV |
| Amps Pull | 15 | 15 | Amps |
| FAC | 25 | NA | ppm |

TABLE 58

| | Anode Feed | Cathode Feed | |
|---|---|---|---|
| | Na2PO4 | NaCl | Units |
| Conductivity | 7590 | 21580 | uS |
| pH | 9.08 | 8.85 | pH units |

| | Product | Waste | Units |
|---|---|---|---|
| Flow | 1 L/87.3 sec | 1 L/17.8 sec | — |
| pH | 8.47 | 10.67 | pH units |
| Cond | 10430 | 19230 | uS |
| ORP | 550 | −335 | mV |
| Amps Pull | 15 | 15 | Amps |
| FAC | 22.5 | NA | ppm |

TABLE 59

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |

| | Product | Waste | Units |
|---|---|---|---|
| Flow | 1 L/108.2 sec | 1 L/35.4 sec | — |
| pH | 8.42 | 10.55 | pH units |
| Cond | 15970 | 8660 | uS |
| ORP | 400 | −385 | mV |
| Amps Pull | 10 | 10 | Amps |
| FAC | 0 | NA | ppm |

TABLE 60

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |

| | Product | Waste | Units |
|---|---|---|---|
| Flow | 1 L/94 sec | 1 L/35.4 sec | — |
| pH | 8.23 | 11.05 | pH units |
| Cond | 16110 | 9980 | uS |
| ORP | 450 | −387 | mV |
| Amps Pull | 10 | 10 | Amps |
| FAC | 12.5 | NA | ppm |

TABLE 61

| | Anode Feed | Cathode Feed | |
|---|---|---|---|
| | Na2PO4 | NaCl | Units |
| Conductivity | 16770 | 7590 | uS |
| pH | 8.94 | 8.53 | pH units |

| | Product | Waste | Units |
|---|---|---|---|
| Flow | 1 L/77 sec | 1 L/35.4 | — |
| pH | 7.9 | 10.9 | pH units |
| Cond | 16,320 | 9,780 | uS |
| ORP | 465 | −213 | mV |
| Amps Pull | 12 | 12 | Amps |
| FAC | 15 | NA | ppm |

For the co-current single pass activation with one feed brine solution each in the anodic (disodium phosphate) and cathodic (sodium chloride) chambers, the feed solutions in the chambers were varied to create a concentration gradient between the chambers. The anodic chamber feed brine conductivity was varied between 7,600 and 16,800 μS. The cathodic chamber feed brine conductivity was varied between 7,600 and 21,600 μS.

The waste flow rate from the cathodic chamber ranged between 3.3 and 4.9 times faster than the product flow rate, when the cathodic chamber (sodium chloride) feed brine conductivity was higher than the anodic chamber (disodium phosphate) feed conductivity. On the other hand the waste flow rate from the cathodic chamber ranged between 2.2 and 3.1 times faster than the product flow rate, when the cathodic chamber (sodium chloride) feed brine conductivity was lower than the anodic chamber (disodium phosphate) feed conductivity. The waste flow adjustment is necessary to control the activated solution pH to be within the target range of between 6.5 and 8.5.

The ORP of the activated solution ranged between 400 mV and 570 mV while the Amps pull ranged from 10-15 Amps across each set of 4 EMs. The FAC in the activated solutions ranged from 0 and 25 ppm.

The pH of the activated solution was the highest at about 8.5, when the waste flow rate was 4.9 times the product flow under the conditions of the cathodic chamber feed brine being higher concentration than the anodic chamber (Run 2). Under the same conditions of the cathodic chamber feed brine being higher concentration than the anodic chamber (Run 1), when the waste flow rate was decreased and was faster than the product flow rate at about 3.3 times, the product pH was about 7.7.

The pH of the activated solution was also high at about 8.5, when the waste flow rate was 3.1 times the product flow under the conditions of the cathodic chamber feed brine being lower concentration than the anodic chamber (Run 3). Under the same conditions of the cathodic chamber feed brine being higher concentration than the anodic chamber (Run 5), when the product flow rate was increased and was slower than the waste flow rate at about 2.2 times, the product pH was about 7.9.

The electrochemical co-synthesis of disodium phosphate brine and sodium chloride brine to produce activated hypochlorus and phosphate based solutions showed the following product characteristics: ORP: 400 mV-850 mV; pH: 7.2-8.5; FAC: 0-40 ppm; Ampere differential between anode and cathode chambers: 10-30 Amperes.

The higher ORP and FAC content in the activated solution were in the conditions of counter-current feed between the feeds in the anodic and cathodic chambers. However both modes of synthesizing and co-activating hypochlorus acid and bicarbonate based solutions are favorable. The FAC content is lower than the conditions where only hypochlorus acid is activated, and hence the deduction is that the FAC concentration is not critical towards the activated solutions holding high ORP, in the co-synthesis products. By increasing the waste flowrate proportion the pH of the final product (counter-current Run 2) can be lowered, and the activation can be optimized by lowering the pH of the activated solution to be as low as possible while increasing the ORP of the activated solution.

### Results for Co-Activation of Hypochlorus Acid and Bicarbonate and Phosphate Based Solutions

### 1. Counter-Current Single Pass Production (FIG. 20)

A total of four runs were carried out and the results are presented in Tables 62-65.

TABLE 62

| | Anode Feed | | |
|---|---|---|---|
| | NaHCO3 + | Cathode Feed | |
| | Na2PO4 | NaCl | Units |
| Cond. NaHCO3 | 9989 | — | uS |
| Cond. Na2PO4 | 10760 | — | uS |
| Conductivity Mix | 10470 | 20150 | uS |
| pH | 8.27 | 8.28 | pH units |

| | Product | Waste | Units |
|---|---|---|---|
| Flow | 1 L/69.6 | 1 L/17.9 sec | — |
| pH | 7.14 | 11.22 | pH units |
| Cond | 9750 | 19660 | uS |
| ORP | 810 | −838 | mV |
| Amps Pull | 30 | 30 | Amps |
| FAC | 20 | NA | ppm |

TABLE 63

| | Anode Feed | | |
|---|---|---|---|
| | NaHCO3 + | Cathode Feed | |
| | Na2PO4 | NaCl | Units |
| Cond. NaHCO3 | 9989 | — | uS |
| Cond. Na2PO4 | 10760 | — | uS |
| Conductivity Mix | 10470 | 6825 | uS |
| pH | 8.33 | 8.26 | pH units |

| | Product | Waste | Units |
|---|---|---|---|
| Flow | 1 L/69 sec | 1 L/15.5 sec | — |
| pH | 7.13 | 10.01 | pH units |
| Cond | 9674 | 7505 | uS |
| ORP | 845 | −769 | mV |
| Amps Pull | 25 | 25 | Amps |
| FAC | 27.5 | NA | ppm |

TABLE 64

| | Anode Feed | | |
|---|---|---|---|
| | NaHCO3 + | Cathode Feed | |
| | Na2PO4 | NaCl | Units |
| Cond. NaHCO3 | 20850 | — | uS |
| Cond. Na2PO4 | 18570 | — | uS |
| Conductivity Mix | 20010 | 6840 | uS |
| pH | 8.21 | 8.39 | pH units |

| | Product | Waste | Units |
|---|---|---|---|
| Flow | 1 L/22 sec | 1 L/15.5 sec | — |
| pH | 7.63 | 11.3 | pH units |
| Cond | 19640 | 8495 | uS |
| ORP | 765 | −857 | mV |
| Amps Pull | 40 | 40 | Amps |
| FAC | 17.5 | NA | ppm |

TABLE 65

| | Anode Feed | | |
|---|---|---|---|
| | NaHCO3 + | Cathode Feed | |
| | Na2PO4 | NaCl | Units |
| Cond. NaHCO3 | 20850 | — | uS |
| Cond. Na2PO4 | 18570 | — | uS |
| Conductivity Mix | 20010 | 20070 | uS |
| pH | 8.21 | 8.80 | pH units |

| | Product | Waste | Units |
|---|---|---|---|
| Flow | 1 L/22 sec | 1 L/7.5 sec | — |
| pH | 7.53 | 11.25 | pH units |
| Cond | 13040 | 21390 | uS |
| ORP | 800 | −863 | mV |
| Amps Pull | 35 | 35 | Amps |
| FAC | 0 | NA | ppm |

For the counter-current single pass activation with mix feed brine solution in the anodic (sodium bicarbonate+disodium phosphate) and cathodic (sodium chloride) chambers, the feed solutions in the chambers were varied to create a concentration gradient between the chambers. The anodic chamber feed brine conductivity was varied between 10,500 and 20,000 μS. The cathodic chamber feed brine conductivity was varied between 6,800 and 20,000 μS. The feed brine mix for the anodic chamber is prepared by mixing sodium bicarbonate and disodium phosphate brines of approximately equal conductivities.

The waste flow rate from the cathodic chamber ranged between 1.2 and 4.5 times faster than the product flow rate. The waste flow adjustment is necessary to control the activated solution pH to be within the target range of between 6.5 and 8.5. The pH of the activated solutions ranged from 7.13 to 7.63.

The ORP of the activated solution ranged between 765 mV and 845 mV, with the ORP readings being higher when the cathodic chamber (sodium chloride) feed brine conductivity was lower (Run 2) or comparable to (Run 4) the anodic chamber mix (sodium bicarbonate+disodium phosphate) feed conductivity. The Amps pull in the range of 25-40 Amps across each set of 4 EMs. The FAC in the activated solutions ranged from 0 and 27.5 ppm, and the zero FAC was observed when the concentration of either feed brines were comparable (Run 4).

### 2. Co-Current Single Pass Production (FIG. 21)

A total of four runs were carried out and the results are presented in Tables 66-69.

TABLE 66

| | Anode Feed | | |
|---|---|---|---|
| | NaHCO3 + | Cathode Feed | |
| | Na2PO4 | NaCl | Units |
| Cond. NaHCO3 | 9989 | — | uS |
| Cond. Na2PO4 | 10760 | — | uS |
| Conductivity Mix | 10470 | 20150 | uS |
| pH | 8.27 | 8.28 | pH units |

| | Product | Waste | Units |
|---|---|---|---|
| Flow | 1 L/80 sec | 1 L/15.6 sec | — |
| pH | 7.06 | 11.08 | pH units |
| Cond | 10230 | 18720 | uS |
| ORP | 570 | −585 | mV |
| Amps Pull | 20 | 20 | Amps |
| FAC | 12.5 | NA | ppm |

TABLE 67

| | Anode Feed | | |
|---|---|---|---|
| | NaHCO3 + | Cathode Feed | |
| | Na2PO4 | NaCl | Units |
| Cond. NaHCO3 | 9989 | — | uS |
| Cond. Na2PO4 | 10760 | — | uS |
| Conductivity Mix | 10470 | 6825 | uS |
| pH | 8.33 | 8.26 | pH units |

| | Product | Waste | Units |
|---|---|---|---|
| Flow | 1 L/80 sec | 1 L/12.3 sec | — |
| pH | 7.34 | 10.65 | pH units |
| Cond | 9472 | 7371 | uS |
| ORP | 510 | −455 | mV |
| Amps Pull | 15 | 15 | Amps |
| FAC | 0 | NA | ppm |

TABLE 68

| | Anode Feed | | |
|---|---|---|---|
| | NaHCO3 + | Cathode Feed | |
| | Na2PO4 | NaCl | Units |
| Cond. NaHCO3 | 20850 | — | uS |
| Cond. Na2PO4 | 18570 | — | uS |
| Conductivity Mix | 20010 | 6840 | uS |
| pH | 8.21 | 8.39 | pH units |

| | Product | Waste | Units |
|---|---|---|---|
| Flow | 1 L/23.3 sec | 1 L/45.5 sec | — |
| pH | 8.43 | 9.64 | pH units |
| Cond | 19320 | 7734 | uS |
| ORP | 535 | −376 | mV |
| Amps Pull | 15 | 15 | Amps |
| FAC | 0 | NA | ppm |

TABLE 69

| | Anode Feed | | |
|---|---|---|---|
| | NaHCO3 + | Cathode Feed | |
| | Na2PO4 | NaCl | Units |
| Cond. NaHCO3 | 20850 | — | uS |
| Cond. Na2PO4 | 18570 | — | uS |
| Conductivity Mix | 20010 | 20070 | uS |
| pH | 8.21 | 8.80 | pH units |

| | Product | Waste | Units |
|---|---|---|---|
| Flow | 1 L/13.7 sec | 1 L/45.5 sec | — |
| pH | 7.8 | 9.33 | pH units |
| Cond | 19660 | 21230 | uS |
| ORP | 577 | −510 | mV |
| Amps Pull | 15 | 15 | Amps |
| FAC | 10 | NA | ppm |

For the co-current single pass activation with mix feed brine solution in the anodic (sodium bicarbonate+disodium phosphate) and cathodic (sodium chloride) chambers, the feed solutions in the chambers were varied to create a concentration gradient between the chambers. The anodic chamber feed brine conductivity was varied between 10,500 and 20,000 μS. The cathodic chamber feed brine conductivity was varied between 6,800 and 20,000 μS. The feed brine mix for the anodic chamber is prepared by mixing sodium bicarbonate and disodium phosphate brines of approximately equal conductivities.

The waste flow rate from the cathodic chamber ranged between 5.1 and 6.5 times faster than the product flow rate; and also when the cathodic chamber ranged between 3 and 3 times slower than the product flow rate. The waste flow adjustment is necessary to control the activated solution pH to be within the target range of between 6.5 and 8.5. The pH of the activated solutions ranged from 7.06 to 8.43. The lower pH conditions were noted when the waste flow rates were higher than the product flow rate. The higher pH conditions were noted when the waste flow rates were slowed down and were slower than the product flow rate.

The ORP of the activated solution ranged between 510 mV and 577 mV, with the ORP readings being higher when the cathodic chamber (sodium chloride) feed brine conductivity was higher (Run 1) or comparable to (Run 4) the anodic chamber mix (sodium bicarbonate+disodium phosphate) feed conductivity. The Amps pull in the range of 15-20 Amps across each set of 4 EMs. The FAC in the activated solutions ranged from 0 and 12.5 ppm, and the zero FAC was observed when the concentration of the cathodic chamber (sodium chloride) feed brine was lower than the anodic chamber (sodium bicarbonate+disodium phosphate) feed (Run 2).

The electrochemical co-synthesis of sodium bicarbonate and disodium phosphate brine mix and sodium chloride brine to produce activated hypochlorus and bicarbonate and phosphate based solutions showed the following product characteristics: ORP: 500 mV-850 mV; pH: 7.0-8.5; FAC: 0-27.5 ppm; Ampere differential between anode and cathode chambers: 15-40 Amperes.

The higher ORP and FAC content in the activated solution were in the conditions of counter-current feed between the feeds in the anodic and cathodic chambers. However both modes of synthesizing and co-activating hypochlorus acid and bicarbonate and phosphate based solutions are favorable. The FAC content is much lower than the conditions where only hypochlorus acid is activated, and hence the deduction is that the FAC concentration is not critical towards the activated solutions holding high ORP, in the co-synthesis products. By increasing the waste flowrate proportion the pH of the final product (counter-current Run 2) can be lowered, and the activation can be optimized by lowering the pH of the activated solution to be as low as possible while increasing the ORP of the activated solution.

### Combinations of Solutions

Experiments were conducted to determine the strength and stability of combinations of activated solutions. Results are shown in the Tables 70, 71 and 72, below. Solutions comprising bicarbonate ion and/or hypochlorous acid (HOCl) were prepared separately and then combined with additional HOCl solution, as follows:

Sample A was prepared using the ANK processing method by feeding a NaCl solution bottom up in the cathode chamber to produce a Na waste stream at a waste stream flow rate of 1 L per 10 seconds. The feed NaCl concentration (measured in terms of conductivity) was 10,600 μS. The Na waste stream (containing NaOH) had a conductivity of 12,320 μS. The product stream has the following properties: ORP 981 mV, and Total Chlorine (TC) 590 ppm. In the ANK method, dilute brine is first introduced to the lower collector feed of the cathode chamber, then routed through a single channel to the lower feed of the anode chamber, for optimum pH control.

Sample B is activated HOCl, prepared using the ANK processing method. The Na waste stream was processed at a waste stream flow rate of 1 L per 5 seconds. The feed NaCl concentration (measured in terms of conductivity) was 10,600 μS. The Na waste stream (containing NaOH) had a conductivity of 12,320 μS. The product stream has the following properties: ORP 880 mV, and TC 400 ppm.

Sample C is activated HOCl, prepared using the ANK processing method, with a pH adjusted feed brine of NaCl and NaOH. The feed brine NaCl (5 gal) solution had a conductivity of 15,940 μS and pH 10.10. The feed brine NaOH (5 gal) had a conductivity of 7,895 μS and pH 12.65. The combined 10 gal of NaCl and NaOH had a conductivity of 11,850 μS and pH 12.57.

Sample D is activated bicarbonate ion, prepared in a FEM in counter-current mode, with the bicarbonate solution fed upwardly in the anode chamber and reverse osmosis (RO) water fed downwardly in the cathode chamber. The feed bicarbonate was measured to have a conductivity value of 25670 μS, and the product stream had the following measured properties: ORP 681 mV, and pH of 7.97.

Sample E is activated bicarbonate ion, prepared in a FEM in counter-current mode, with the bicarbonate solution fed downwardly in the anode chamber and reverse osmosis (RO) water fed upwardly in the cathode chamber. The feed bicarbonate was measured to have a conductivity value of 25670 μS, and the product stream had the following measured properties: ORP 685 mV, and pH of 7.93.

Sample F is activated bicarbonate ion, prepared in a FEM in counter-current mode, with the bicarbonate solution fed upwardly in the anode chamber and reverse osmosis (RO) water fed downwardly in the cathode chamber. The feed bicarbonate was measured to have a conductivity value of 8273 μS, and the product stream had the following measured properties: ORP 800 mV, and pH 7.53. Sample F is the same as Sample D, except the bicarbonate concentration in Sample F (8273 μS) is about 33% of the bicarbonate concentration of Sample D (25670 μS). Thus, Sample F is stronger than Sample D.

Sample G is a combination (cosynthesis) of activated bicarbonate and activated HOCl, prepared in a FEM in counter-current mode, with the bicarbonate solution fed upwardly in the anode chamber and a solution of NaCl fed downwardly in the cathode chamber. The feed bicarbonate was measured to have a conductivity value of 8276 μS, the feed NaCl solution had a conductivity of 25,880 μS, and the product stream had the following measured properties: ORP 803 mV, and FAC 37.5 ppm.

Sample H is a combination (cosynthesis) of activated bicarbonate and activated HOCl, prepared in a FEM in counter-current mode, with the bicarbonate solution fed upwardly in the anode chamber and a solution of NaCl fed downwardly in the cathode chamber. Sample H was prepared using a lower bicarbonate concentration (8276 μS). The feed bicarbonate was measured to have a conductivity value of 8276 μS, the feed NaCl solution had a conductivity of 13,300 μS, and the product stream had the following measured properties: ORP 825 mV, and TC 55 ppm.

A solution (I) of activated HOCl was produced using the ANK method, described above. The NaCl feed was determined to have a conductivity value of 13,290 μS, and the product stream had the following measured properties: pH 7.50, ORP 825 mV, and TC 55 ppm.

Activated bicarbonate solutions D, E, F, G and H were combined with activated HOCl solutions in various proportions, as indicated by Samples D11, D12, D13, E11, E12, E13, G11, G12, G13 and H11, H12 and H13, as shown in the tables below.

TABLE 70
Conductivity (ORP)

| | Day | Day | Day | | | |
|---|---|---|---|---|---|---|
| Sample | 1 | 2 | 3 | Day 5 | Day 8 | Day 16 |
| A | 891 | | | 875 | 836 | 841 |
| B | 880 | | | 894 | 860 | 855 |
| C | | 905 | | 902 | 884 | 885 |
| D (Bicarbonate/H2O) | | | 681 | 695 | 705 | 673 |
| E | | | 685 | 626 | 585 | 644 |
| F (Bicarbonate/H2O) | | | 800 | 778 | 767 | 741 |
| G | | | 803 | 807 | 771 | 736 |
| H (Bicarbonate/NaCl) | | | 825 | 798 | 797 | 751 |
| I (HOCl) | | | 931 | 930 | 915 | 925 |
| D11 (D-25%:I-75%) | | | | 859 | 828 | 793 |
| D12 (D-50%:I-50%) | | | | 840 | 803 | 784 |
| D13 (D-75%:I-25%) | | | | 848 | 816 | 793 |
| E11 (E-25%:I-75%) | | | | 869 | 823 | 802 |
| E12 (E-50%:I-50%) | | | | 692 | 690 | 665 |
| E13 (E-75%:I-25%) | | | | 828 | 797 | 778 |
| F11 (F-25%:I-75%) | | | | 890 | 866 | 722 |
| F12 (F-50%:I-50%) | | | | 865 | 839 | 774 |
| F13 (F-75%:I-25%) | | | | 839 | 807 | 780 |
| G11 (G-25%:I-75%) | | | | 883 | 850 | 836 |
| G12 (G-50%:I-50%) | | | | 862 | 830 | 824 |
| G13 (G-75%:I-25%) | | | | 870 | 836 | 828 |
| H11 (H-25%:I-75%) | | | | 880 | 825 | 795 |
| H12 (H-50%:I-50%) | | | | 888 | 856 | 848 |
| H13 (H-75%:I-25%) | | | | 889 | 832 | 832 |

TABLE 71
Total Chlorine (ppm)

| | Day | Day | Day | | | |
|---|---|---|---|---|---|---|
| Sample | 1 | 2 | 3 | Day 5 | Day 8 | Day 16 |
| A | 590 | | | 480 | 532 | 377.5 |
| B | 400 | | | 402.5 | 460 | 385 |
| C | | 647 | | 612.5 | 700 | 452 |
| D (Bicarbonate/H2O) | | | 0 | 0 | 0 | 0 |
| E | | | 0 | 0 | 0 | 0 |
| F (Bicarbonate/H2O) | | | 0 | 0 | 0 | 0 |
| G | | | 37.5 | 22.5 | 0 | 0 |
| H (Bicarbonate/NaCl) | | | 55 | 17.5 | 0 | 0 |
| I (HOCl) | | | 475 | 427 | 460 | 407.5 |
| D11 (D-25%:I-75%) | | | | 335 | 440 | 350 |
| D12 (D-50%:I-50%) | | | | 235 | 265 | 250 |
| D13 (D-75%:I-25%) | | | | 102.5 | 110 | 92.5 |
| E11 (E-25%:I-75%) | | | | 317.5 | 380 | 347.5 |
| E12 (E-50%:I-50%) | | | | 0 | 0 | 0 |
| E13 (E-75%:I-25%) | | | | 122.5 | 185 | 95 |
| F11 (F-25%:I-75%) | | | | 340 | 382 | 300 |
| F12 (F-50%:I-50%) | | | | 200 | 270 | 252.5 |
| F13 (F-75%:I-25%) | | | | 140 | 135 | 142.5 |
| G11 (G-25%:I-75%) | | | | 372.5 | 402.5 | 367.5 |
| G12 (G-50%:I-50%) | | | | 237.5 | 247.5 | 225 |
| G13 (G-75%:I-25%) | | | | 117.5 | 167.5 | 142.5 |
| H11 (H-25%:I-75%) | | | | 315 | 345 | 347.5 |
| H12 (H-50%:I-50%) | | | | 537.5 | 235 | 262.5 |
| H13 (H-75%:I-25%) | | | | 112.5 | 150 | 170 |

TABLE 72
pH

| Sample | Day 1 | Day 2 | Day 3 | Day 16 |
|---|---|---|---|---|
| A | 7.37 | | | 7.54 |
| B | 7.40 | | | 7.67 |
| C | | 7.51 | | 7.42 |
| D (Bicarbonate/H2O) | | | 7.97 | 8.32 |
| E | | | 7.93 | 8.39 |
| F (Bicarbonate/H2O) | | | 7.53 | 7.88 |
| G | | | 7.69 | 8.16 |
| H (Bicarbonate/NaCl) | | | 7.50 | 8.15 |
| I (HOCl) | | | 7.21 | 6.89 |
| D11 (D-25%:I-75%) | | | | 8.47 |
| D12 (D-50%:I-50%) | | | | 8.55 |
| D13 (D-75%:I-25%) | | | | 8.32 |
| E11 (E-25%:I-75%) | | | | 8.57 |
| E12 (E-50%:I-50%) | | | | 8.48 |
| E13 (E-75%:I-25%) | | | | 8.48 |
| F11 (F-25%:I-75%) | | | | 9.65 |
| F12 (F-50%:I-50%) | | | | 8.40 |
| F13 (F-75%:I-25%) | | | | 8.41 |
| G11 (G-25%:I-75%) | | | | 8.18 |
| G12 (G-50%:I-50%) | | | | 8.21 |
| G13 (G-75%:I-25%) | | | | 8.00 |
| H11 (H-25%:I-75%) | | | | 8.81 |
| H12 (H-50%:I-50%) | | | | 7.86 |
| H13 (H-75%:I-25%) | | | | 8.06 |

As shown in the above tables, Samples E11, E12 and E13 are different proportions of Sample E to Sample I (ANK method of synthesizing HOCl). E11 has 75% of HOCl. E12 has 50% HOCl and E13 has 25% HOCl.

The H11, H12 and H13 systems involve blending more activated HOCl to a product (sample H) that already is co-systhesized with HOCl and bicarbonate. That is HOCl is doubled after co-synthesizing a combination product already containing activated bicarbonate and activated HOCl. The mixtures with more HOCl added show improved ORP and TC.

The above results show that HOCl solutions comprising bicarbonate have improved stability over time. Specifically, as shown in Table 71, Samples D11, E11, F11, G11 and H11 (each of which represent mixtures of bicarbonate ion solution with HOCl solution, with 25% by volume bicarbonate solution) all shown improved stability over time, as measured by the retention of total chlorine (TC) over the course of 11 days (from Day 5 to Day 16), compared with solutions having 50% and 75% by volume bicarbonate solution. This data suggest that combination solutions of HOCl and bicarbonate have improved stability and activity. In a particular embodiment, such stability and activity is dramatically improved when the bicarbonate solution represents about 25% by volume of the total solution.

In addition, comparing Sample E (in which the feed in the anode was reversed (top down) to Sample D (in which the bicarbonate fed bottom up in the anode chamber, with RO water fed down in the cathode chamber), the data further demonstrate that the methodology of Sample D resulted in improved stability.

Those skilled in the art will recognize various modifications, which could be made to the embodiments disclosed herein without departing from the scope and spirit of the invention. The following claims are intended to cover such obvious modifications.

1. A method for co-synthesizing in a flow-through electrochemical cell an activated solution for use in water treatment, comprising:
(a) providing a flow-through electrochemical cell comprising a cylindrical anode and a coaxial cylindrical cathode, a capillary-porous diaphragm coaxial with and between the anode and cathode and defining an anodic chamber and cathodic chamber;
(b) introducing an anodic electrolyte solution into the anodic chamber such that the anodic electrolyte solution flows through the anodic chamber and the products of the electrochemical reaction flow out of the anodic chamber, wherein the anodic electrolyte solution comprises one or more electrolyte of the formula MK, wherein
M is selected from the group consisting of alkali metal and alkaline earth metal ions, and
K is selected from the group consisting of bicarbonate, carbonate and phosphate ions;
(c) introducing a cathodic electrolyte solution into the cathode chamber such that the cathodic electrolyte solution flows through the cathodic chamber and the products of the electrochemical reaction flow out of the cathodic chamber, wherein the cathodic electrolyte solution comprises one or more electrolyte of the formula MX, wherein
M is selected from the group consisting of alkali metals and alkaline earth metal ions, and
X is a halogen ion; and
(d) subjecting the first electrolyte solution and second electrolyte solution to a current sufficient to create an electrolytic reaction and produce an activated solution comprising a hypohalous acid and one or more ion selected from the group consisting of phosphate ion and bicarbonate ion.

2. The method of claim 1, wherein MX comprises one or more of the group consisting of sodium chloride, potassium chloride, calcium chloride, magnesium chloride, sodium bromide, potassium bromide, sodium iodide, and potassium iodide.

3. The method of claim 1, wherein MX comprises sodium chloride.

4. The method of claim 1, wherein MK comprises one or more of the group consisting of sodium bicarbonate, potassium bicarbonate, calcium bicarbonate, magnesium bicarbonate, sodium carbonate, potassium carbonate.

5. The method of claim 1, wherein MK comprises sodium bicarbonate.

6. The method of claim 1, wherein MK comprises one or more of the group consisting of disodium phosphate, dipotassium phosphate, calcium phosphate, monomagnesium phosphate, and dimagnesium phosphate.

7. The method of claim 1, wherein MK comprises disodium phosphate.

8. The method of claim 1, wherein MK is a mixture of electrolytes, comprising
one or more of the group consisting of sodium bicarbonate, potassium bicarbonate, aqueous calcium bicarbonate and aqueous magnesium bicarbonate, sodium carbonate, potassium carbonate; calcium bicarbonate, and magnesium bicarbonate; and
one or more of the group consisting of disodium phosphate, dipotassium phosphate, calcium phosphate, monomagnesium phosphate, and dimagnesium phosphate.

9. The method of claim 8, wherein MK is a mixture of electrolytes comprising sodium bicarbonate and disodium phosphate.

10. The method of claim 1, wherein MX is a mixture of electrolytes comprising sodium chloride and sodium bicarbonate.

11. The method of claim 10, wherein the anodic electrolyte solution flows through the anode chamber and the cathodic electrolyte solution flows through cathode chamber in counter-current mode.

12. The method of claim 10, wherein the anodic electrolyte solution flows through the anode chamber and the cathodic electrolyte solution flows through cathode chamber in co-current mode.

13. The method of claim 10, wherein the rate of flow of the cathodic electrolyte solution in the cathode chamber is greater than the rate of flow of the anodic electrolyte solution in the anode chamber.

14. The method of claim 10, wherein the rate of flow of the cathodic electrolyte solution in the cathode chamber is at least two times greater than the rate of flow of the anodic electrolyte solution in the anode chamber.

15. The method of claim 1, wherein MX is a mixture of electrolytes comprising sodium chloride and disodium phosphate.

16. The method of claim 15, wherein the anodic electrolyte solution flows through the anode chamber and the cathodic electrolyte solution flows through cathode chamber in counter-current mode.

17. The method of claim 15, wherein the anodic electrolyte solution flows through the anode chamber and the cathodic electrolyte solution flows through cathode chamber in co-current mode.

18. The method of claim 15, wherein the rate of flow of the cathodic electrolyte solution in the cathode chamber is greater than the rate of flow of the anodic electrolyte solution in the anode chamber.

19. The method of claim 15, wherein the rate of flow of the cathodic electrolyte solution in the cathode chamber is at least two times greater than the rate of flow of the anodic electrolyte solution in the anode chamber.

20. The method of claim 1, wherein MX comprises sodium chloride, and MK comprises sodium bicarbonate and disodium phosphate.

21. The method of claim 20, wherein the anodic electrolyte solution and cathodic electrolyte solution flow through the anode chamber and cathode chamber in co-current mode.

22. The method of claim 20, wherein the rate of flow of the cathodic electrolyte solution in the cathode chamber is greater than the rate of flow of the anodic electrolyte solution in the anode chamber.

23. The method of claim 20, wherein the rate of flow of the cathodic electrolyte solution in the cathode chamber is at least two times greater than the rate of flow of the anodic electrolyte solution in the anode chamber.

24. The method of claim 1, wherein the anode has a surface comprising an electrocatalytic coating comprising about 36% to about 68% iridium, about 2% to about 10% rubidium, about 14% to about 19% ruthenium, and about 24% to about 44% platinum.

25. The method of claim 1, wherein the anode has a surface comprising an electrocatalytic coating comprising about 75% iridium, about 15% ruthenium, and about 5% platinum.

26. The method of claim 1, wherein the cathode chamber outlet is connected to the anode chamber inlet, thereby enabling recirculation of the cathode chamber reaction products to the anode chamber reactants.

27. The method of claim 1, wherein the anodic electrolyte solution and cathodic electrolyte solution flow through the anode chamber and cathode chamber in co-current mode.

28. The method of claim 1, wherein the rate of flow of the cathodic electrolyte solution in the cathode chamber is equal to or greater than the rate of flow of the anodic electrolyte solution in the anode chamber.

29. The method of claim 1, wherein the rate of flow of the cathodic electrolyte solution in the cathode chamber is greater than the rate of flow of the anodic electrolyte solution in the anode chamber.

30. The method of claim 1, wherein the rate of flow of the cathodic electrolyte solution in the cathode chamber is at least two times greater than the rate of flow of the anodic electrolyte solution in the anode chamber.

31. The method of claim 1, wherein the rate of flow of the cathodic electrolyte solution in the cathode chamber is at least three times greater than the rate of flow of the anodic electrolyte solution in the anode chamber.

32. The method of claim 1, wherein the anodic electrolyte solution and cathodic electrolyte solution flow through the anode chamber and cathode chamber in counter-current mode.

33. The method of claim 1, wherein the rate of flow of the cathodic electrolyte solution in the cathode chamber is equal to or greater than the rate of flow of the anodic electrolyte solution in the anode chamber.

34. The method of claim 1, wherein the rate of flow of the cathodic electrolyte solution in the cathode chamber is greater than the rate of flow of the anodic electrolyte solution in the anode chamber.

35. The method of claim 1, wherein the rate of flow of the cathodic electrolyte solution in the cathode chamber is at least two times greater than the rate of flow of the anodic electrolyte solution in the anode chamber.

36. The method of claim 1, wherein the rate of flow of the cathodic electrolyte solution in the cathode chamber is at least three times greater than the rate of flow of the anodic electrolyte solution in the anode chamber.

37. A product produced according to the method of claim 1.

38. A product according to claim 37, wherein the product is a solution comprising two or more of the group consisting of activated hypochlorous acid; activated phosphate ion, activated bicarbonate ion (hydrogencarbonate ion HCO₃⁻).

39. A product accordingly to claim 37, wherein the solution comprises activated hypochlorous acid, activated bicarbonate ion and activated phosphate ion.

40. A product accordingly to claim 37, wherein the solution comprises activated hypochlorous acid and activated phosphate ion.

41. A product accordingly to claim 37, wherein the product comprises a solution of activated hypochlorous acid and a solution of activated bicarbonate ion.

42. A method for preventing or removing mineral and biological deposits in a water system, comprising the step of circulating within the water system a solution comprising two or more of the group consisting of activated hypohalous acid, activated bicarbonate ion and activated phosphate ion.

43. The method of claim 42, wherein the solution comprises hypochlorous acid, and activated bicarbonate ion.

44. The method of claim 42, wherein the solution comprises hypochlorous acid, and activated phosphate ion.

45. The method of claim 42, wherein the solution comprises activated hypochlorous acid, activated bicarbonate ion and activated phosphate ion.

46. A chemical solution comprising two or more of the group comprising activated hypohalous acid, activated bicarbonate ion, and activated phosphate ion.

47. A chemical solution comprising activated hypohalous acid and one or more of activated bicarbonate ion and activated phosphate ion.

48. The chemical solution according to claim 47, wherein the solution comprises activated hypochlorous acid, and activated bicarbonate ion.

49. The chemical solution according to claim 47, wherein the solution comprises activated hypochlorous acid, and activated phosphate ion.

50. The chemical solution according to claim 47, wherein the solution comprises activated hypochlorous acid, activated bicarbonate ion, and activated phosphate ion.

51. The chemical solution according to claim 47, wherein the pH of the solution is from about 6.7 to about 8.5.

52. The chemical solution according to claim 47, wherein the pH of the solution is from about 7.0 to about 8.0.

53. The chemical solution according to claim 47, wherein the oxidation-reduction potential of the solution is greater than about 600 mV.

54. The chemical solution according to claim 47, wherein the oxidation-reduction potential of the solution is greater than about 700 mV.

55. The chemical solution according to claim 47 wherein the oxidation-reduction potential of the solution is greater than about 800 mV.

56. The product of claim 41, wherein the product comprises a mixture of a solution of activated bicarbonate ion and a solution of activated hypochlorous acid.

57. The product of claim 41, wherein the mixture comprises greater than about 2% and less than about 25% by volume activated bicarbonate solution.

58. The product of claim 41, wherein the mixture comprises between about 5% and 15% by volume activated bicarbonate solution.

59. The product of claim 41, wherein the mixture comprises about 10% by volume activated bicarbonate solution.

60. The product of claim 41, wherein the mixture comprises less than about 20% by volume activated bicarbonate solution.

61. The product of claim 41, wherein the mixture comprises less than about 25% by volume activated bicarbonate solution.

62. The product of claim 41, wherein the mixture comprises less than about 50% by volume activated bicarbonate solution.

63. The product of claim 58, wherein the mixture retains an average total chlorine value greater than about 100 over a period of 10 days.

64. The product of claim 58, wherein the mixture retains an average total chlorine value greater than about 200 over a period of 10 days.

65. The product of claim 58, wherein the mixture retains an average total chlorine value greater than about 300 over a period of 10 days.

66. The product of claim 58, wherein the mixture retains an average total chlorine value greater than about 350 over a period of 10 days.
